(19) United States
(12) Patent Application Publication
(10) Pub. No.: US 2002/0103754 A1
(43) Pub. Date: Aug. 1, 2002

(54) InterNetLC documentary letter of credit internet trade transaction and settlement system

(76) Inventor: John William Dunlop, San Diego, CA (US)

Correspondence Address: JOHN W. DUNLOP, SUITE A, 5330 NAPA STREET, SAN DIEGO, CA, 92110, US

(21) Appl. No.: 09/881,032

(22) Filed: Jun. 15, 2001

Related U.S. Application Data
(60) Provisional application No. 60/239,561, filed on Oct. 10, 2000.
(60) Provisional application No. 60/239,531, filed on Oct. 10, 2000.

(51) Int. Cl. G06F 17/60

(52) U.S. Cl. 705/39

(57) ABSTRACT

The InterNetLC® Documentary Letter of net Trade Transaction and Settlement System is an alternative for commercial Letter of Credit transactions. It is a trade finance instrument issued by a bank or corporation via Internet for the purchase and shipment of goods to a buyer. The InterNetLC® conforms to and is negotiable by the ICC Uniform Customs and Practices for Documentary Credits. The InterNetLC® is a secure payment method for transactions that require settlement upon shipment, and is negotiable with authenticated e-documents representing the transport Bill of Lading or Air Waybill, Rail Waybill, Straight Bill, Courier Receipt, Invoice, Packing List and Bill of Exchange that are equivalent with the document requirements specified in the issued InterNetLC® Letter of Credit.

### BACKGROUND OF THE INVENTION

The commercial Documentary Letter of Credit is used in international and domestic trade to negotiate settlement upon the shipment of goods from a buyer to a seller. The traditional Letter of Credit is issued via telex (SWIFT) and negotiated with manually signed hardcopy transport documents mailed or couriered between the par-ties and the banks involved. This process is labor intensive and time consuming. These transactions are conducted under the guidelines of the International Chamber of Commerce, Paris, France, Uniform Customs and Practice for Documentary Credits (UCP). The complexity of Letter of Credit transactions is due in large part because the banks, countries of origin, and the parties involved use the system for purposes other than the settlement of the sale transaction. Often times the documents required for negotiation reflect unnecessary details of the sales transaction, are used to restrict ports of call, or control the packing materials coming into the country. Because of the use of manually signed hardcopy documents and above added complexity, the commercial Letter of Credit has not been able to be adapted to the Internet. That is until now.

The InterNetLC® Letter of Credit is completely online via the Internet and uses only HTML electronic documents for issuing, amending, assigning proceeds, submitting documents and negotiating settlement. It conforms to the guidelines of the UCP whereas other Internet products to not, and use unique rules for their implementation. It is an alternative to the traditional hardcopy Letter of Credit. The InterNetLC® will Internet enable trade finance worldwide for both import and export from and to any country.

### BRIEF SUMMARY OF THE INVENTION

The InterNetLC® Letter of Credit is an Internet alternative for Documentary Letter of Credit transactions. It is a trade finance instrument issued by a bank or corporation via Internet for the purchase and shipment of goods to a buyer. The InterNetLC® conforms to and is negotiable by the ICC Uniform Customs and Practices for Documentary Credits. The InterNetLC® is a secure payment method for transactions that require settlement upon shipment.

The InterNetLC® is negotiable with authenticated e-documents representing the transport Bill of Lading or Air Waybill, Rail Waybill, Straight Bill, Courier Receipt, Invoice, Packing List and Bill of Exchange that are equivalent with the document requirements specified in the InterNetLC® Letter of Credit.

The InterNetLC® transaction process: (1) the buyer and seller register with and agree to settle their transactions following the InterNetLC® Business Rules and ICC Uniform Customs and Practices for Documentary Credits, (2) the buyer places a InterNetLC® issued by a InterNetLC® licensed banking institution, (3) the seller ships the goods and submits digital authenticable e-documents of the ILC Transport Bill of Lading, ILC Invoice and ILC Packing list to for negotiation, and (4) the InterNetLC® is negotiated and payment is made to the seller and any assigned proceeds to third parties if the document contents are equivalent to the issued InterNetLC® requirements. The original transport documents are sent immediately upon shipment to the buyer by the seller or the freight forwarder to eliminate delays clearing customs.

InterNetLC® negotiation includes: (1) verifying the authentication of the submitted documents with digital identification; (2) comparing the documents equivalency with the issued InterNetLC®; (3) making payment minus fees if equivalent; (4) requesting buyer approval for making payment if not equivalent; (5) returning funds minus fees to the buyer if not approved and after the goods are returned; and (6) referring the transaction to arbitration in the event of a dispute between the buyer and seller. As with any Letter of Credit the InterNetLC® transaction does not concern itself in any way with the goods, shipment thereof, or contract performance, only with the required documents evidencing movement, value, content and time. The InterNetLC® Letter of Credit:

Conforms to the ICC Uniform Customs and Procedures

Can be paid within 24 hours of document presentation

Will not delay custom clearance waiting for original documents

Will average less then 5% discrepant presentations

Requires only Internet transmitted E-documents

Is completely online and paperless

Costs a fraction of traditional hardcopy Letters of Credit

The InterNetLC® is fast, simple, secure and totally online.

### BRIEF DESCRIPTION OF THE SEVERAL VIEWS OF THE DRAWING

Drawing No. 1: How the InterNetLC Works

Simple schematic of the InterNetLC process steps.

Drawing No. 2: InterNetLC Concept

Presentation of the InterNetLC concept.

Drawing No. 3: InterNetLC Label Data Field Cross Reference

List of data fields and their related forms.

Drawing No. 4: InterNetLC Data Base Field Names

Computer field names of data fields.

Drawing No. 5: InterNetLC Transaction HTML Forms

HTML form design and layout of each InterNetLC transaction form.

Drawing No. 6: Functional Product Workflow & Architecture

Logic diagram and flow chart of InterNetLC functions.

### DRAWINGS

Drawing No. 1: How InterNetLC Letters of Credit Works

Drawing No. 2: InterNetLC Concept

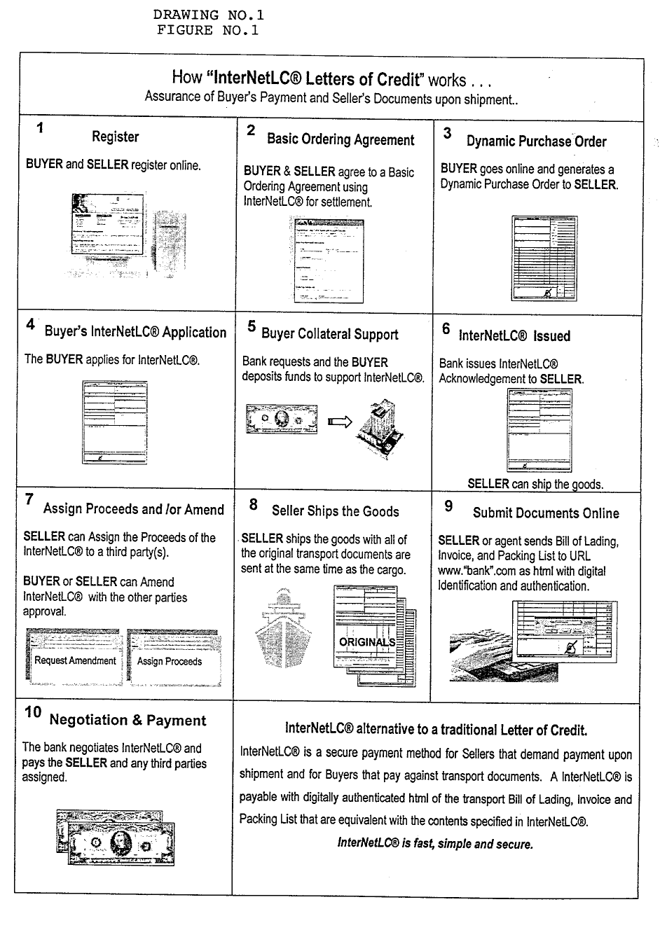

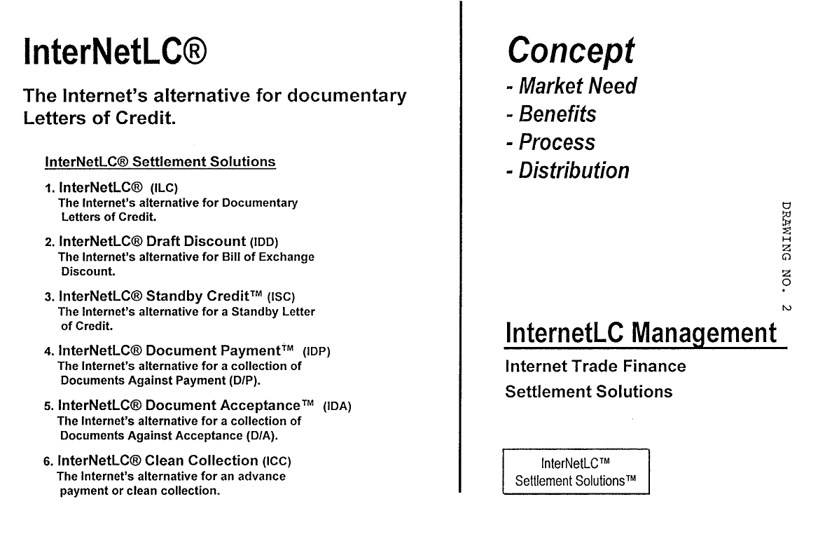

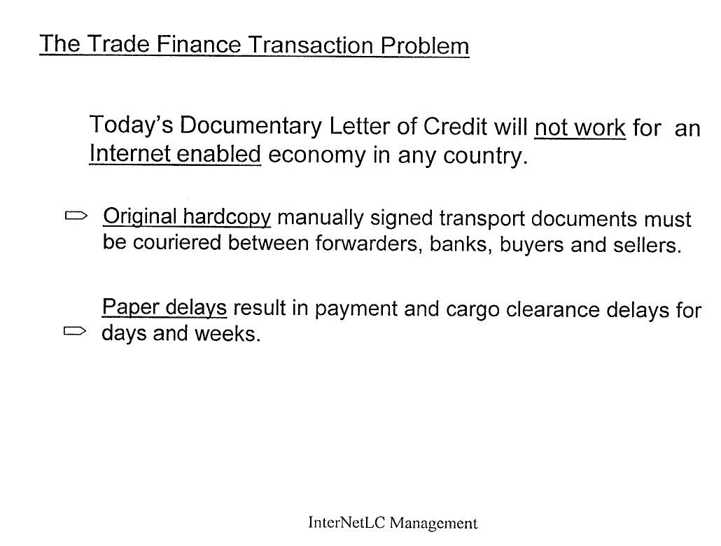

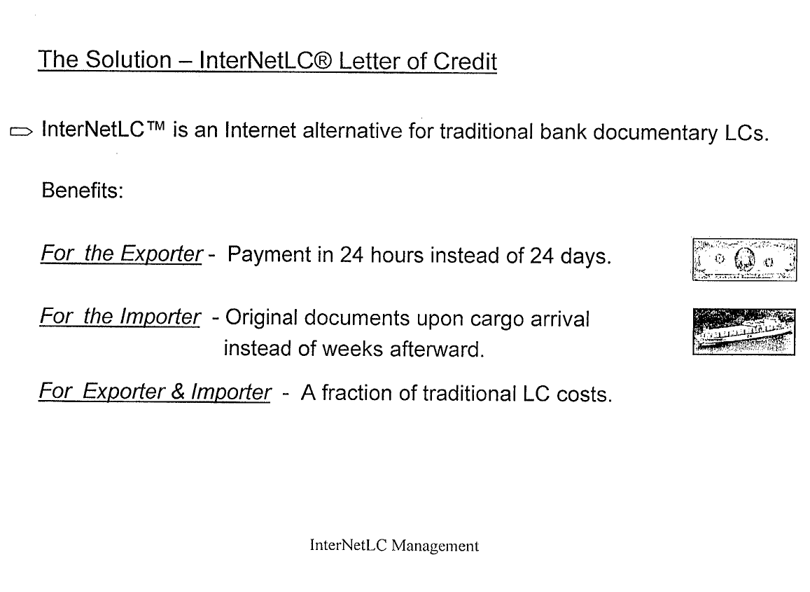

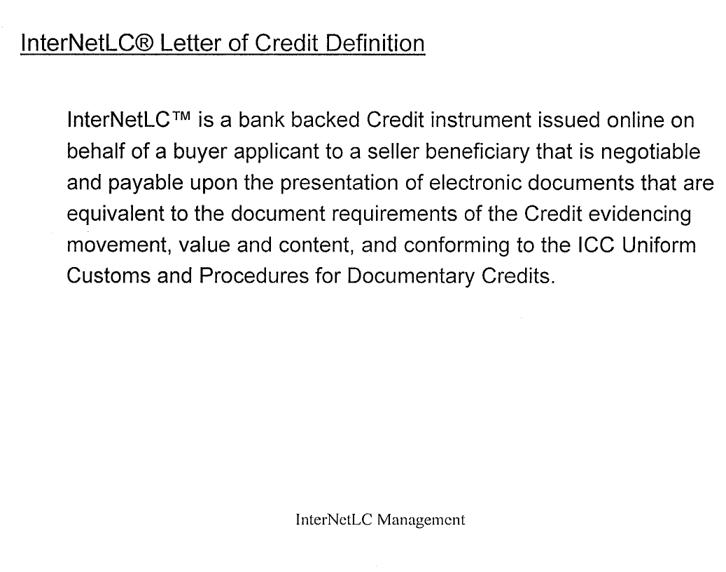

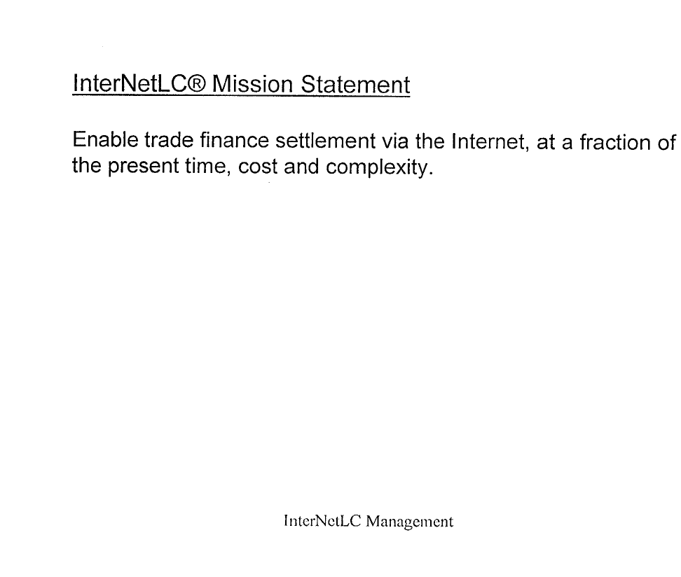

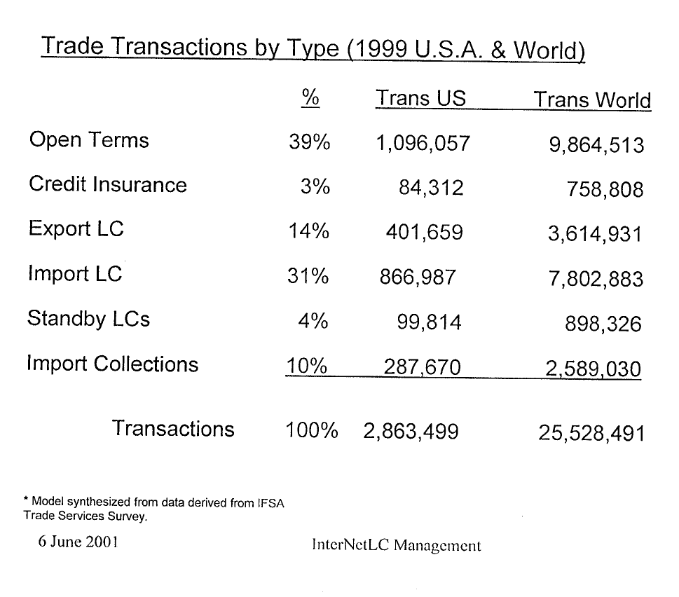

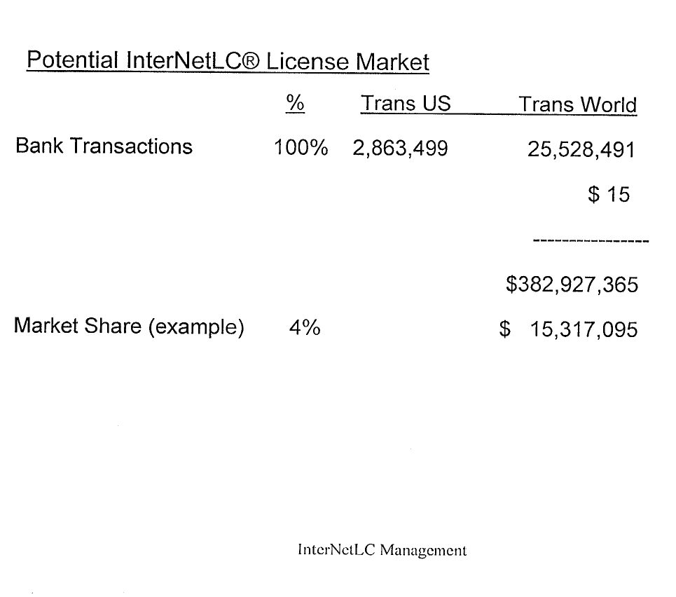

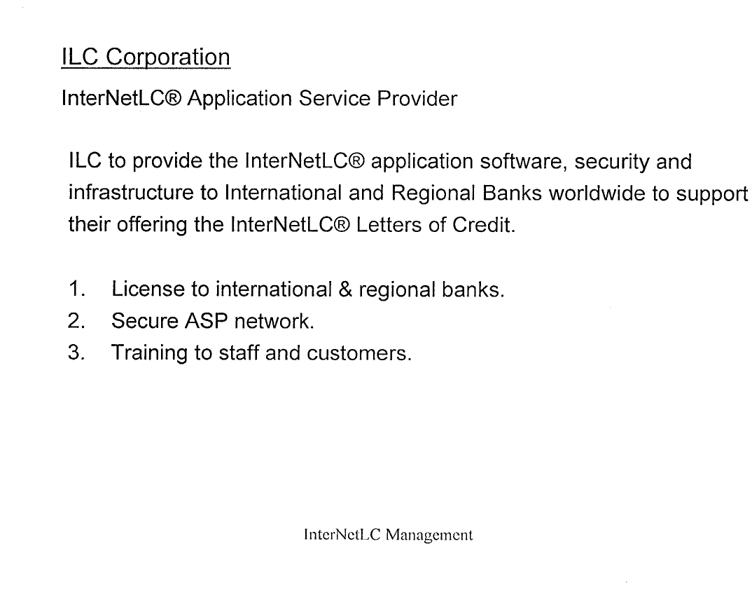

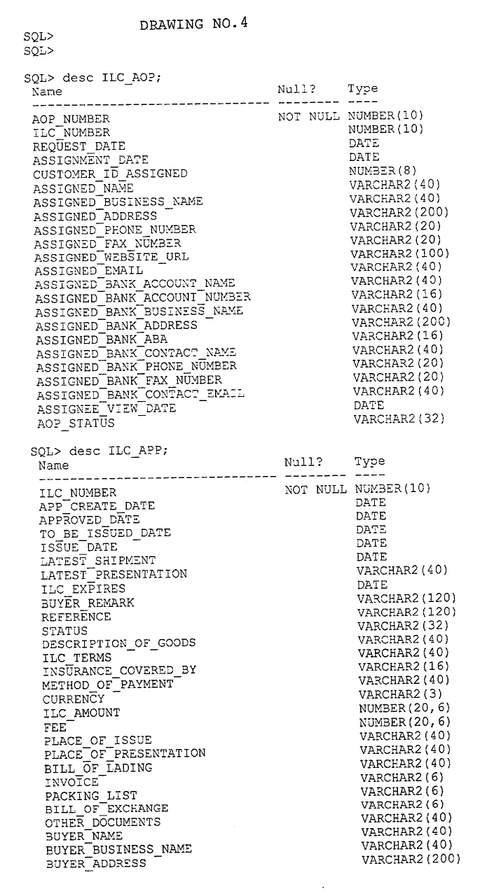

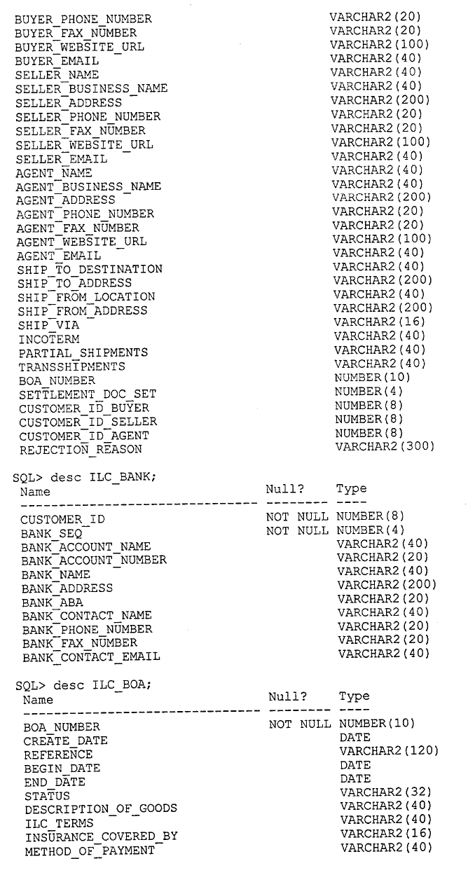

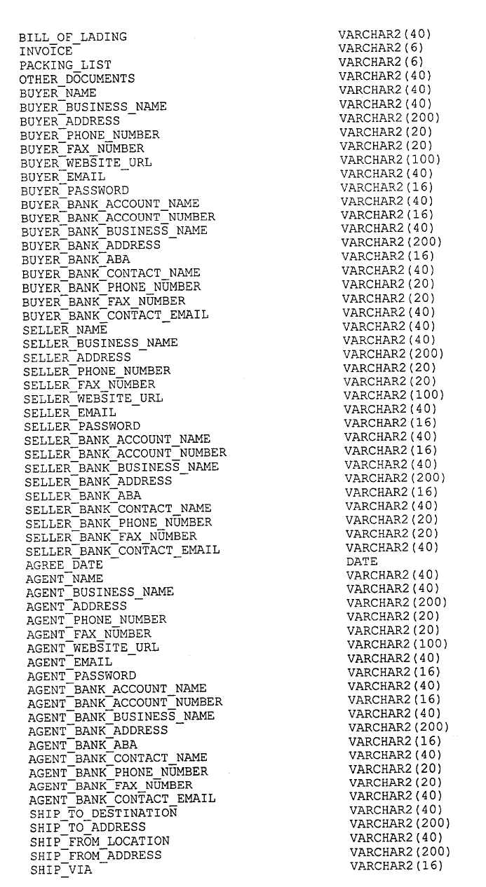

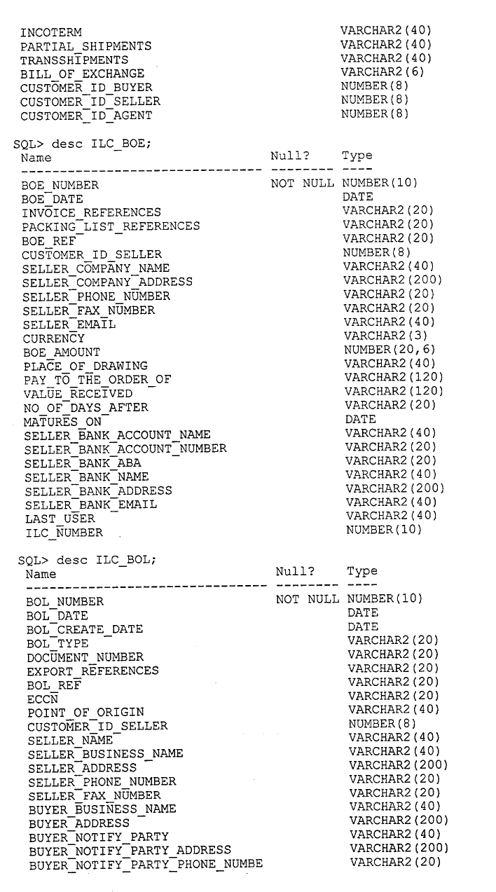

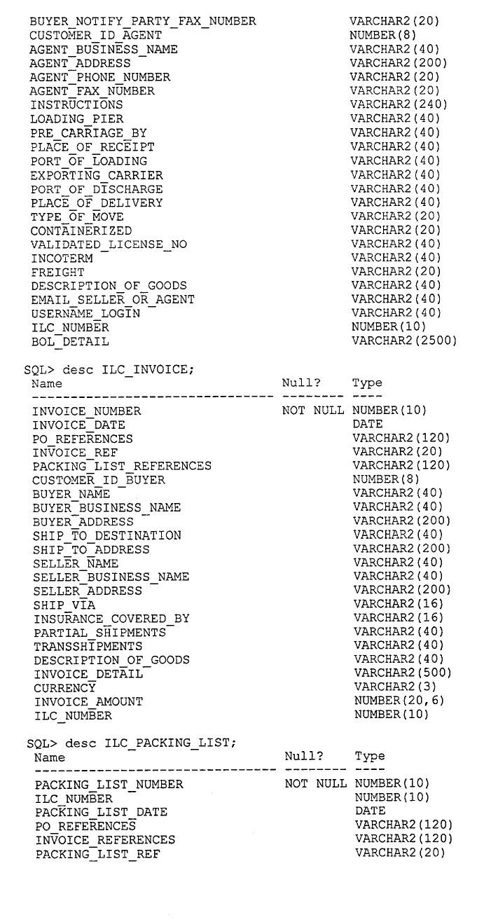

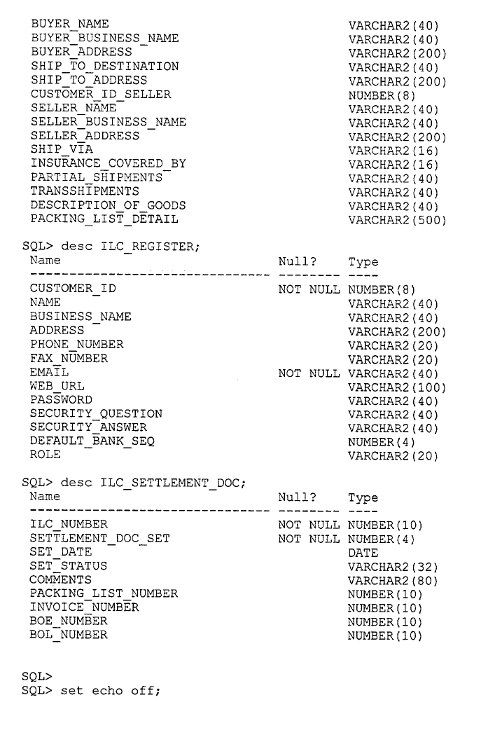

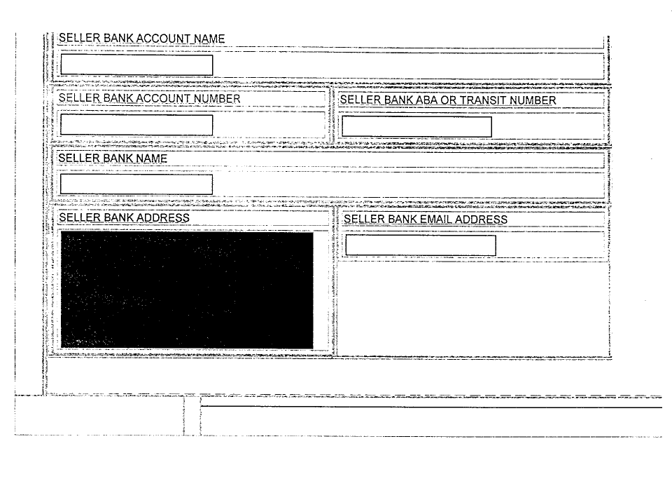

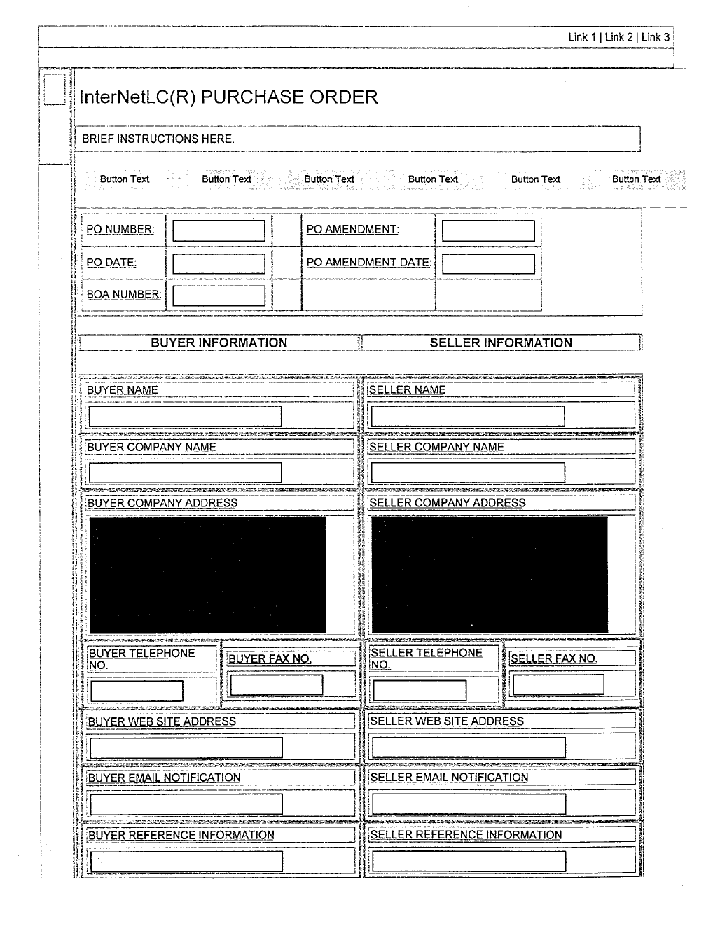

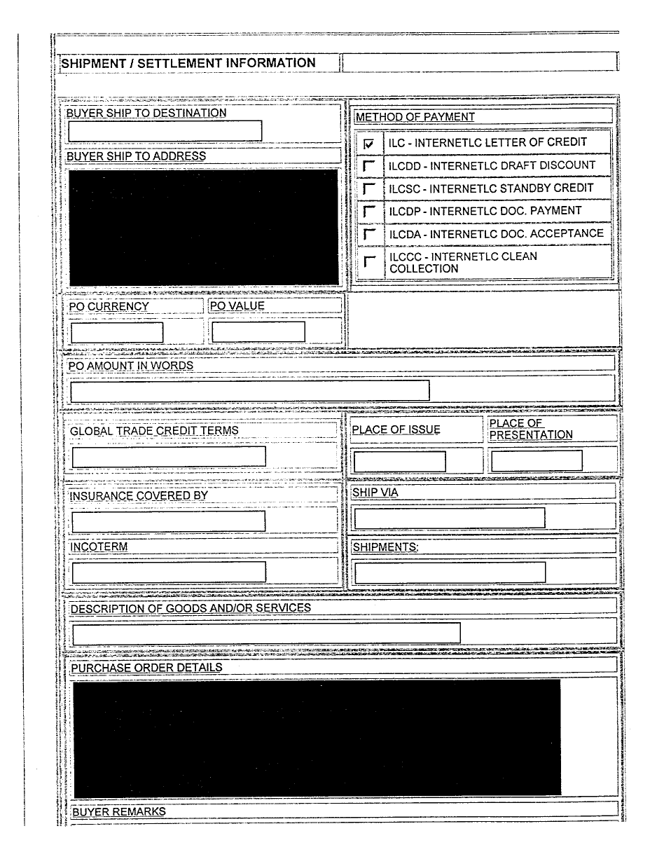

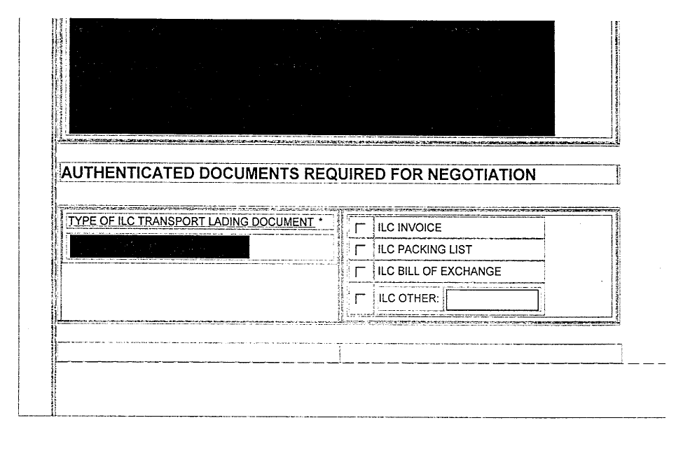

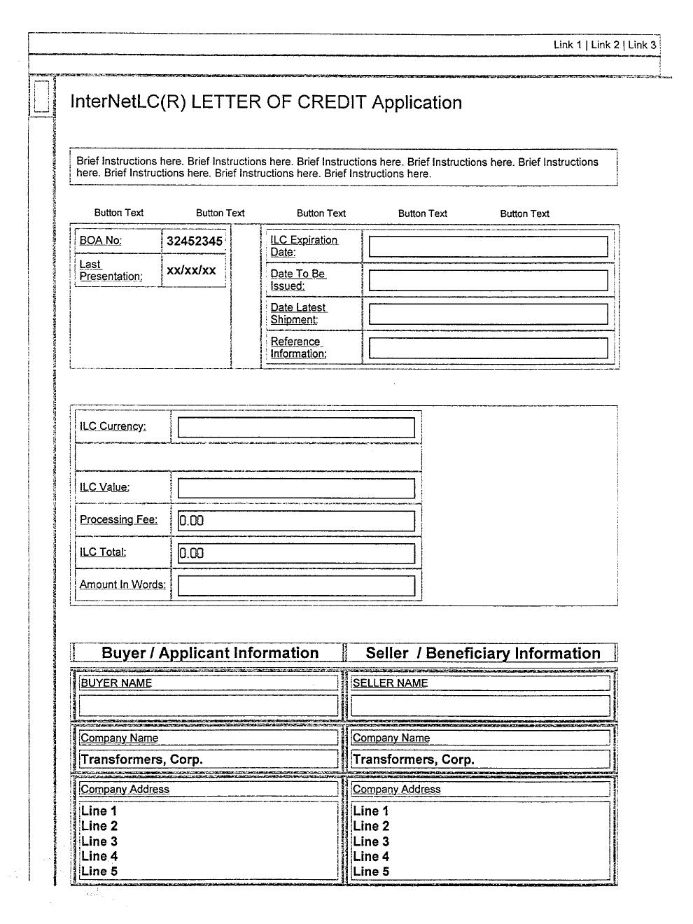

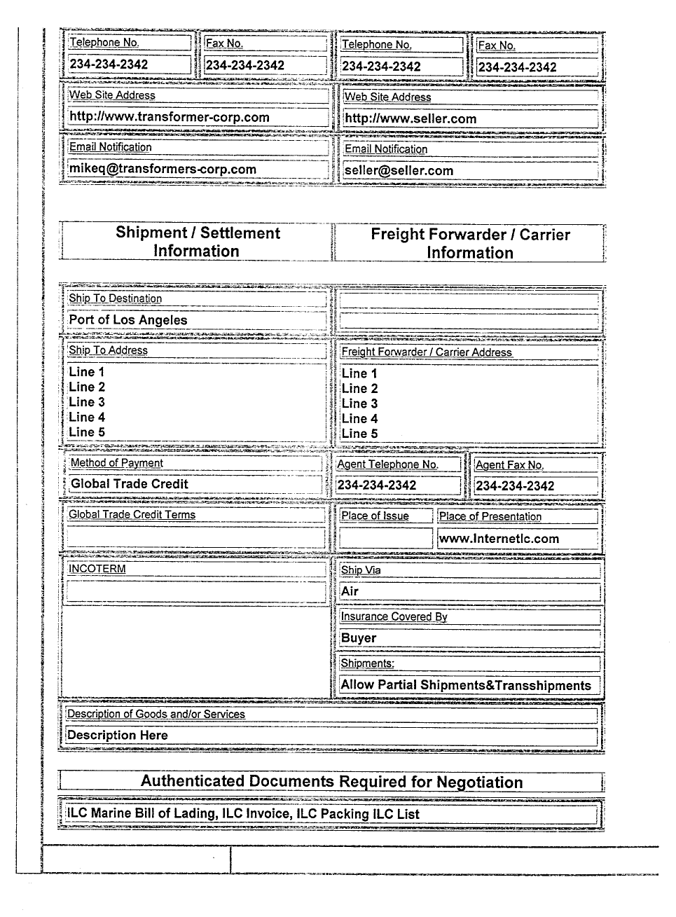

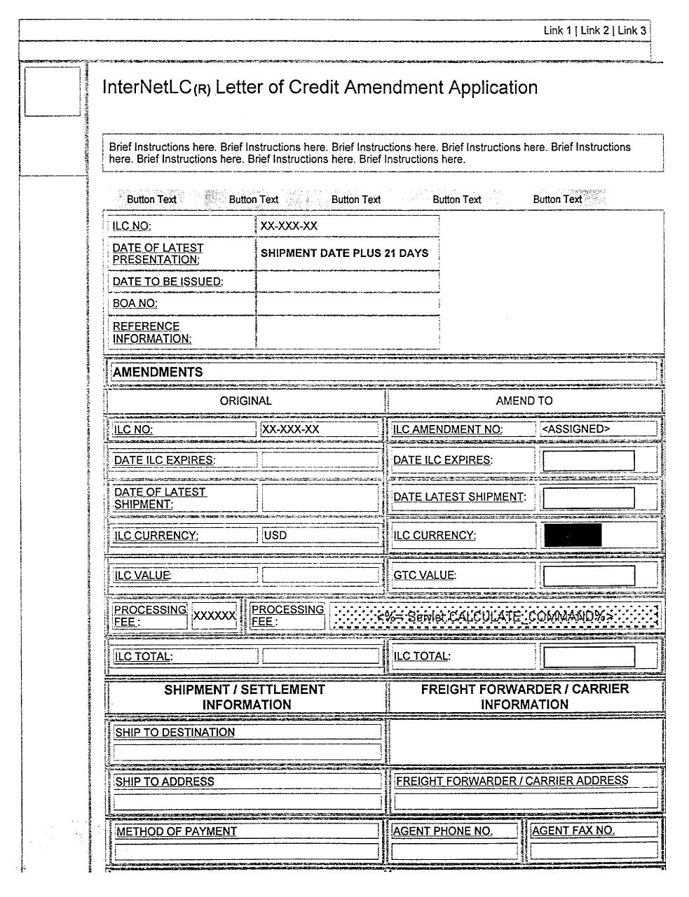

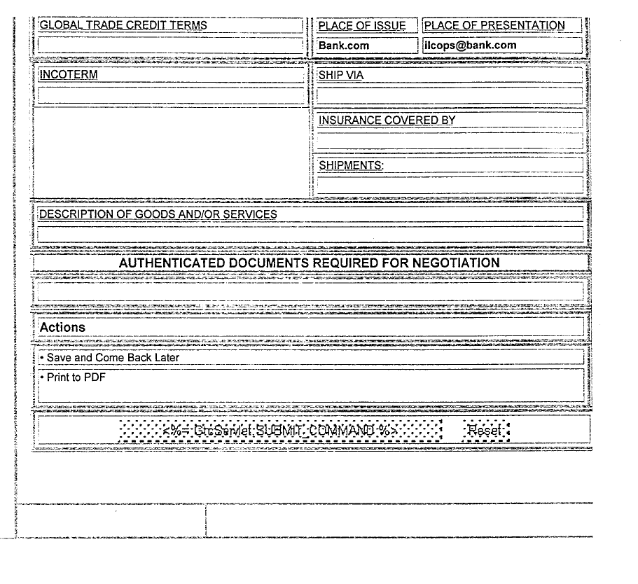

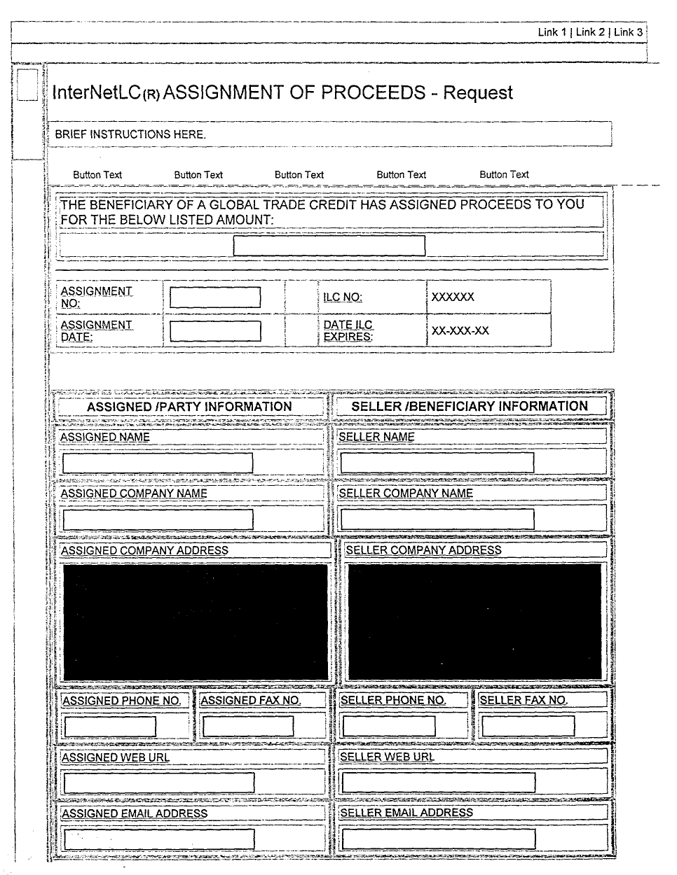

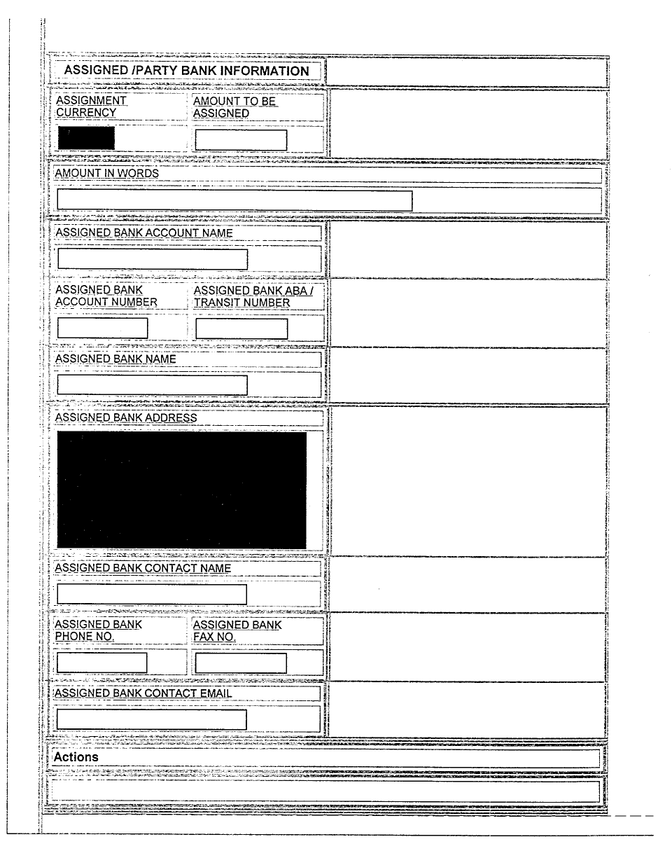

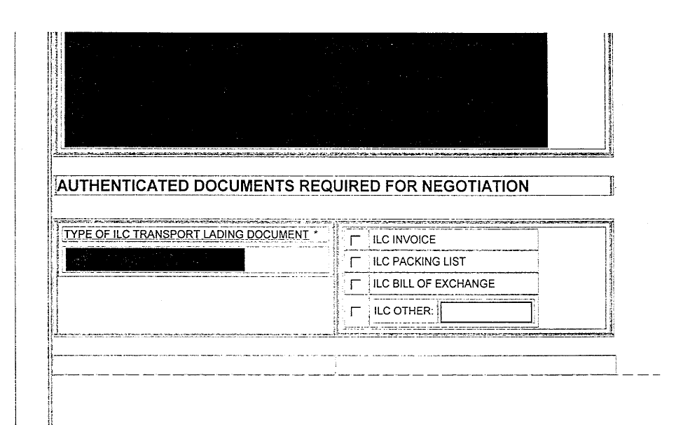

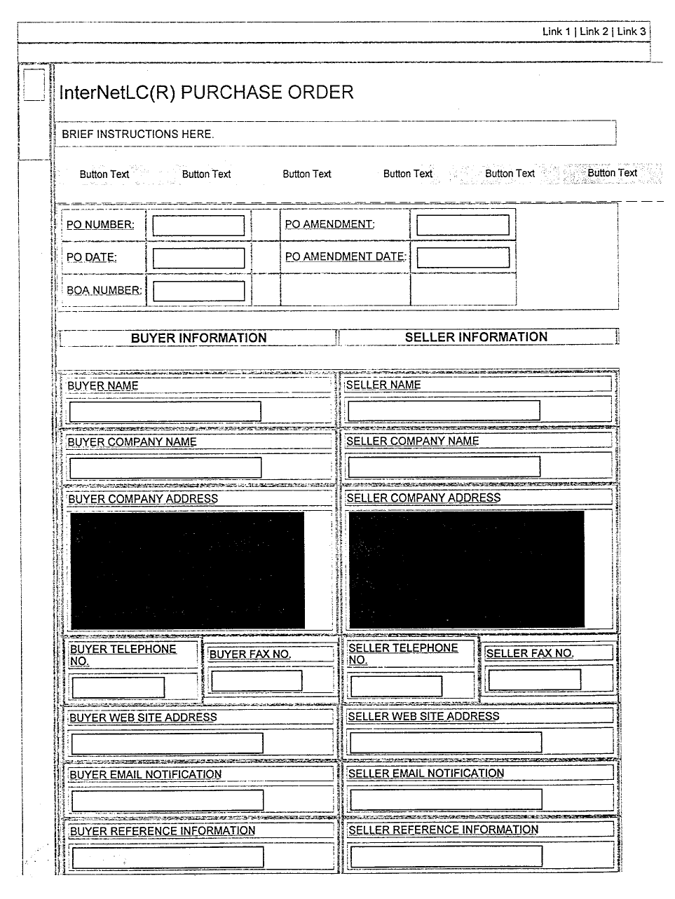

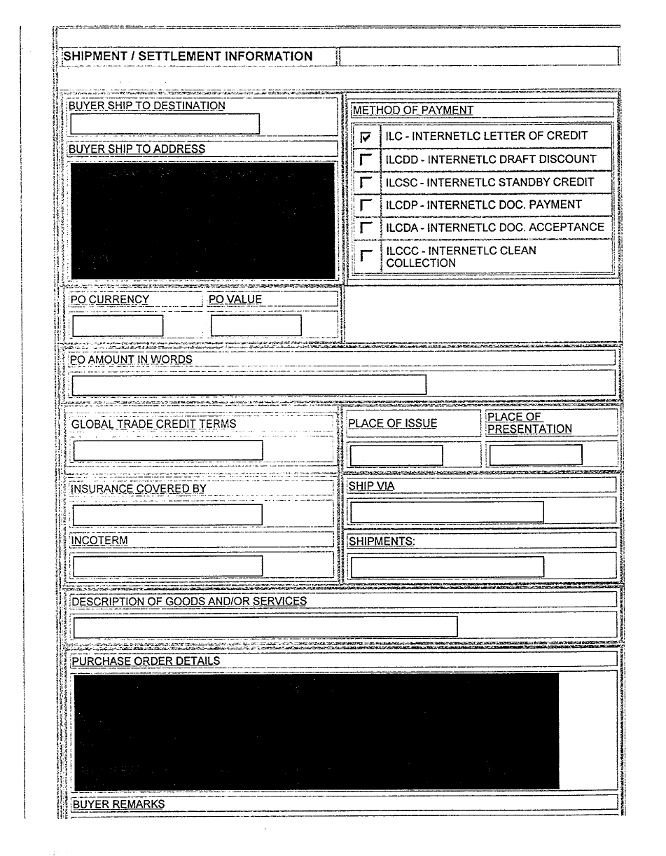

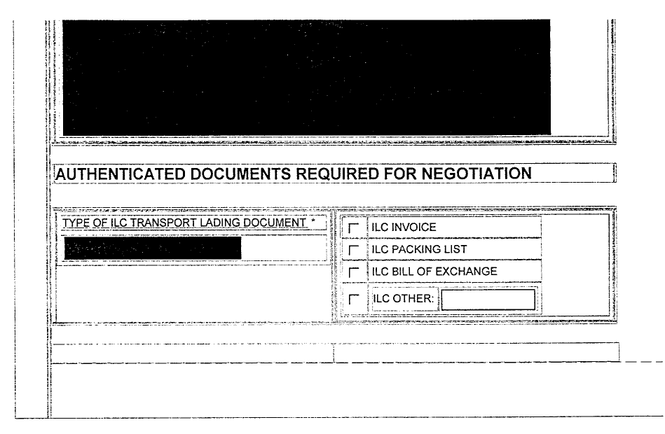

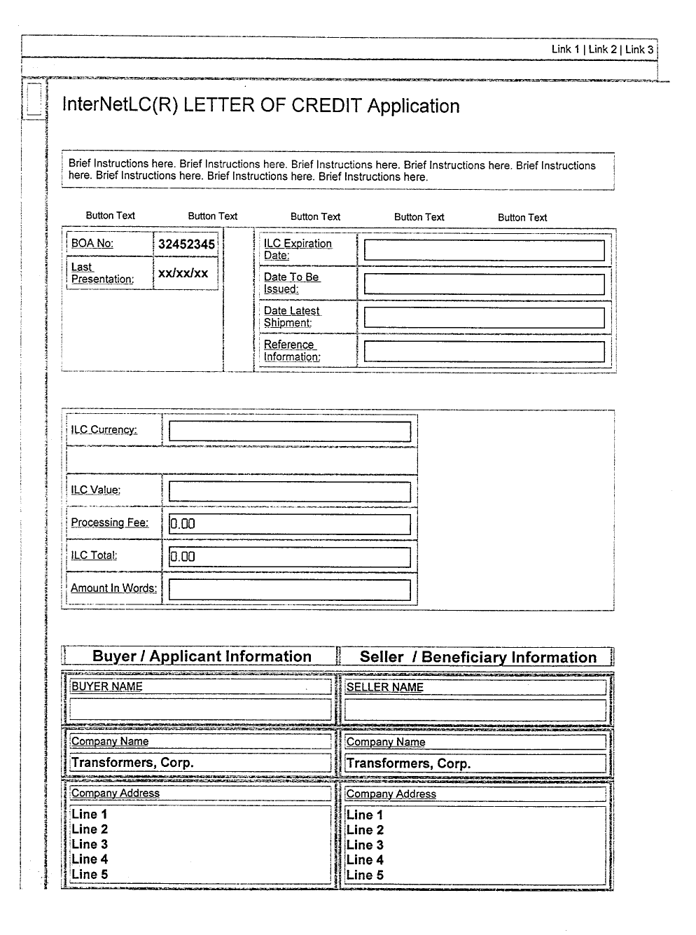

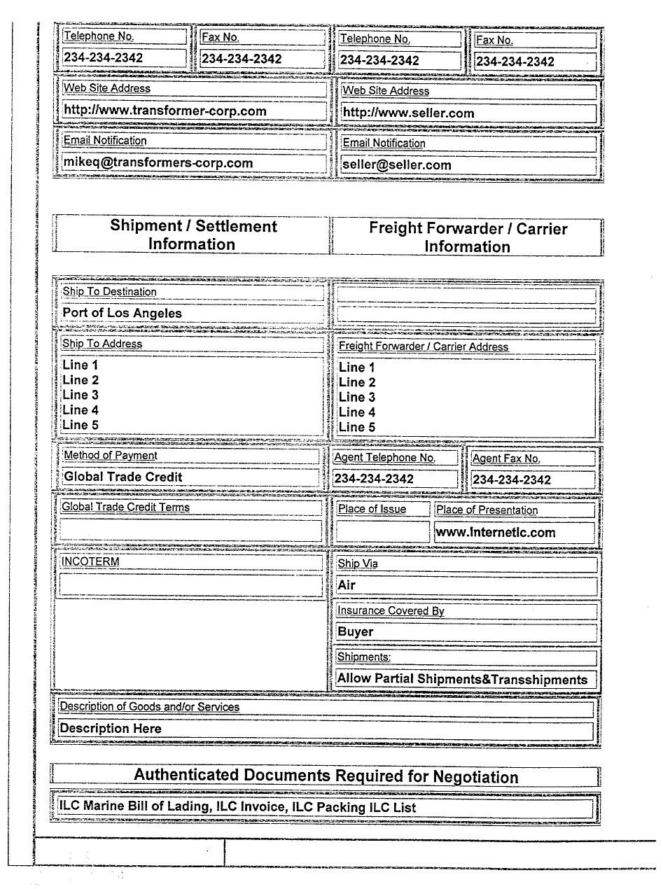

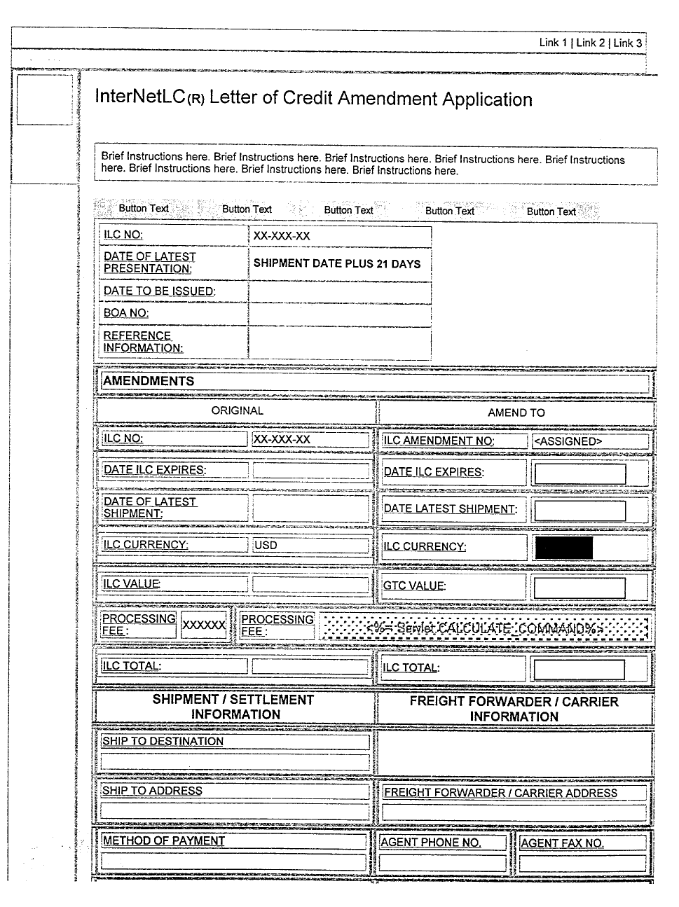

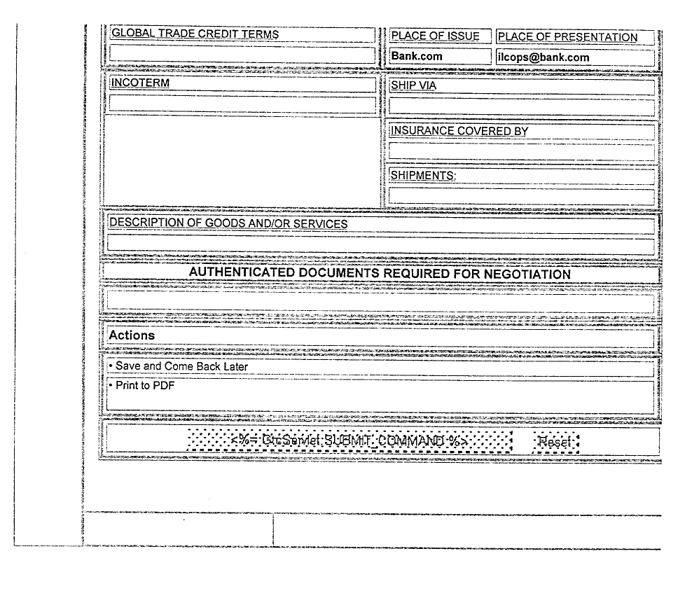

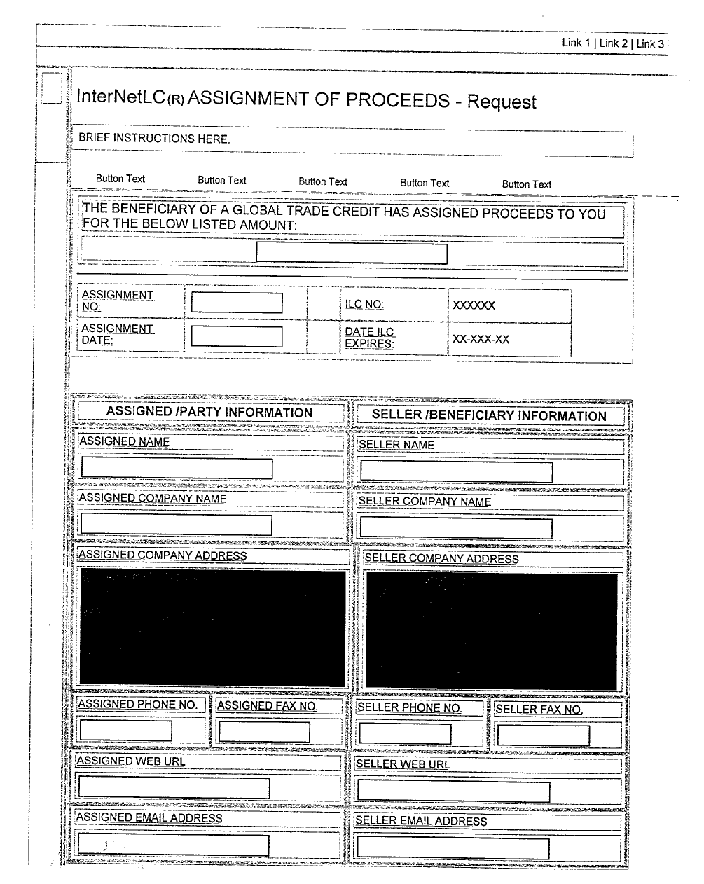

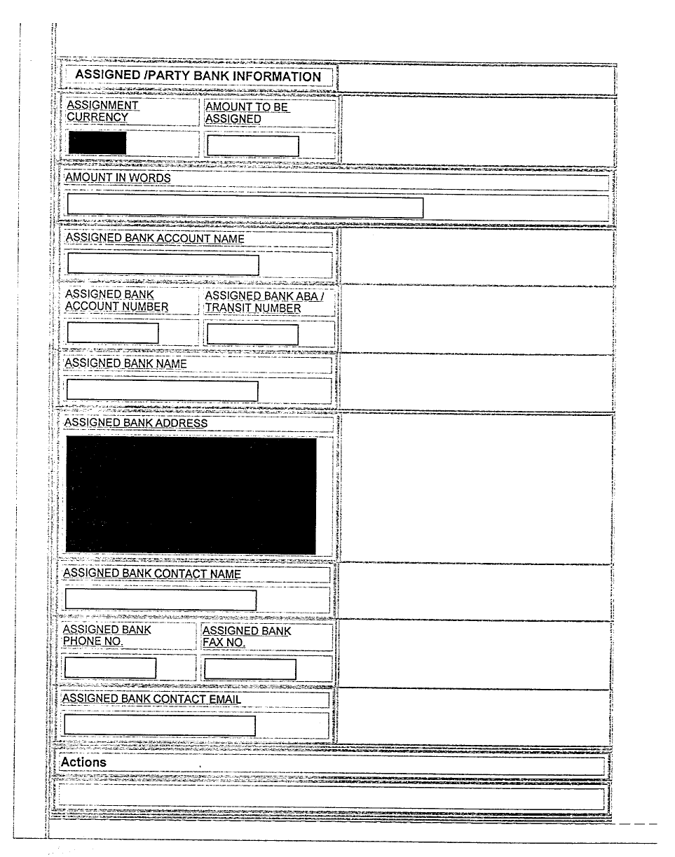

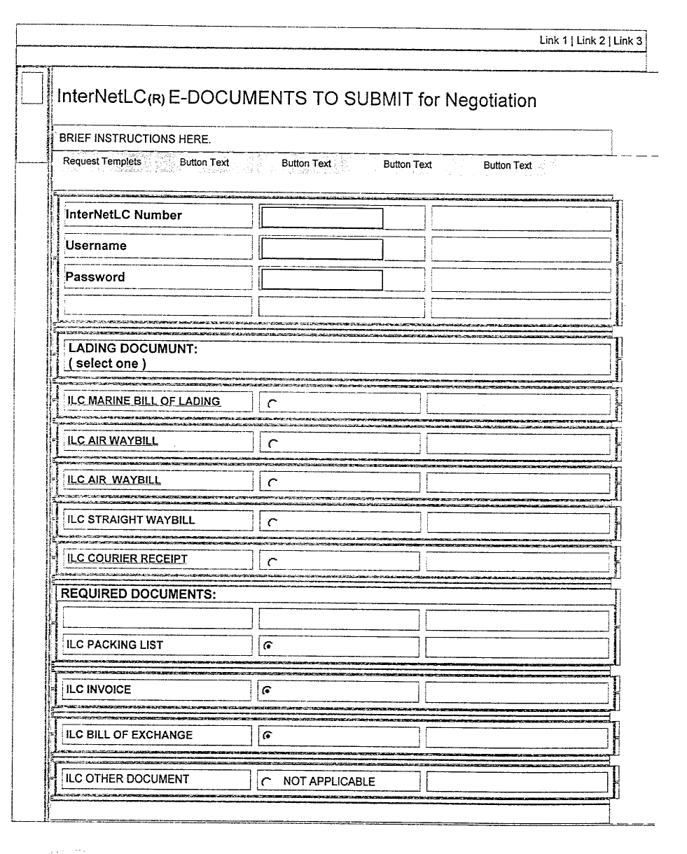

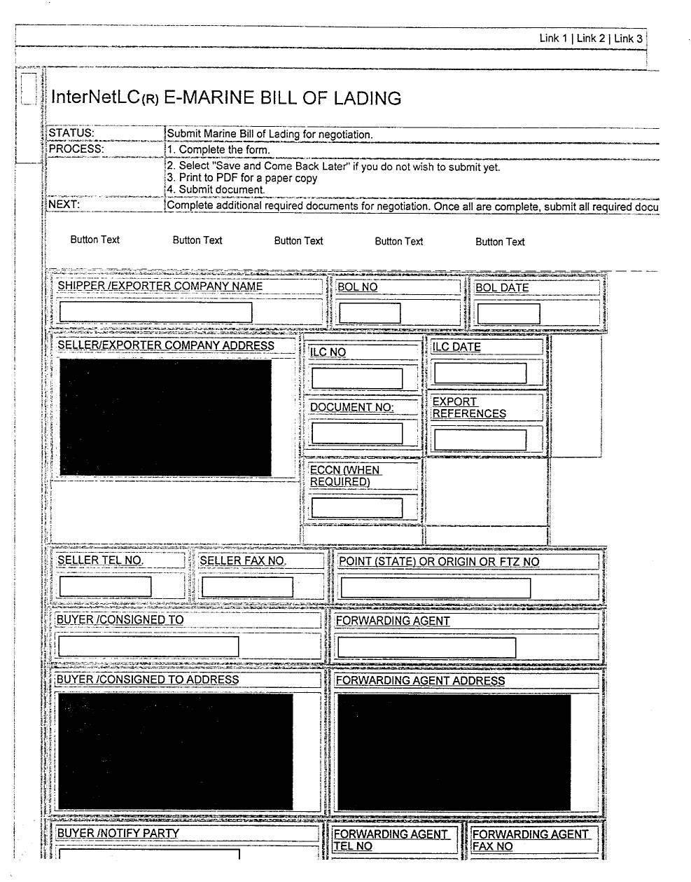

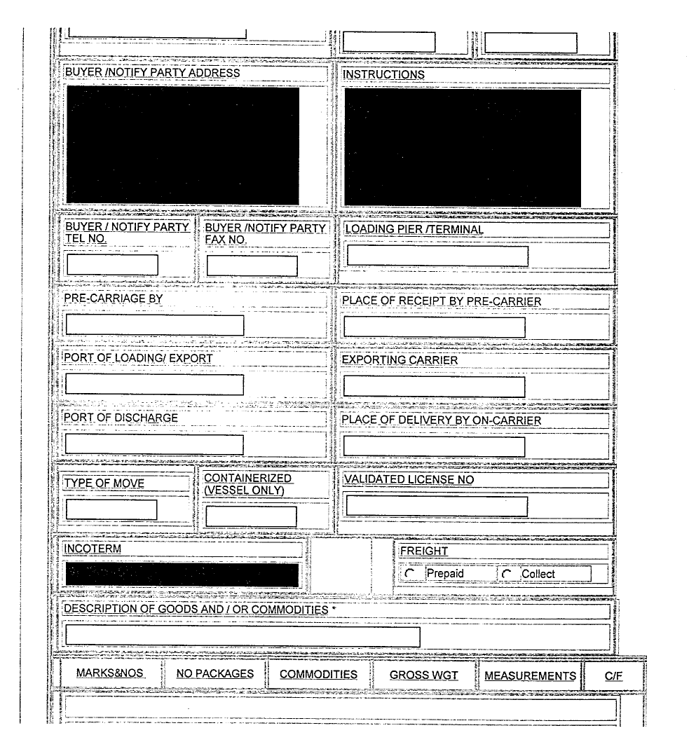

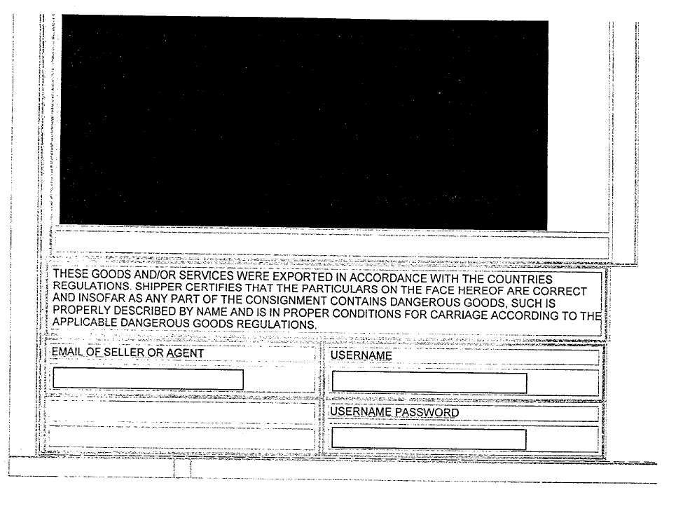

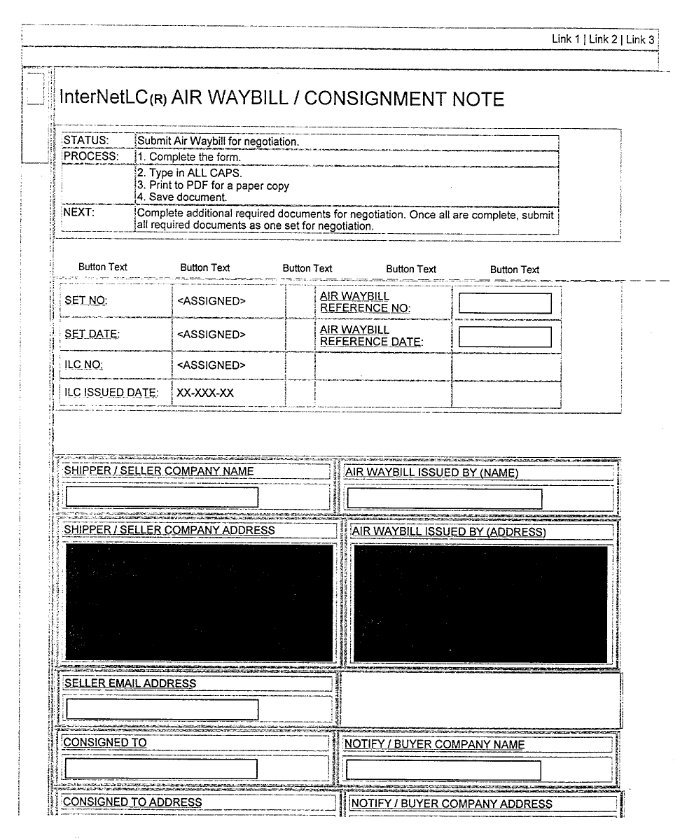

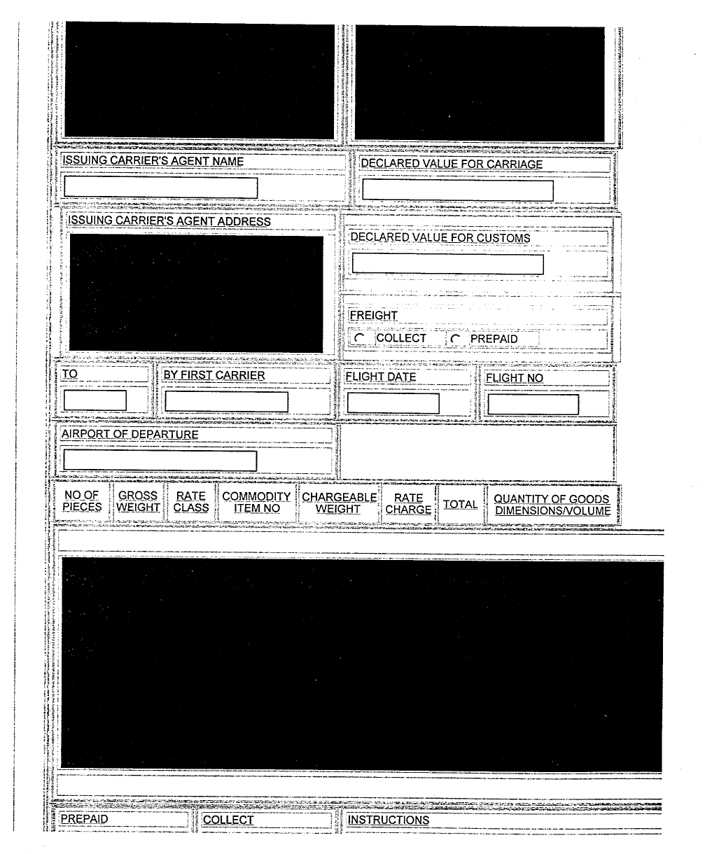

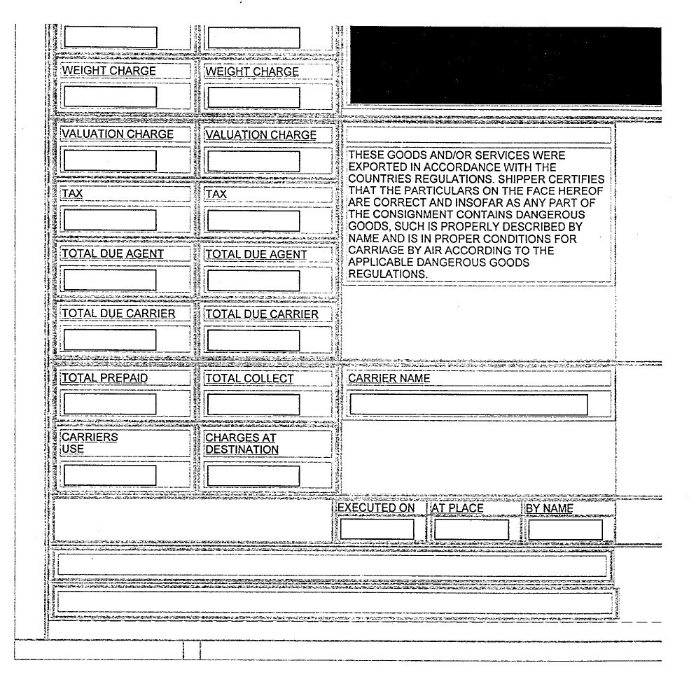

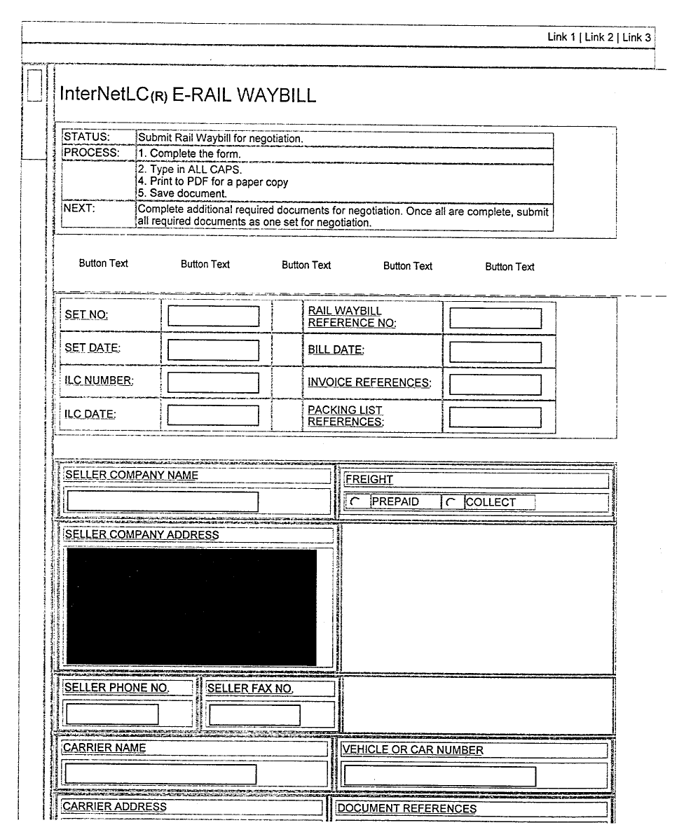

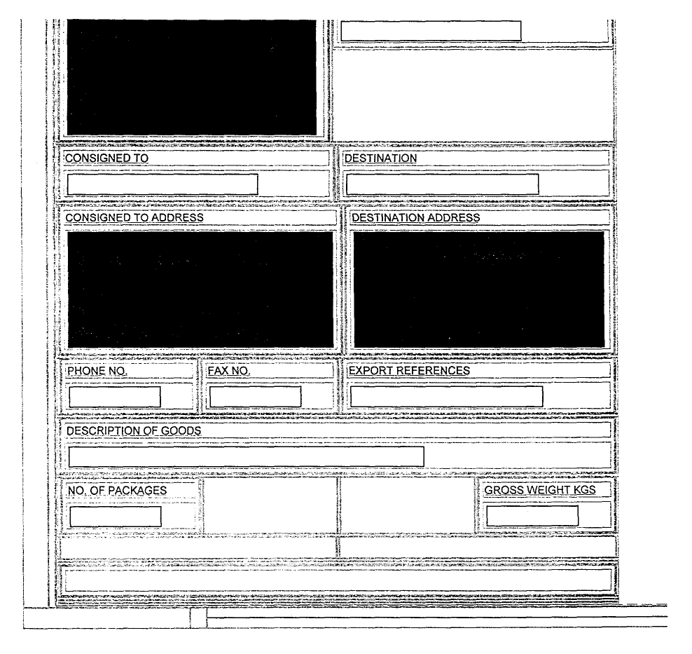

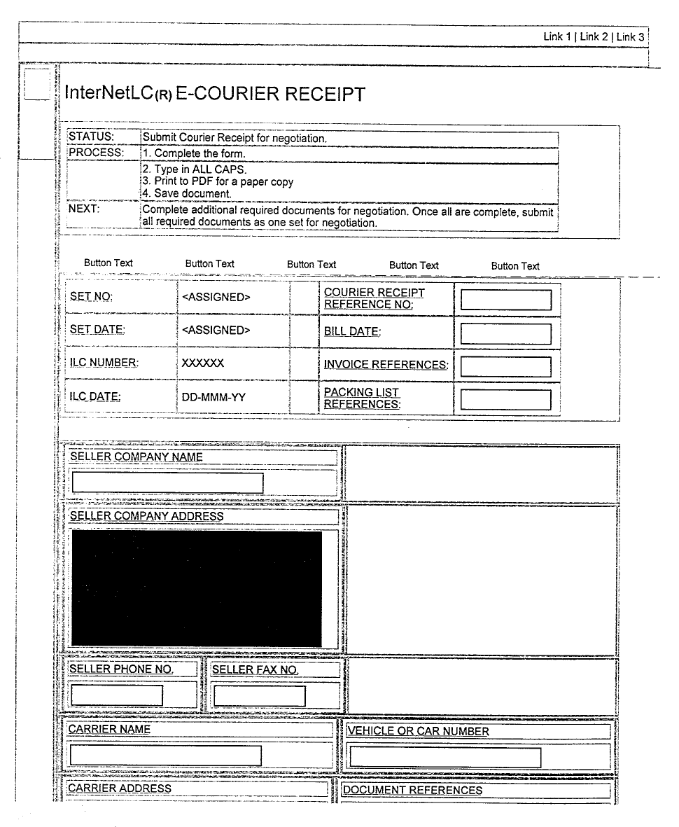

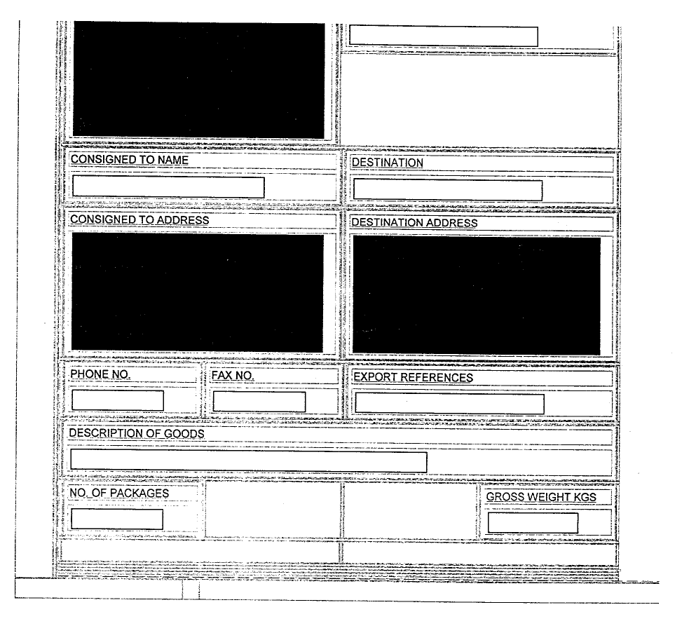

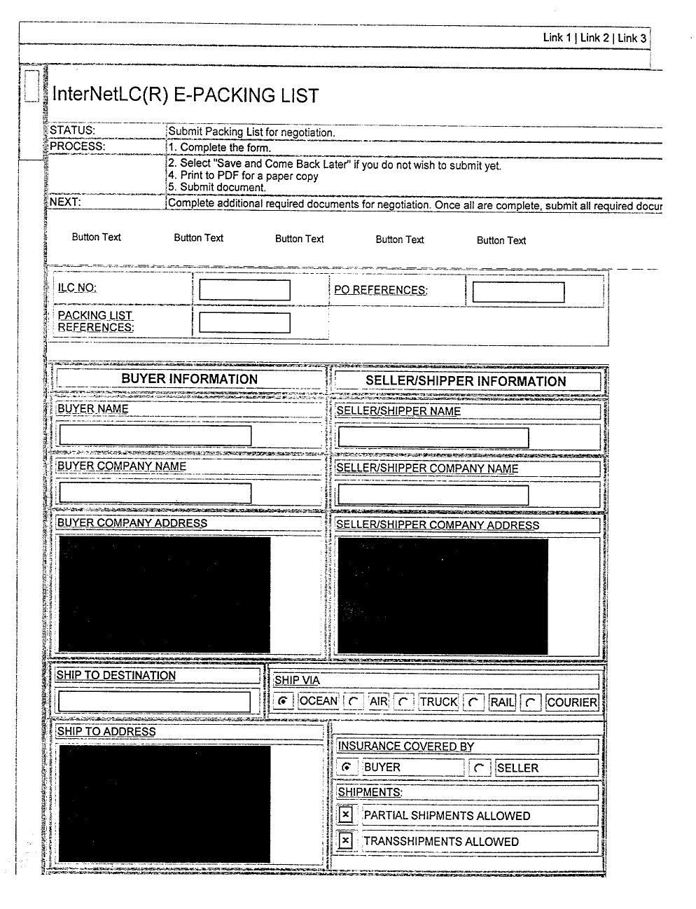

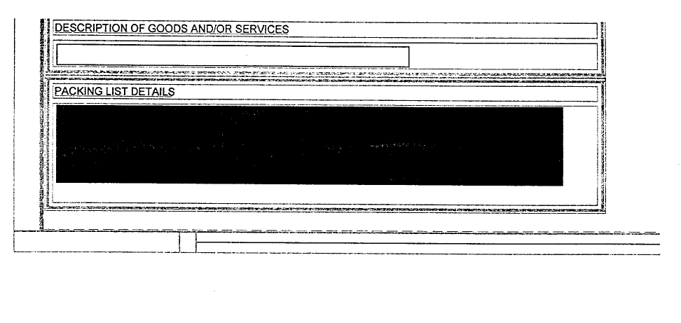

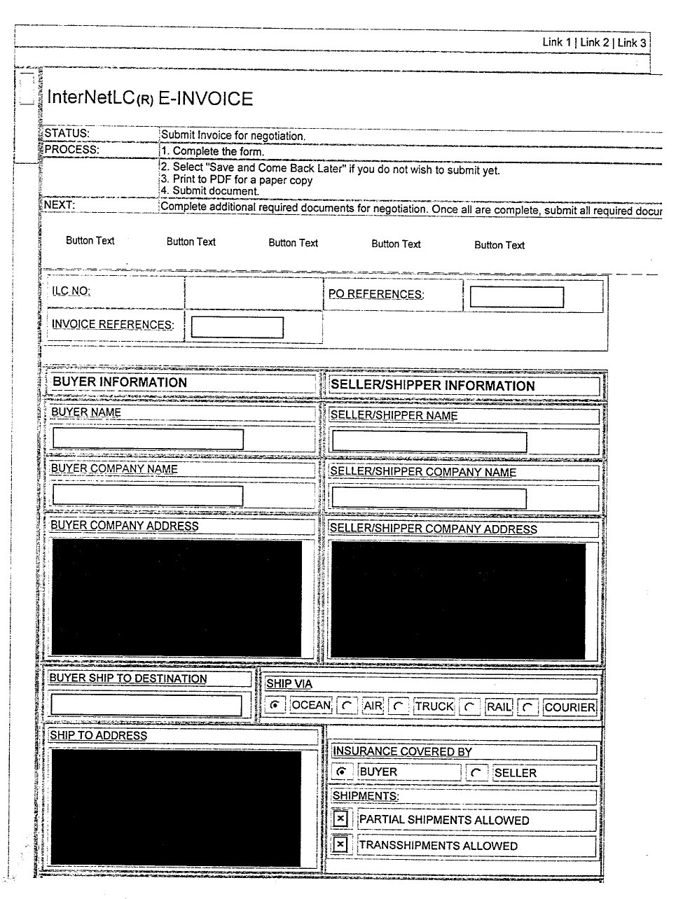

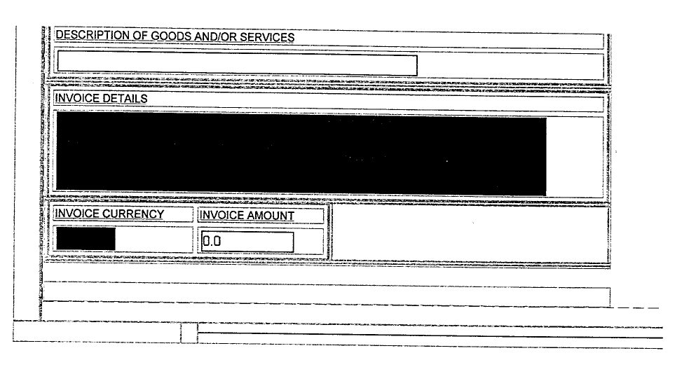

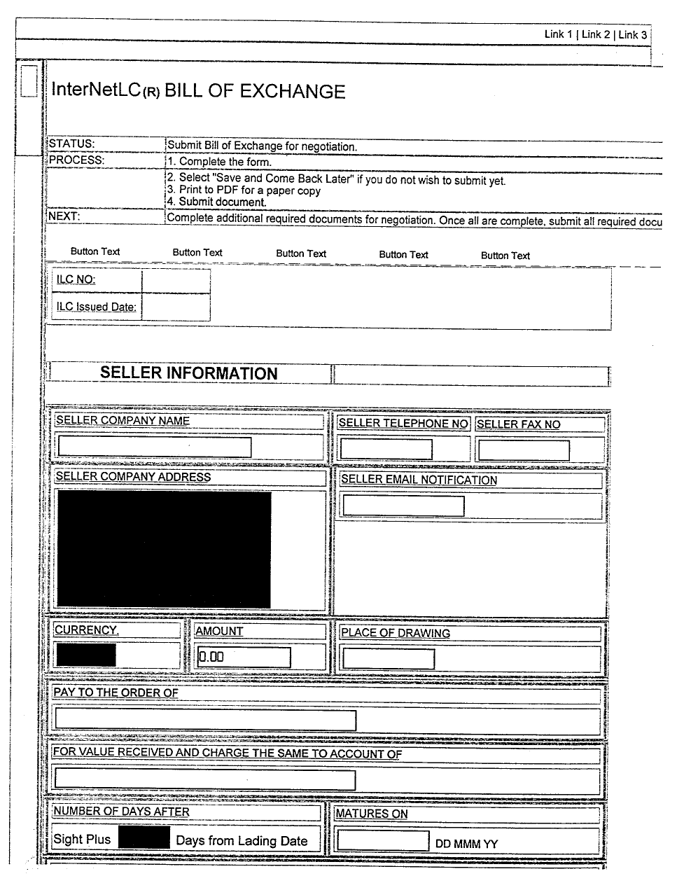

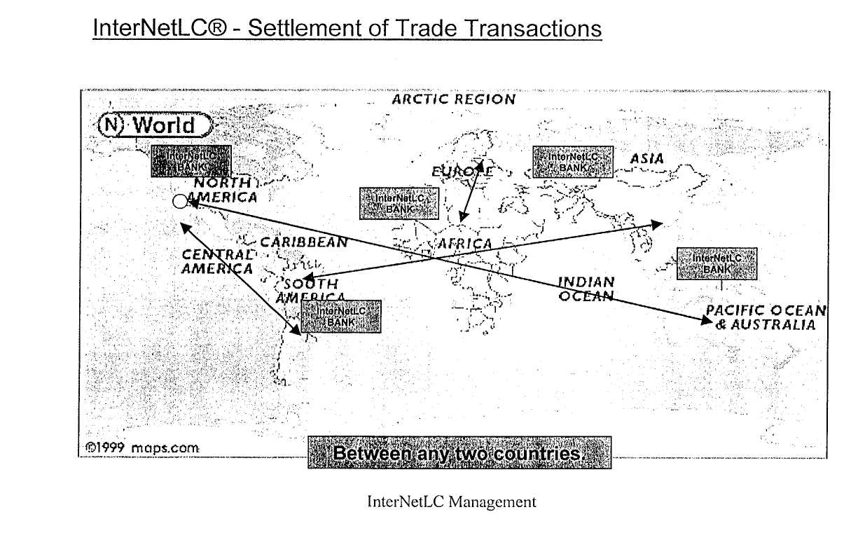

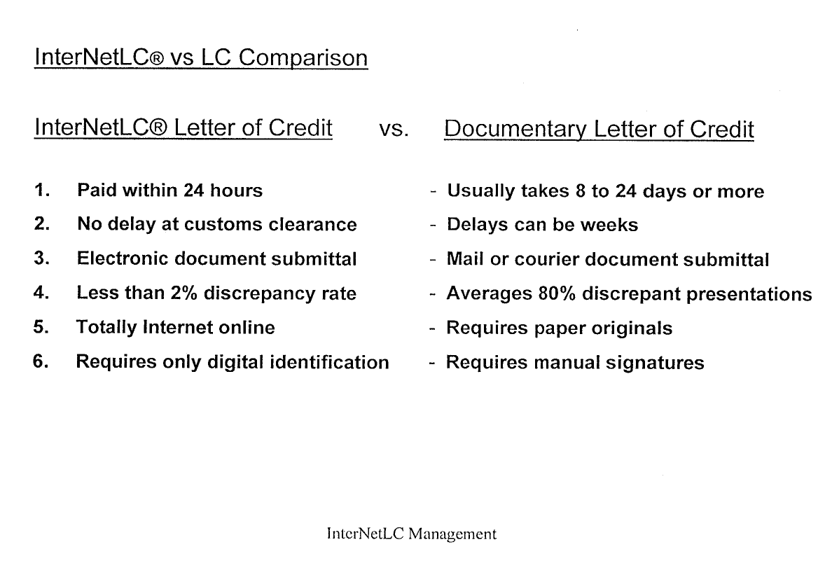

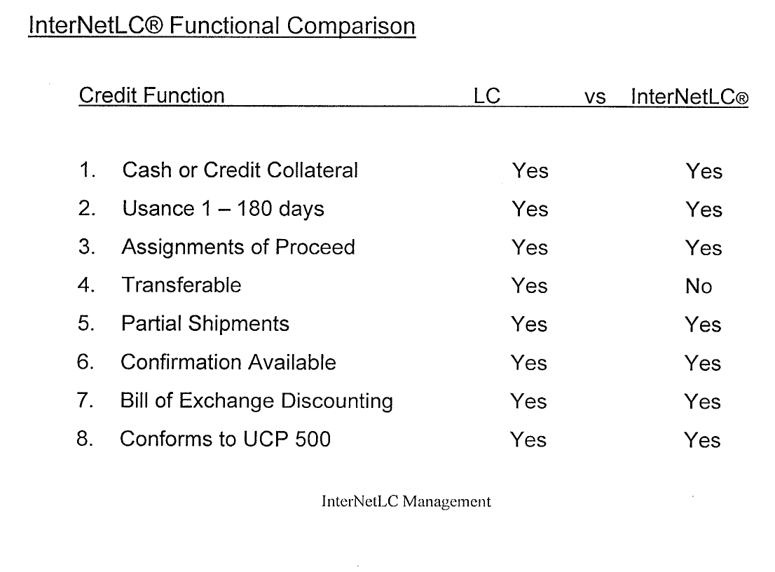

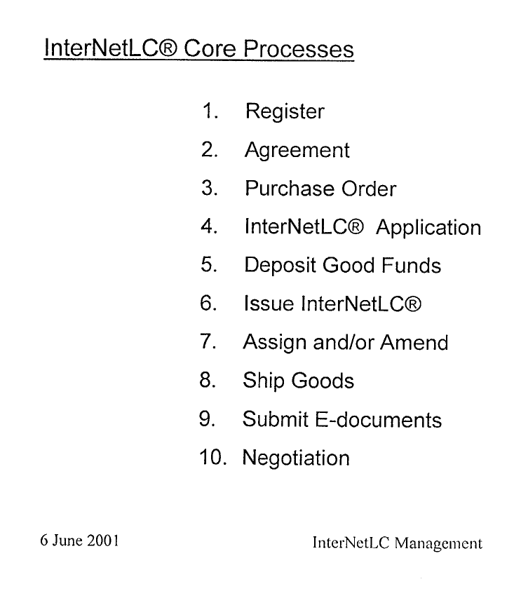

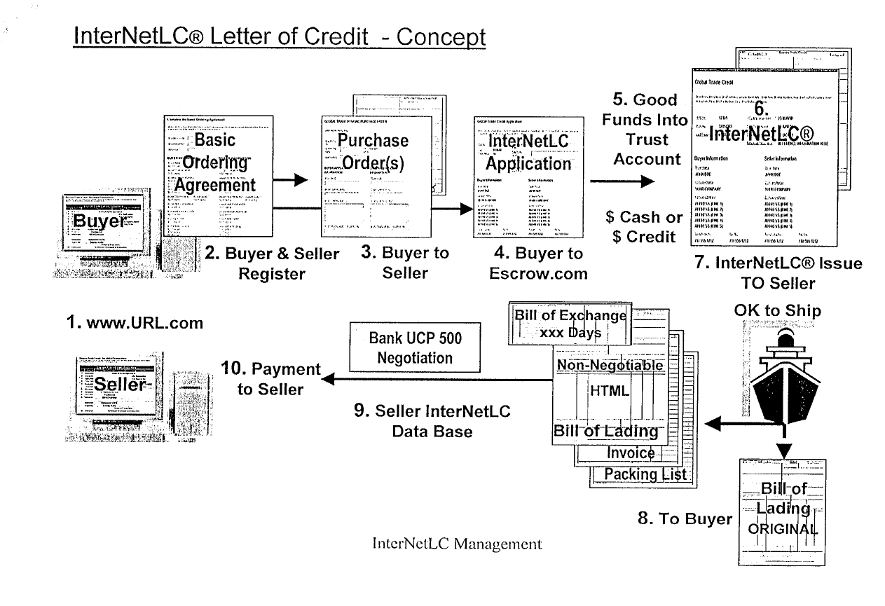

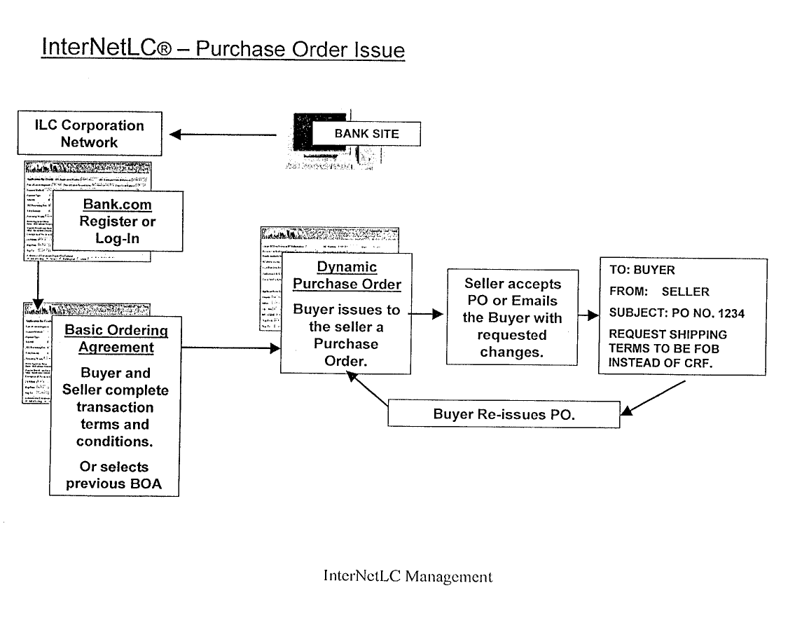

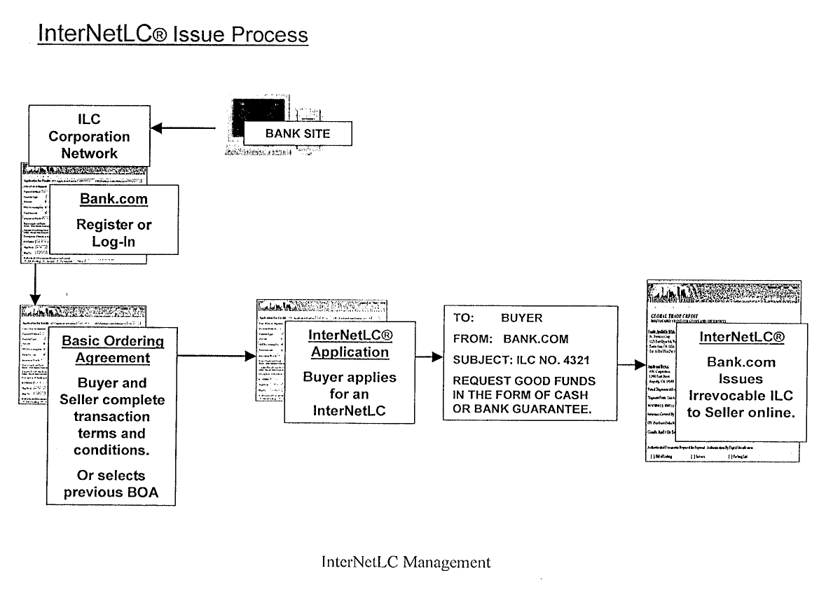

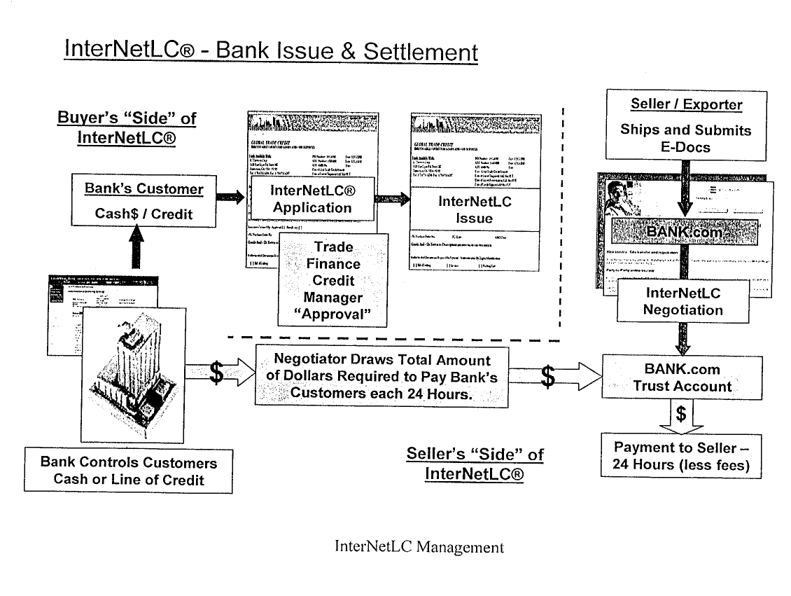

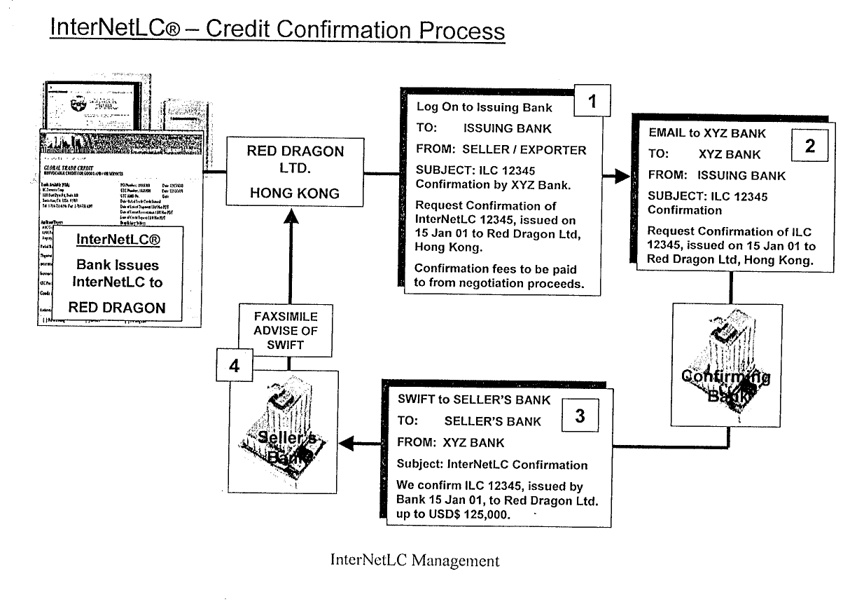

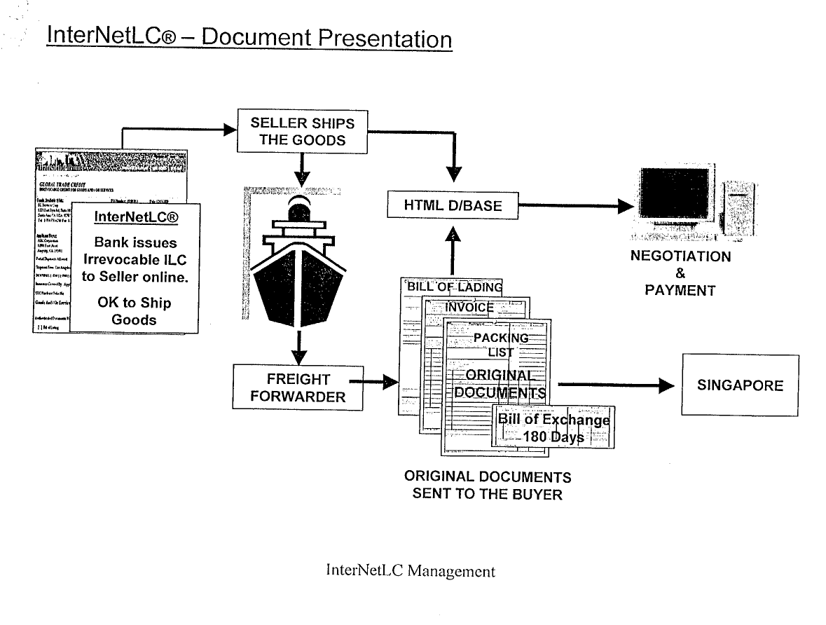

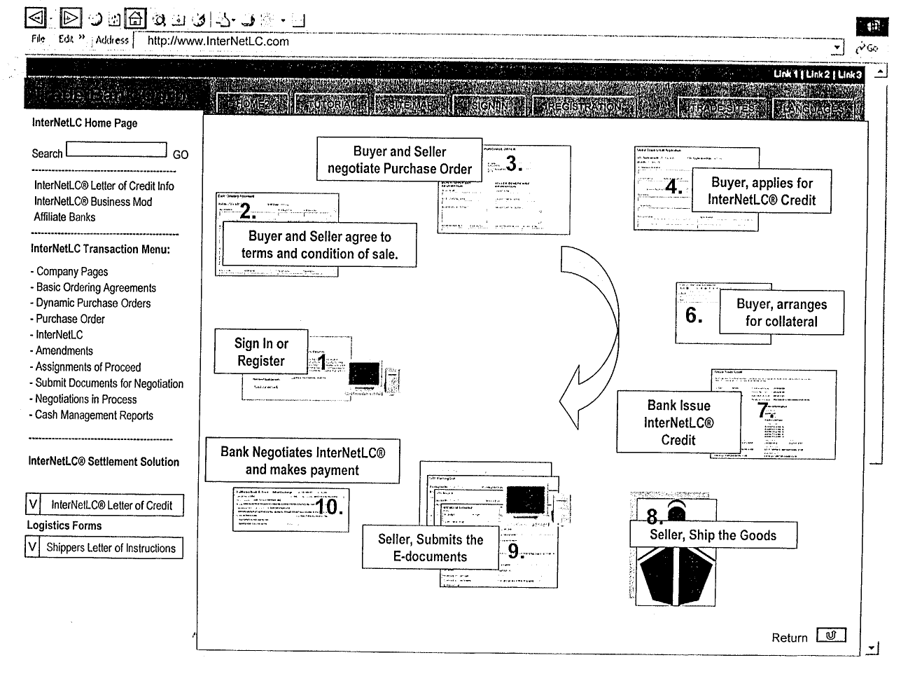

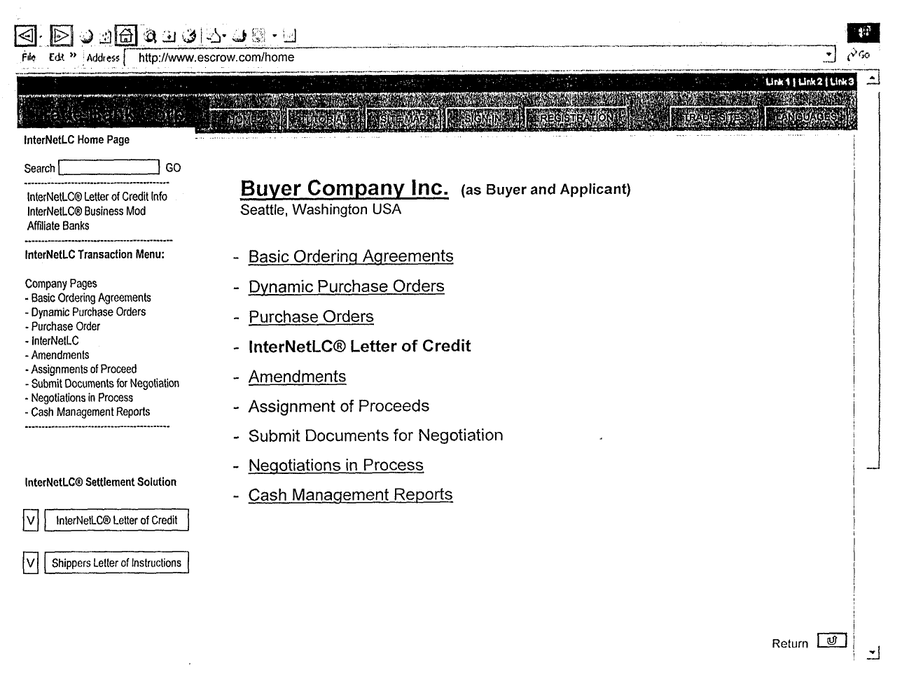

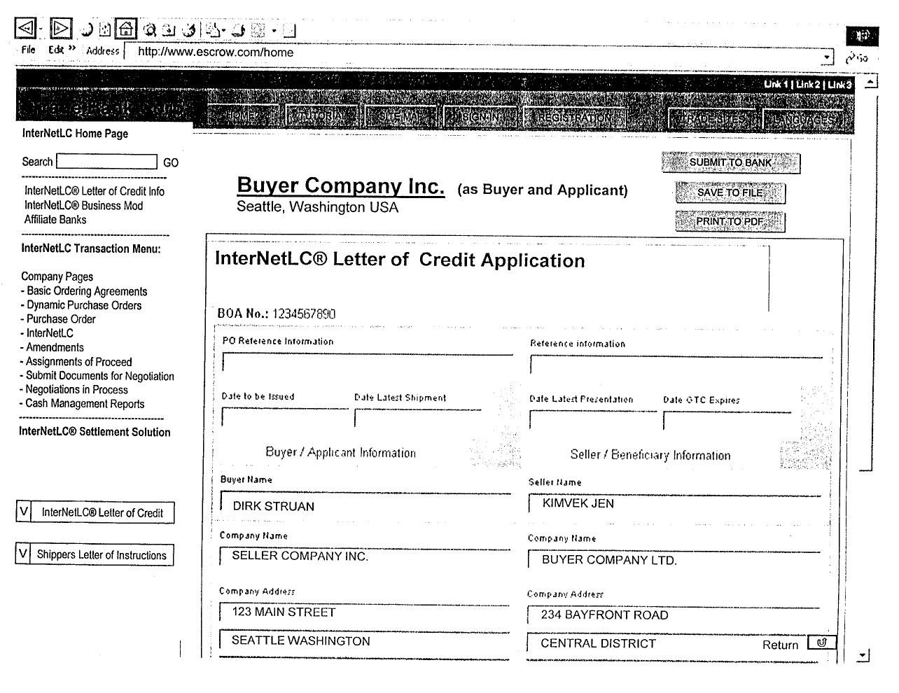

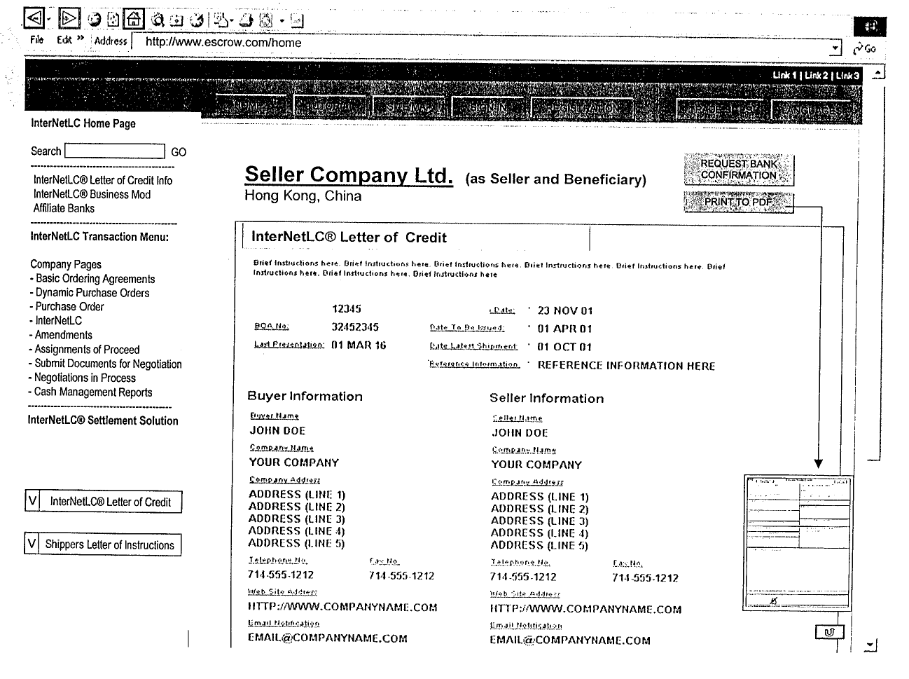

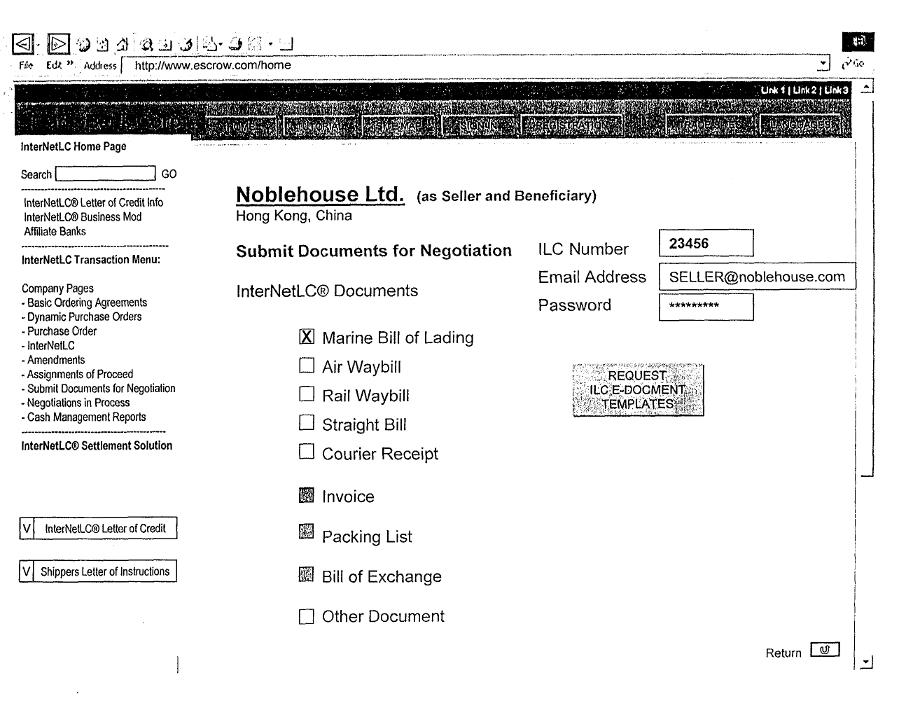

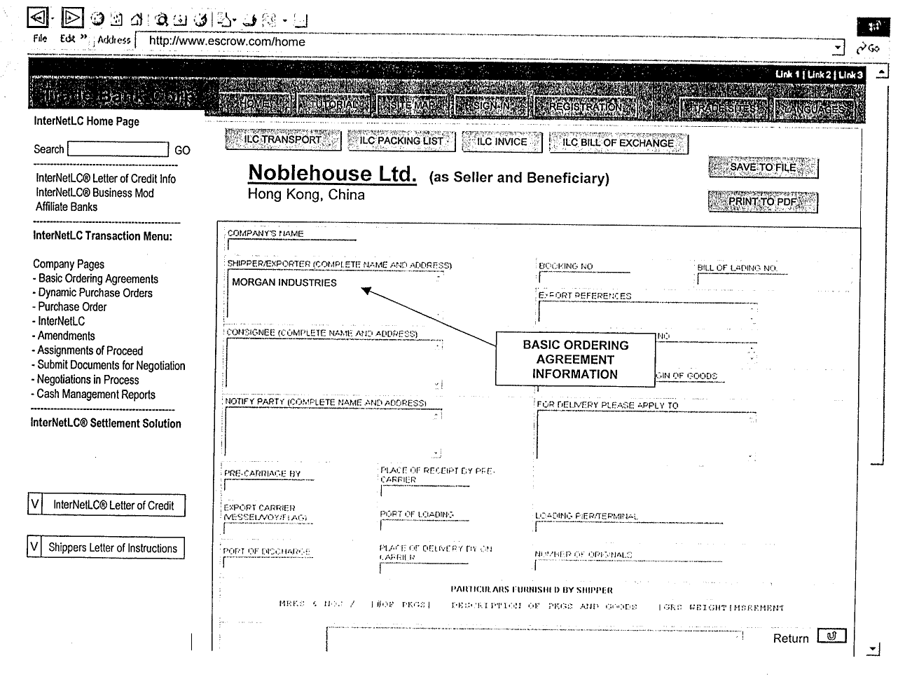

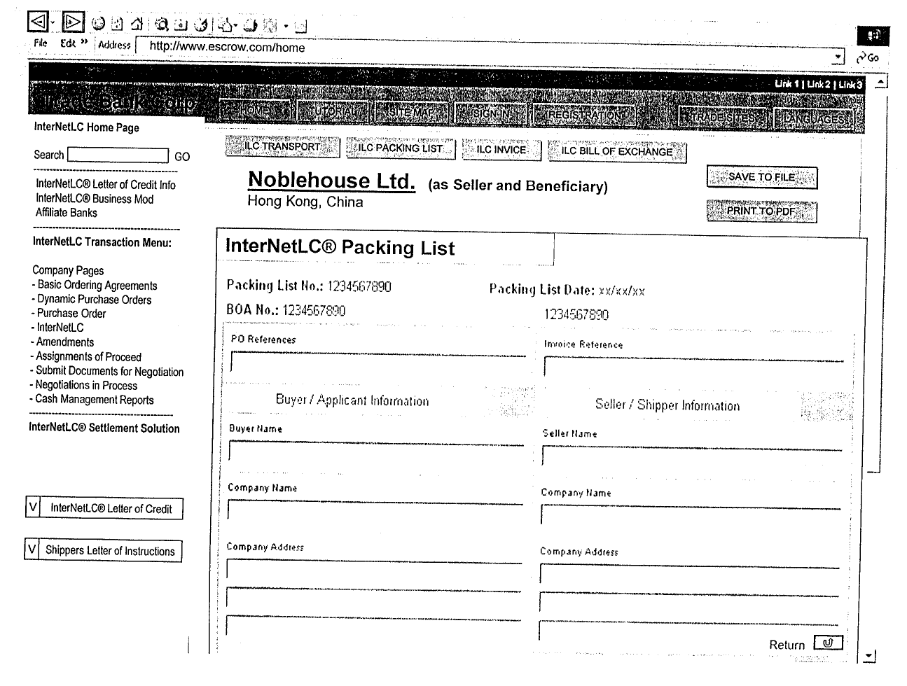

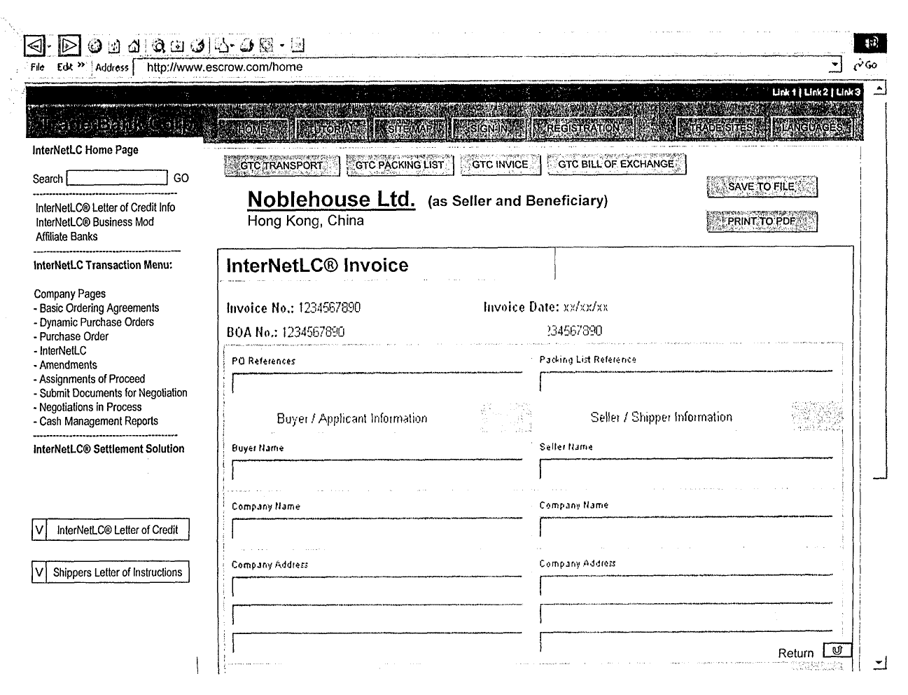

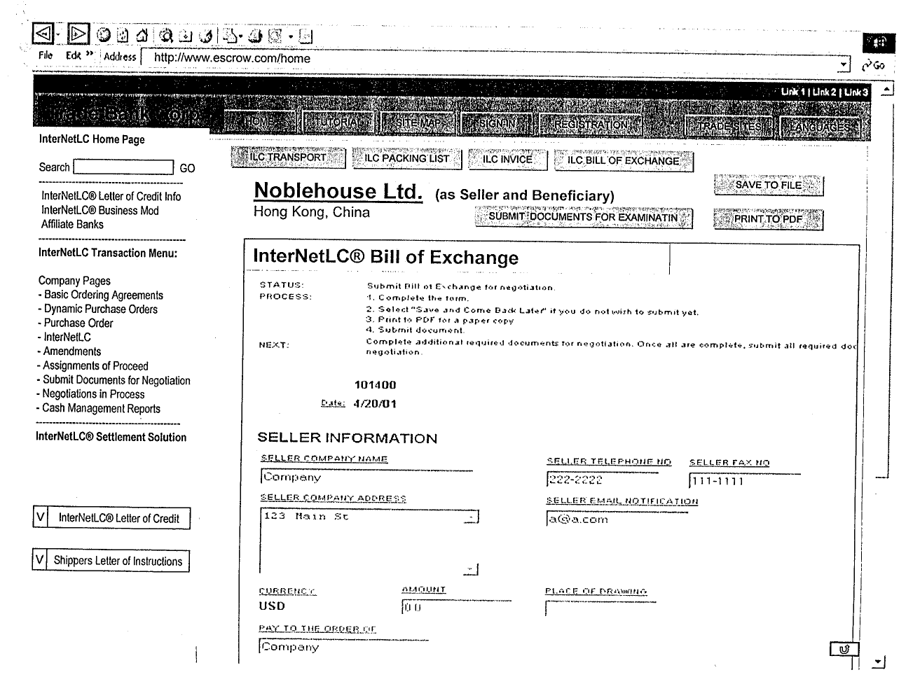

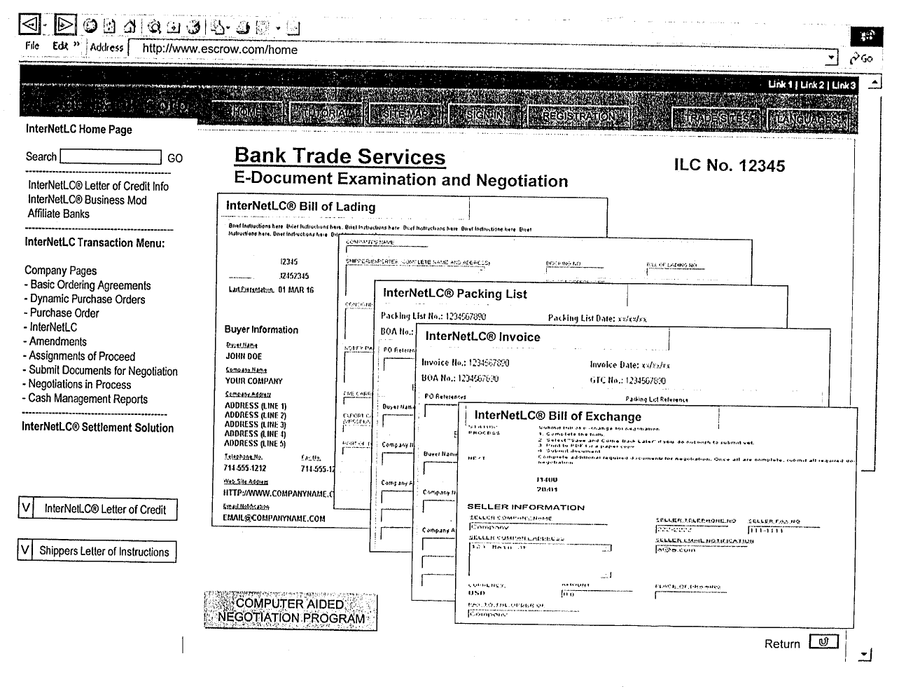

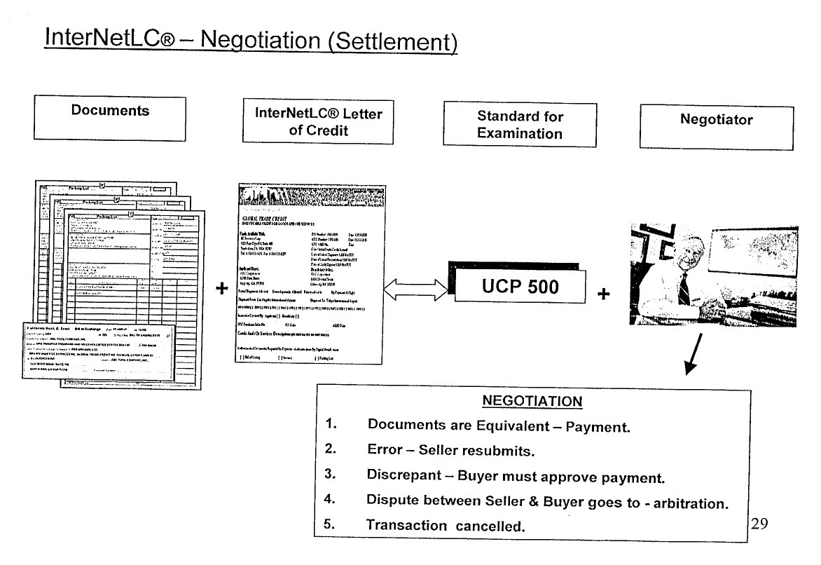

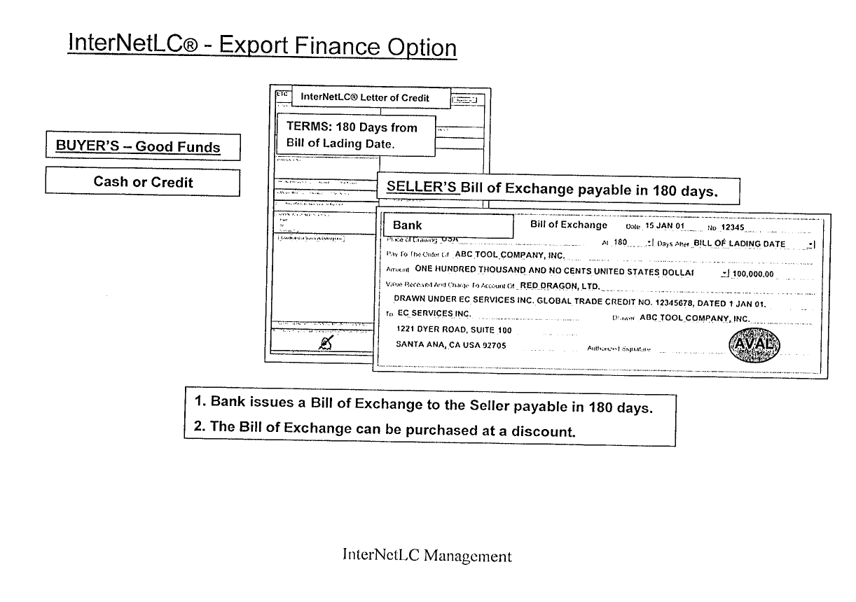

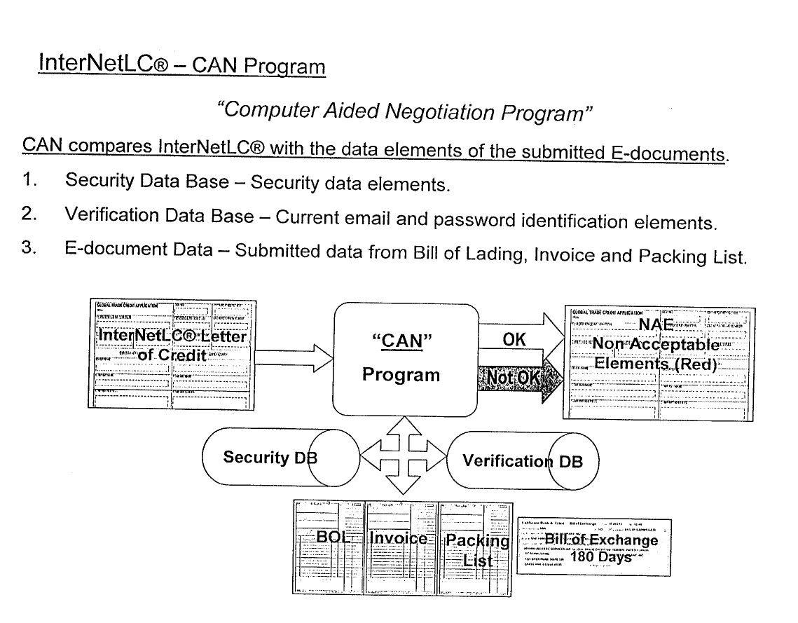

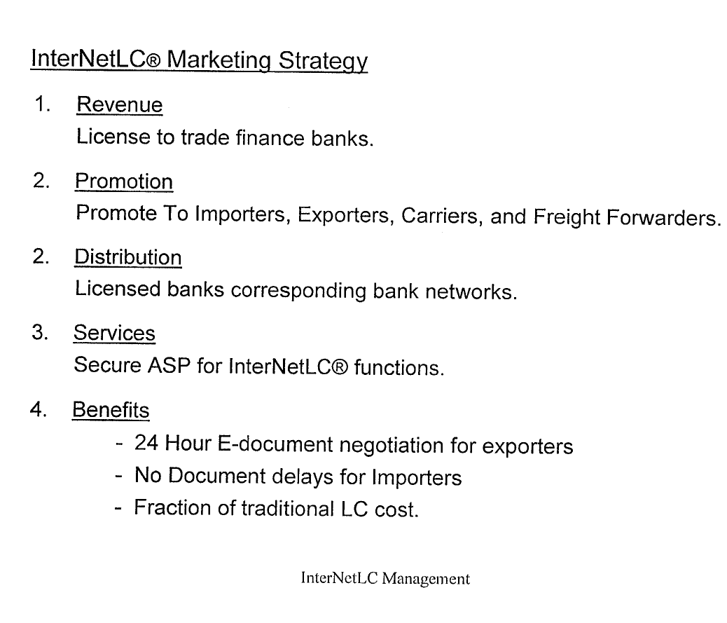

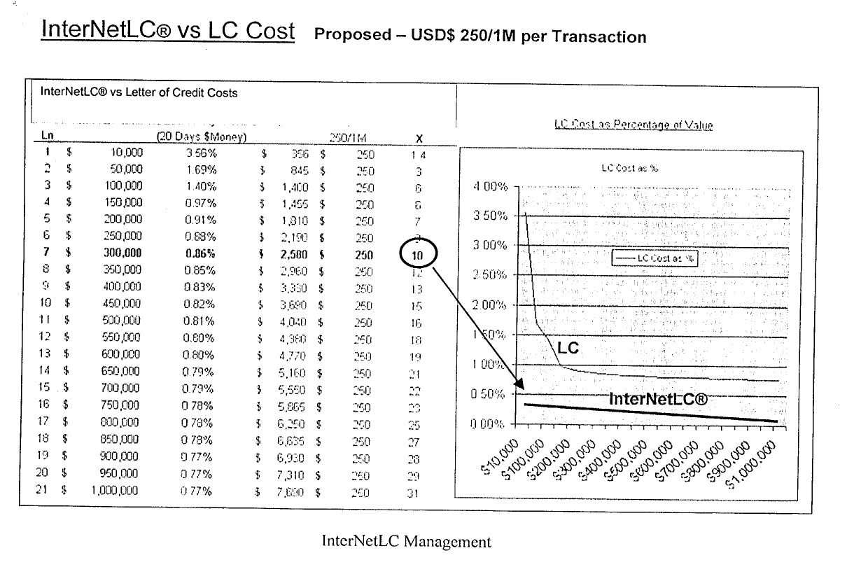

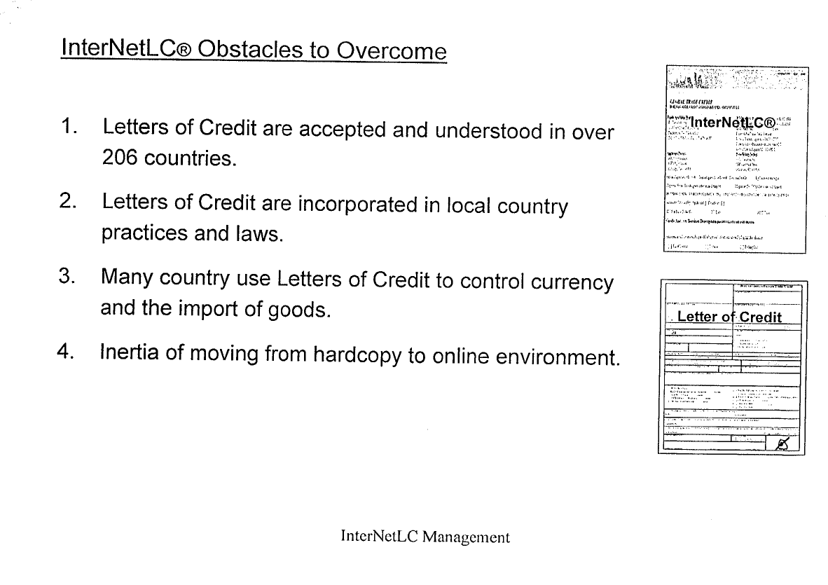

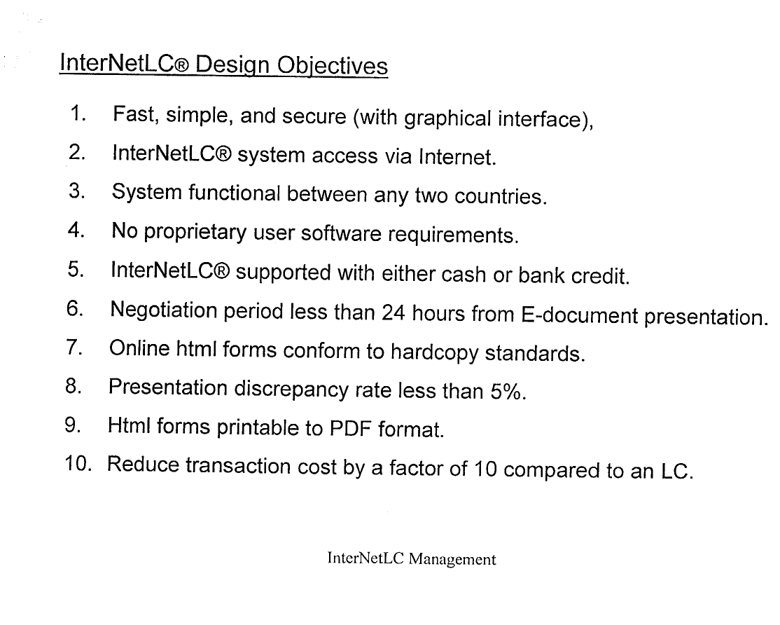

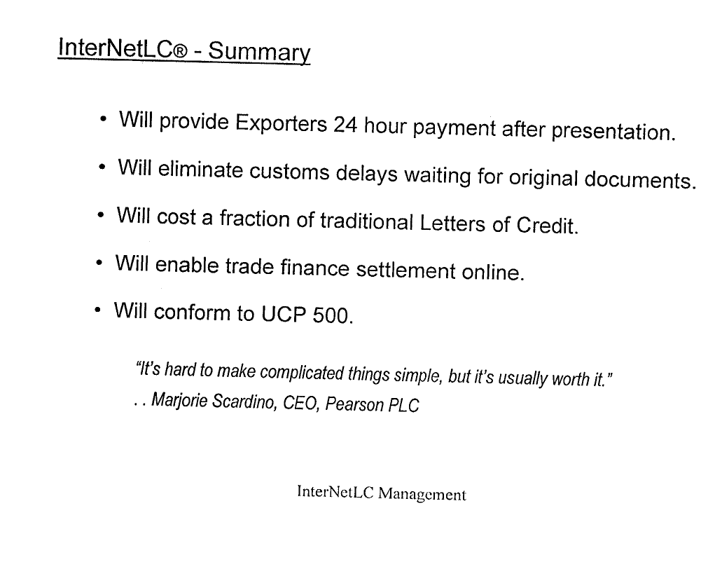

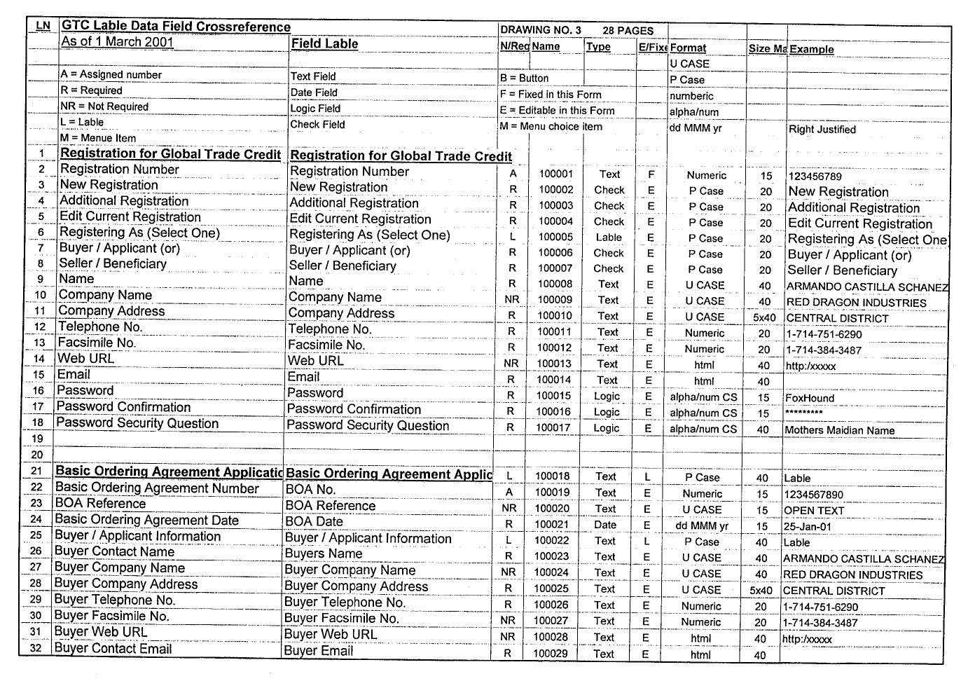

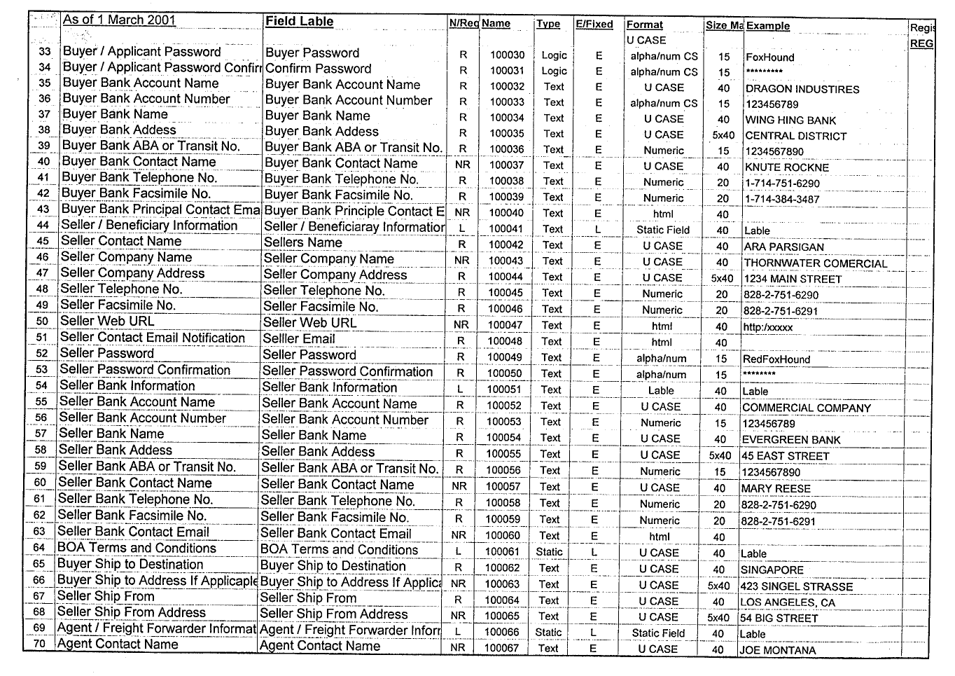

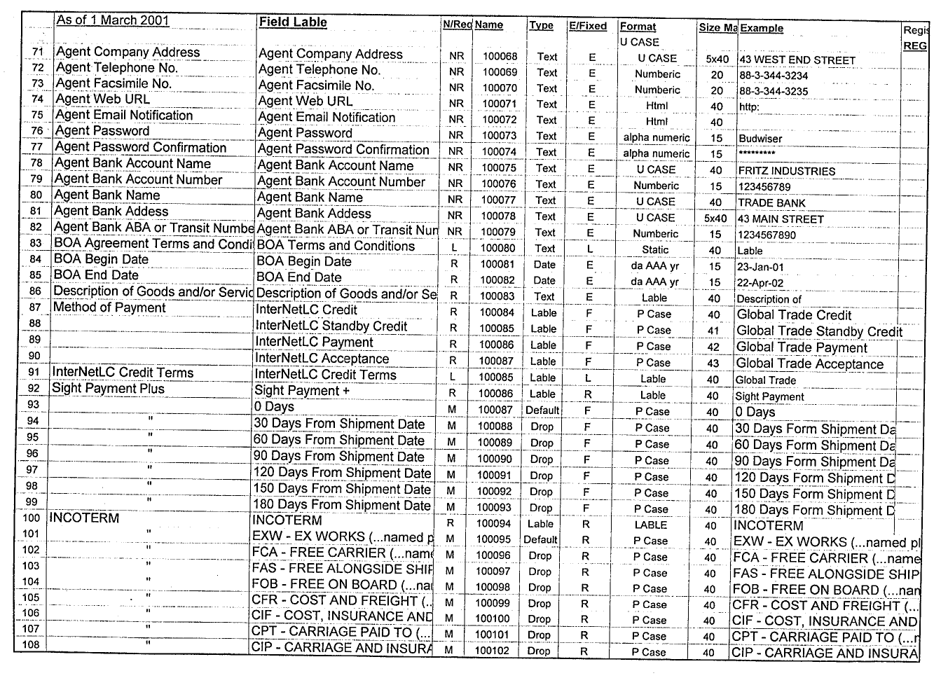

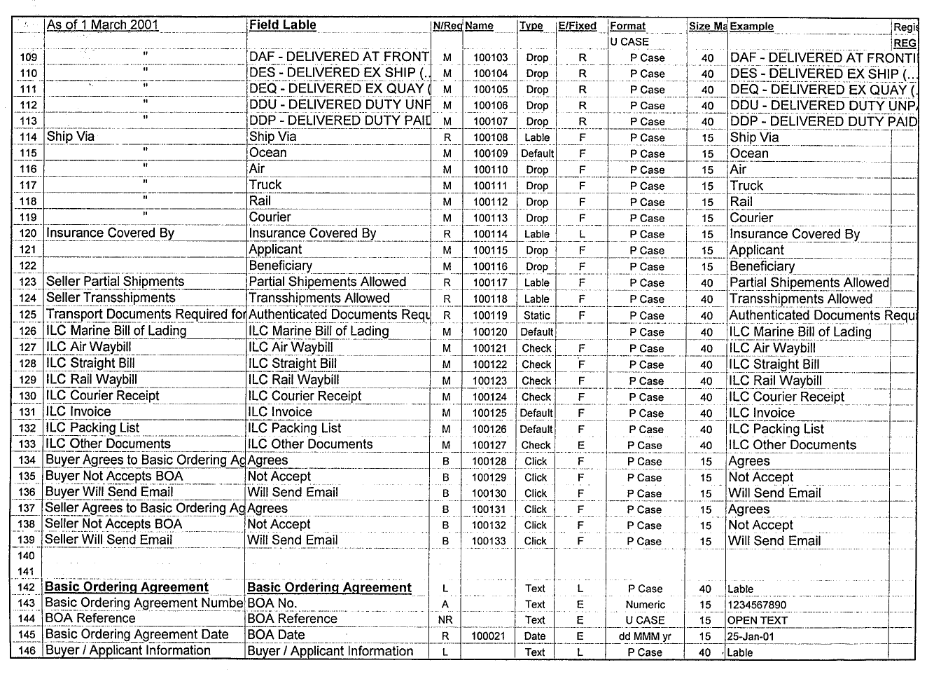

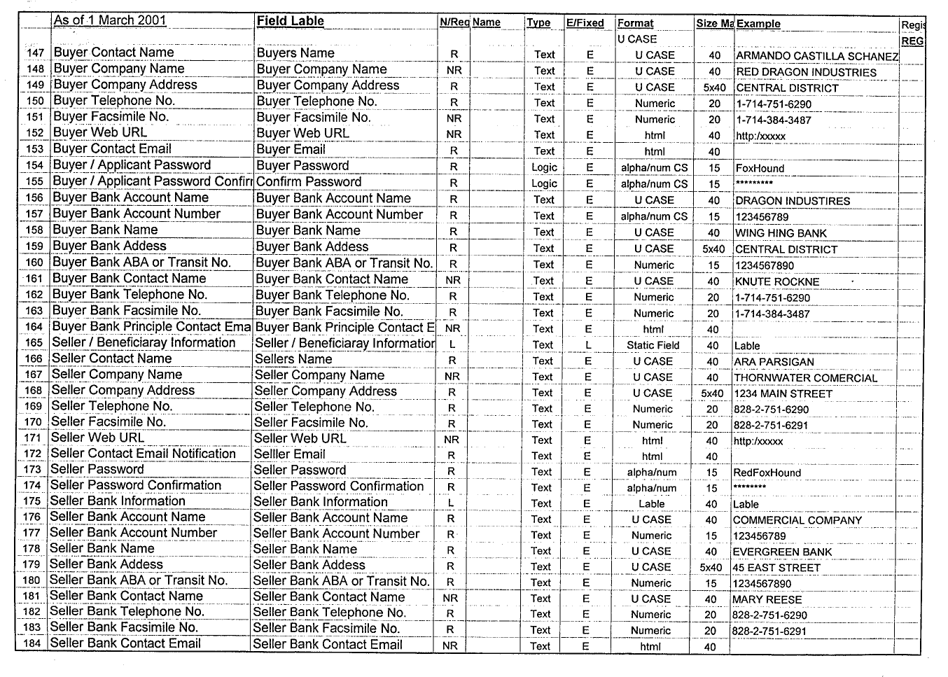

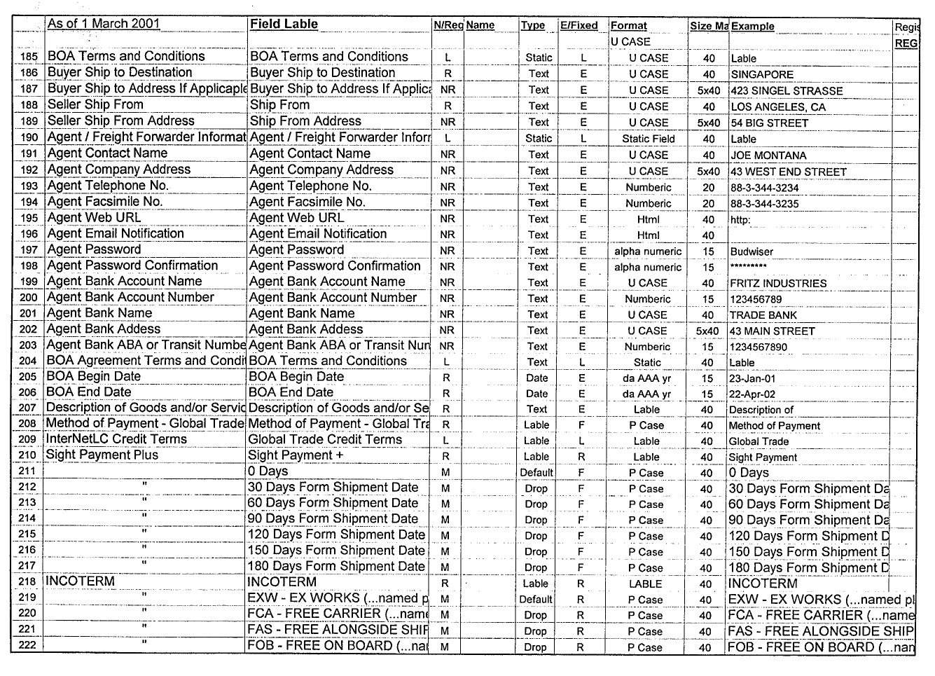

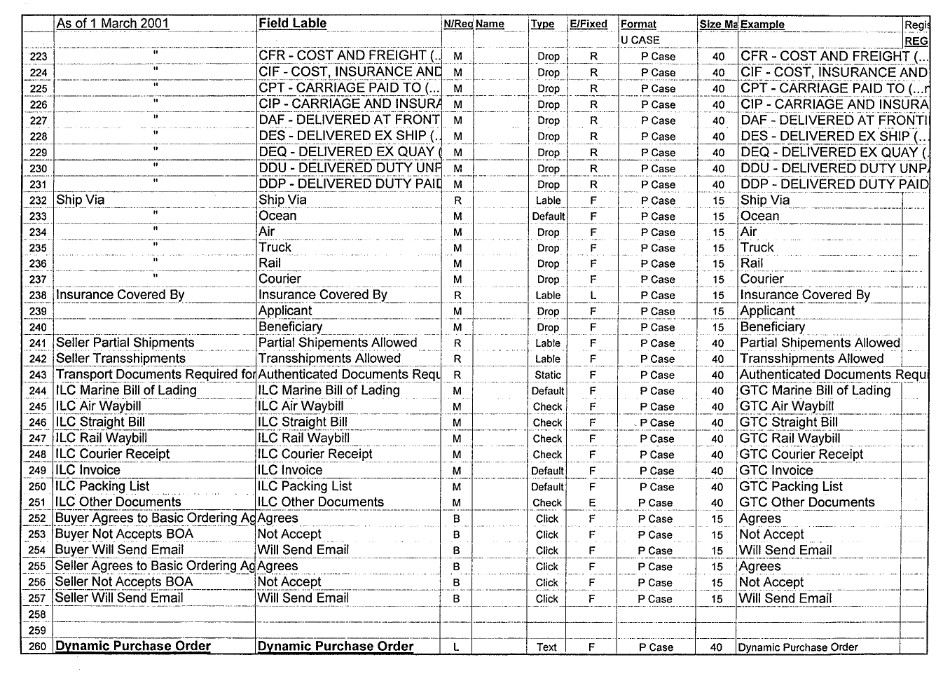

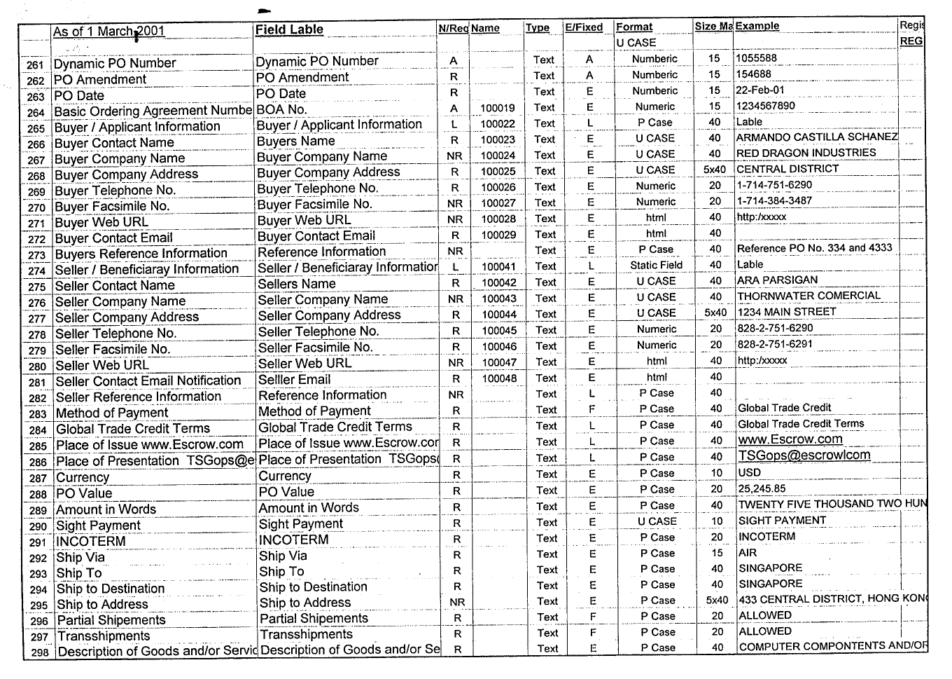

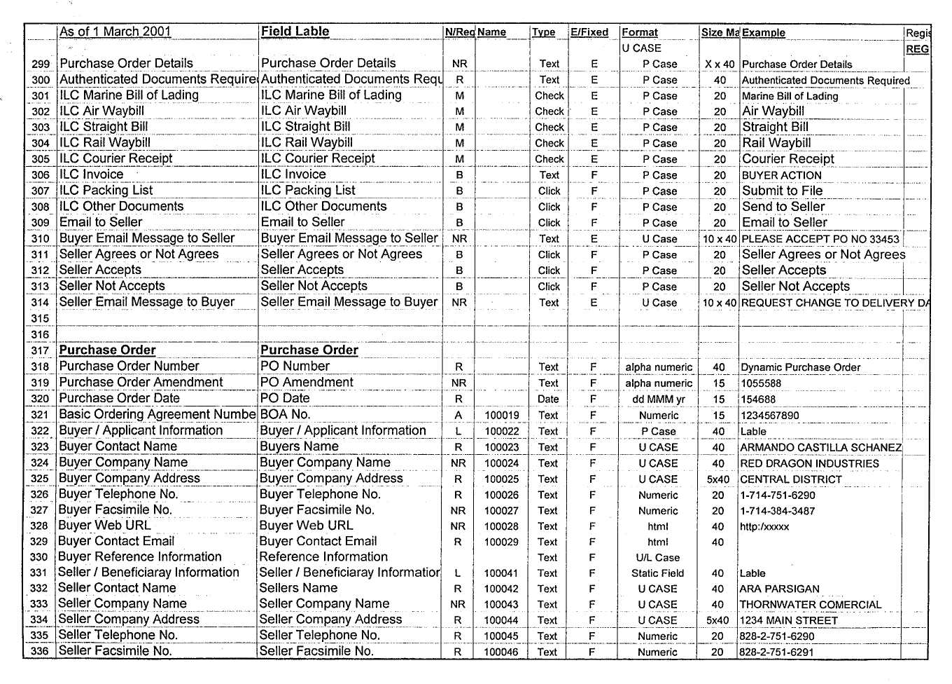

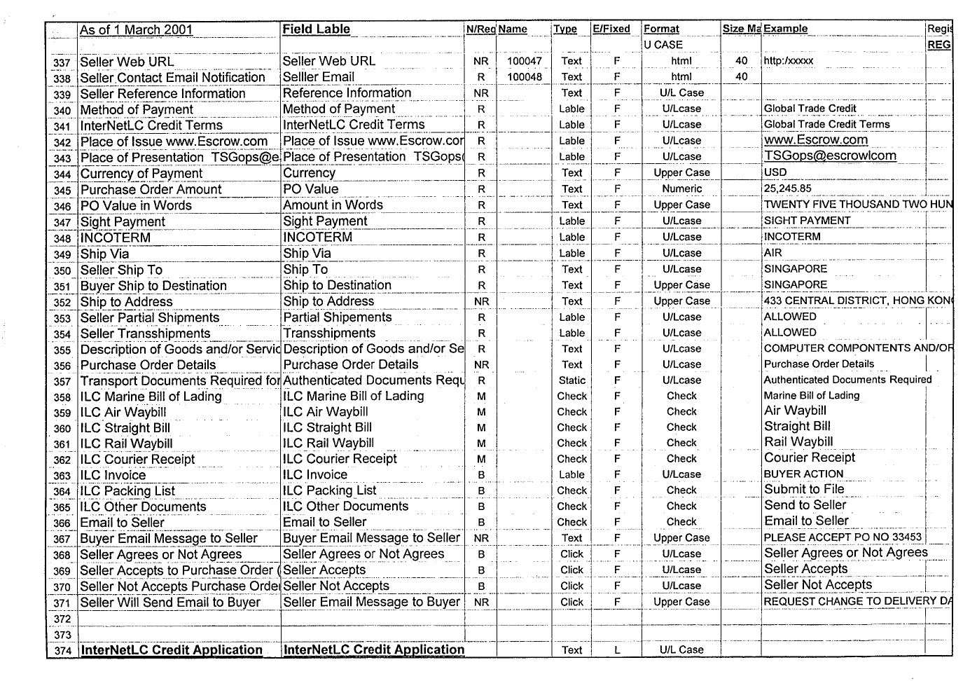

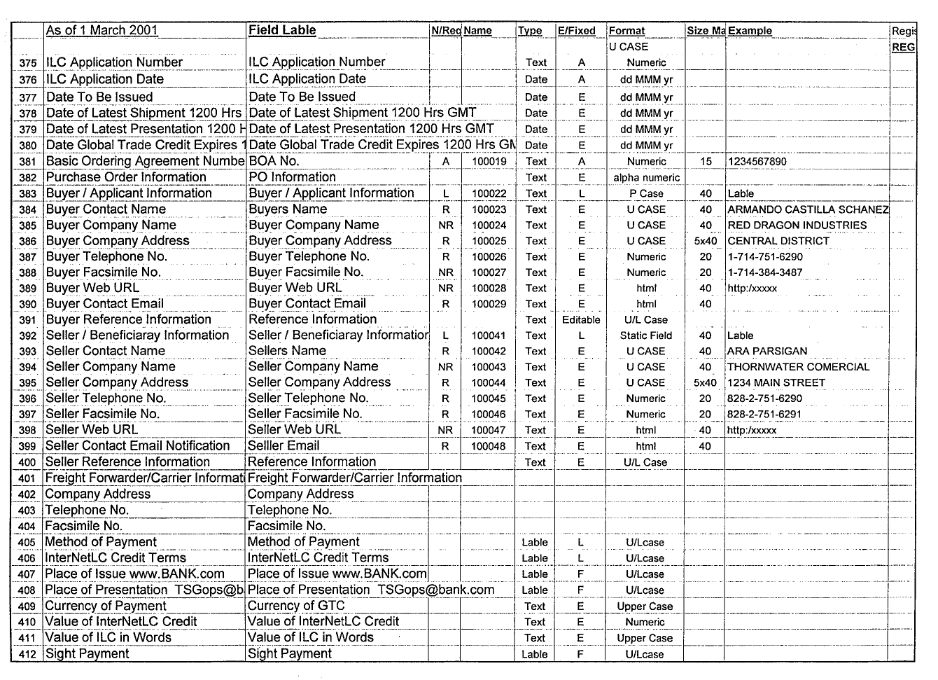

FIG. 2.0: Title

FIG. 2.1: The Trade Finance Transaction Problem

FIG. 2.3: The Solution InterNetLC Letter of Credit

FIG. 2.4: InterNetLC Letter of Credit Definition

FIG. 2.5: InterNetLC Mission Statement

FIG. 2.6: Trade Transaction by Type

FIG. 2.7: Potential InterNetLC License Market

FIG. 2.8: ILC Corporation

FIG. 2.9: InterNetLC Settlement of Trade Transactions

FIG. 2.10: InterNetLC vs LC Comparison

FIG. 2.11: InterNetLC Functional Comparison

FIG. 2.12: InterNetLC Core Processes

FIG. 2.13: InterNetLC Letter of Credit Concept

FIG. 2.14: InterNetLC Purchase Order Issue

FIG. 2.15: InterNetLC Issue Process

FIG. 2.16: InterNetLC Bank Issue & Settlement

FIG. 2.17: InterNetLC Credit Confirmation Process

FIG. 2.18: InterNetLC Document Presentation

FIG. 2.19: Web Interface Ten Steps

FIG. 2.20: Web Interface Buyer Company

FIG. 2.21: Web Interface InterNetLC Application

FIG. 2.23: Web Interface Seller Company

FIG. 2.24: Web Interface Noblehouse Submittal

FIG. 2.25: Web Interface Noblehouse BOL

FIG. 2.26: Web Interface Noblehouse PKL

FIG. 2.27: Web Interface Noblehouse INV

FIG. 2.28: Web Interface Noblehouse BOE

FIG. 2.29: Web Interface Bank Trade Services

FIG. 2.29: Web Interface Negotiation Settlement

FIG. 2.30: InterNetLC Export Finance Option

FIG. 2.31: InterNetLC CAN Program

FIG. 2.32: InterNetLC Marketing Strategy

FIG. 2.33: InterNetLC vs LC Cost

FIG. 2.34: InterNetLC Obstacles to Overcome

FIG. 2.35: InterNetLC Design Objectives

FIG. 2.36: InterNetLC Summary

Drawing No. 3.0: InterNetLC Label Data Field Cross Reference

Drawing No. 4.0: InterNetLC Data Base Field Names

Drawing No. 5.0: InterNetLC Transaction HTML Forms

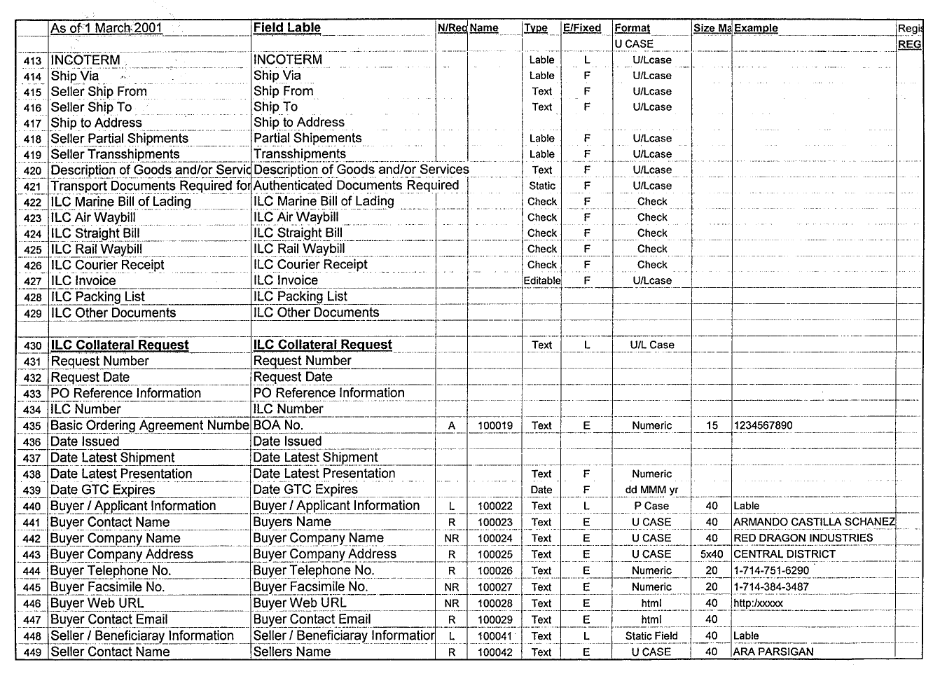

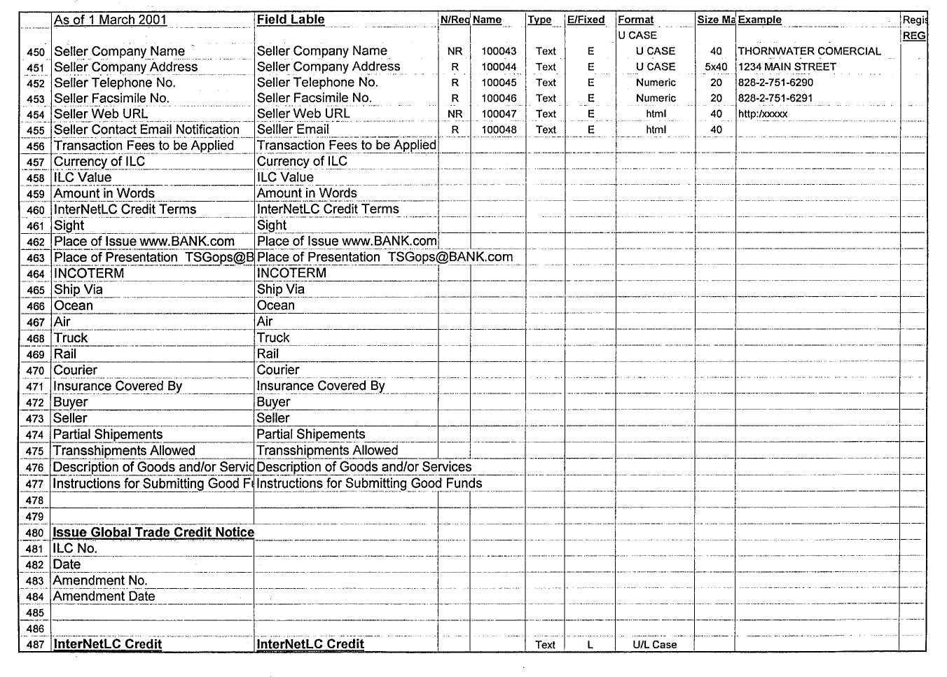

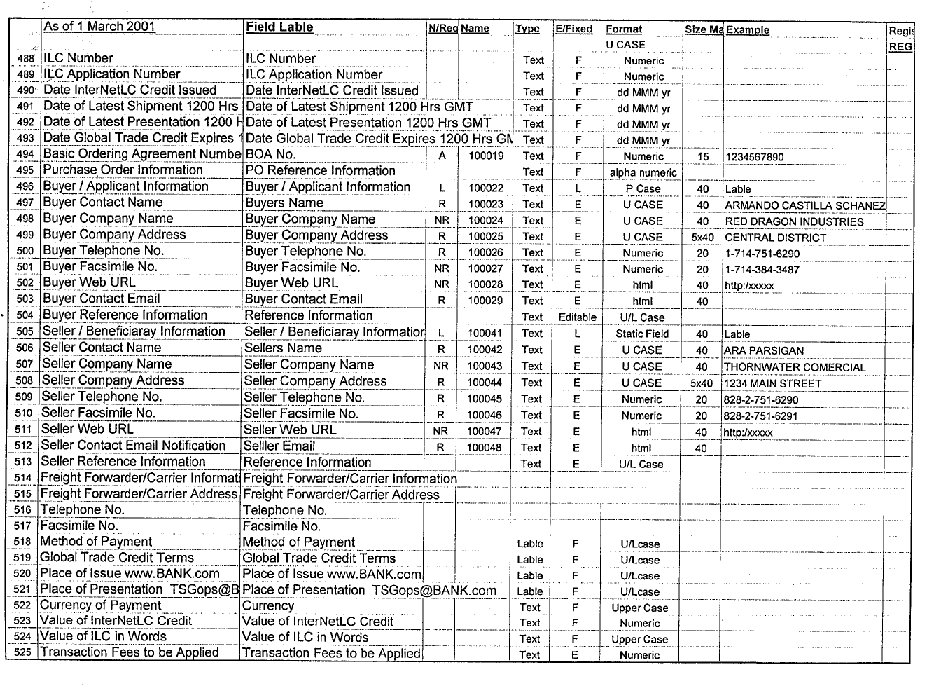

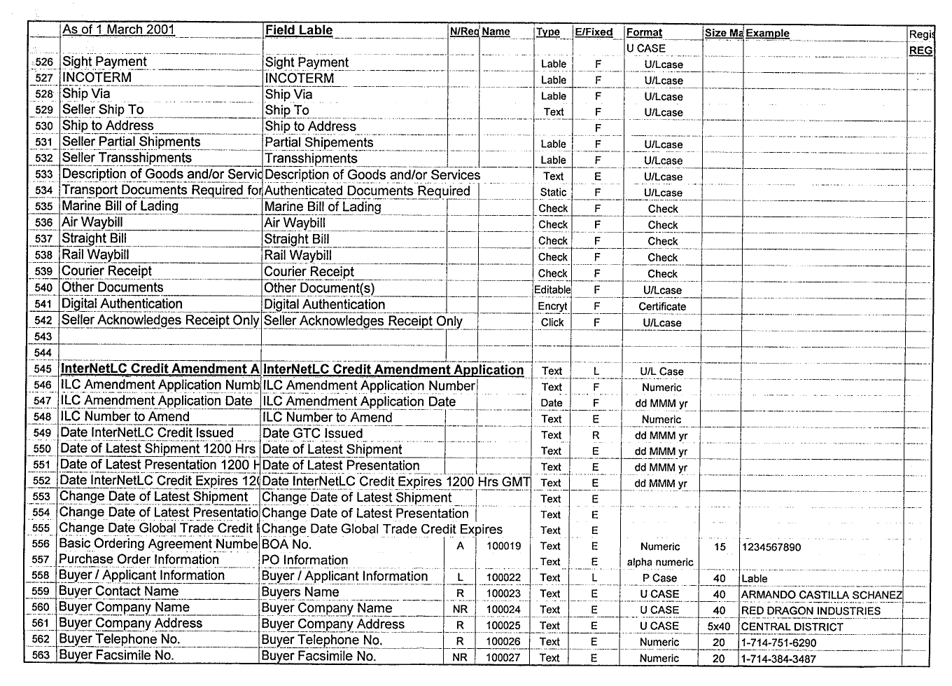

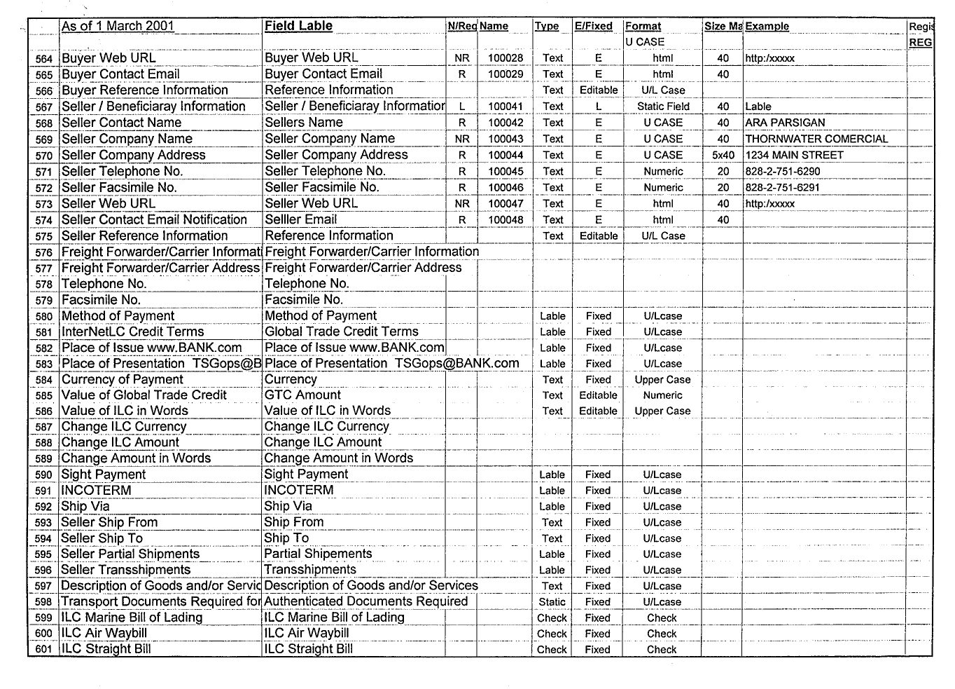

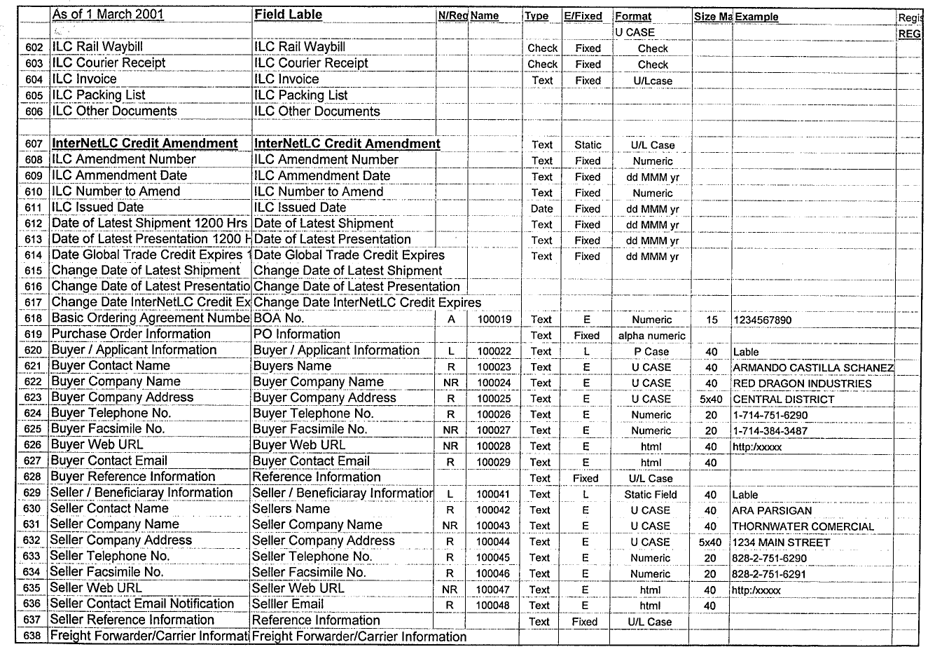

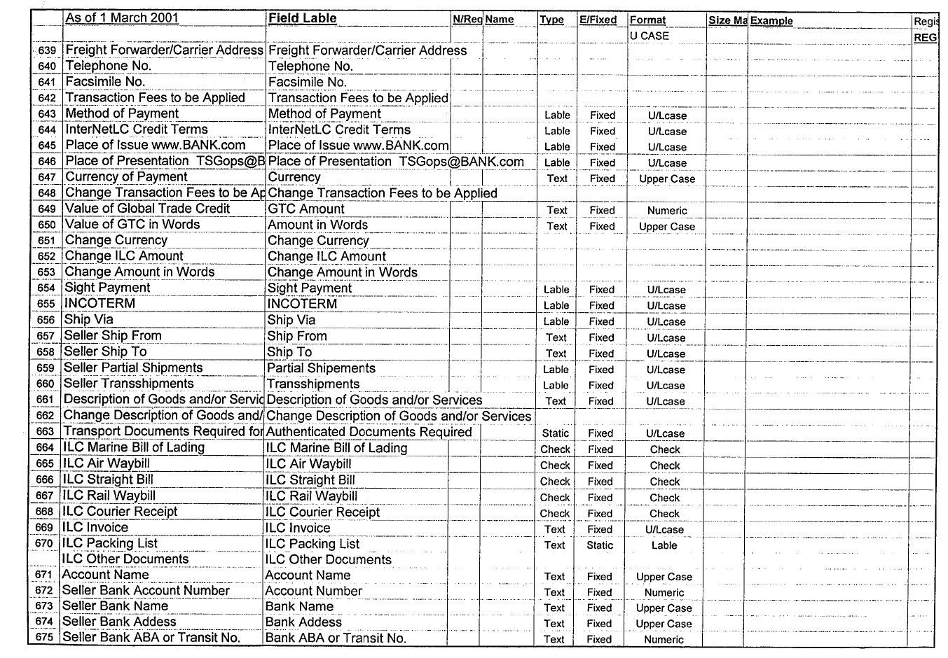

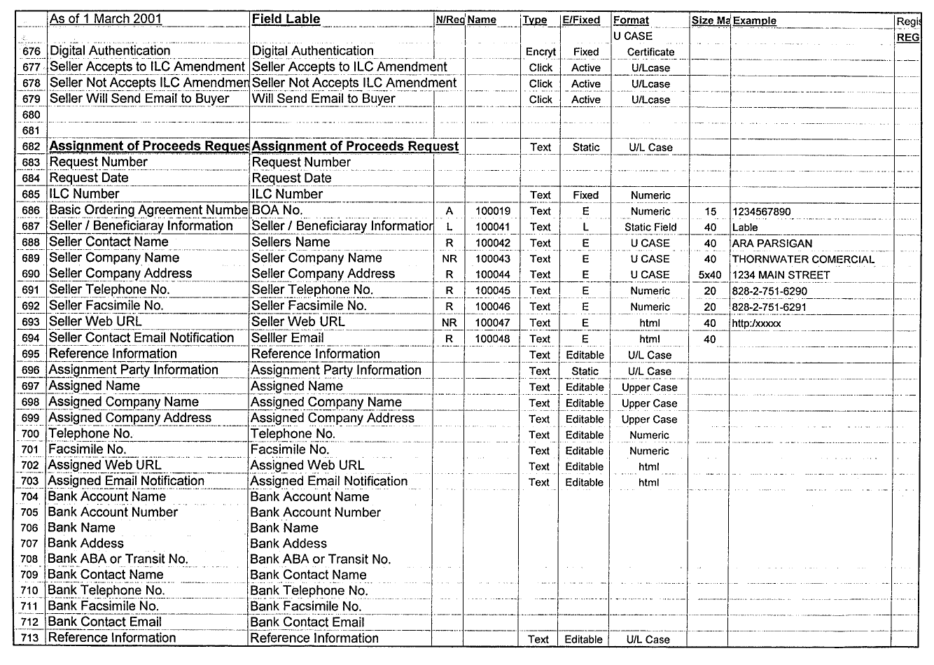

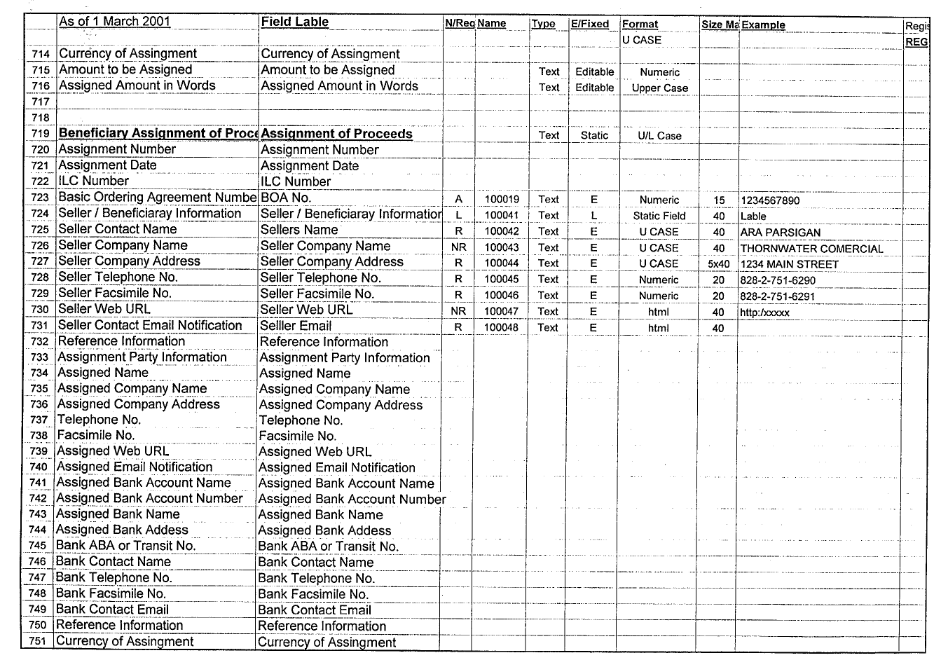

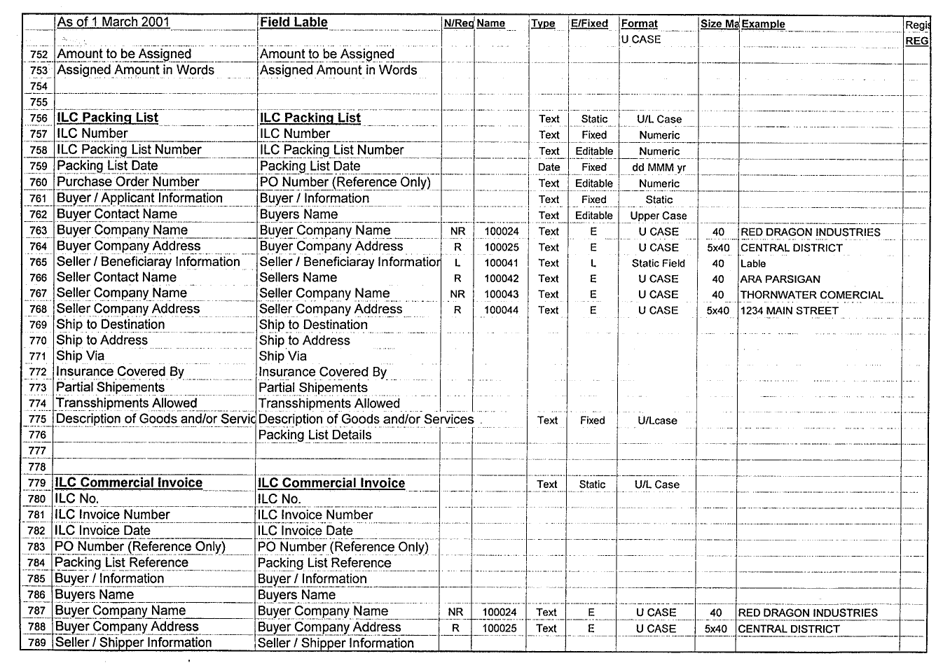

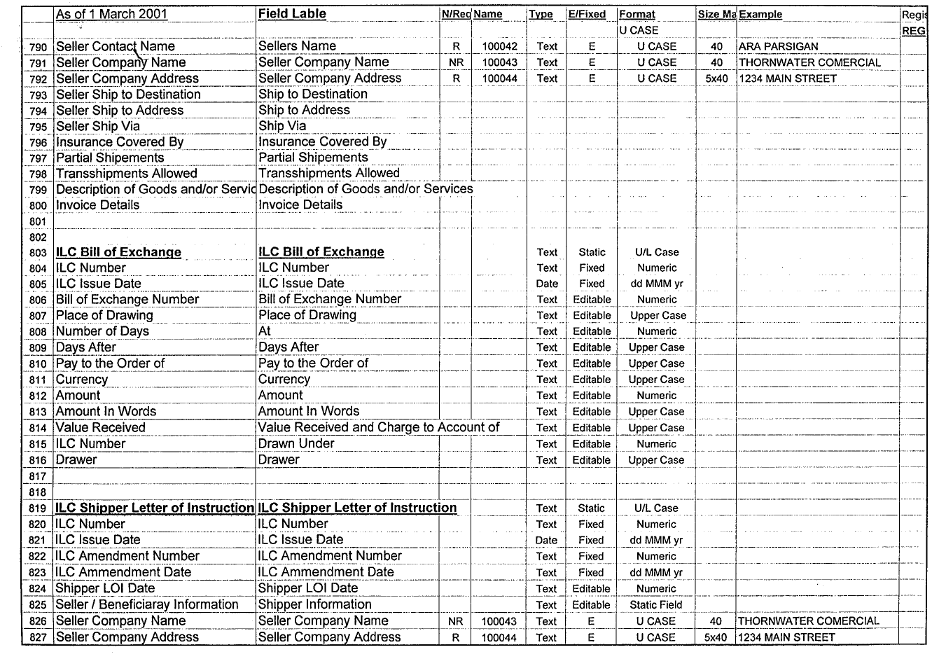

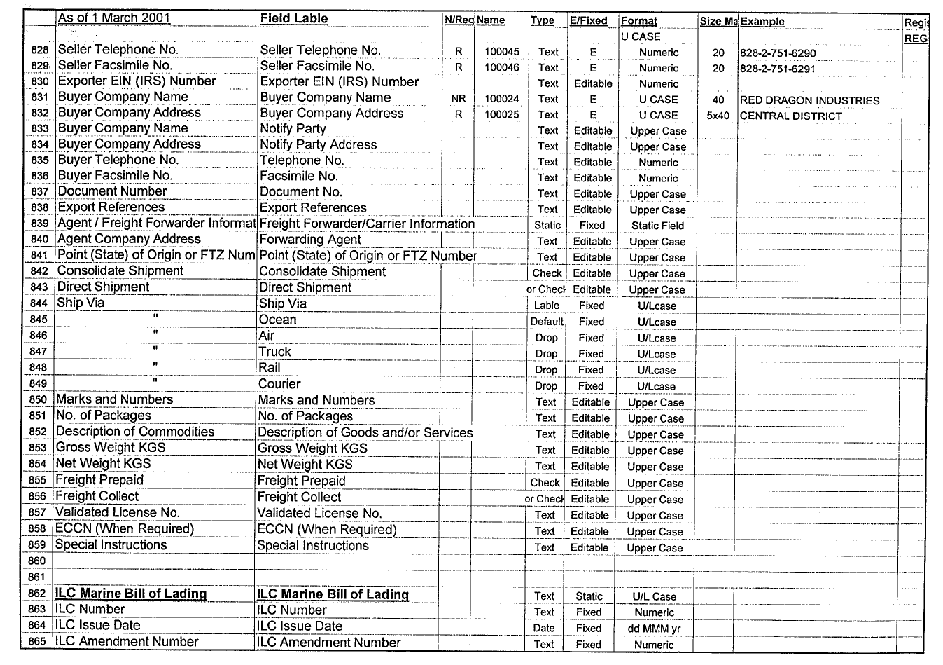

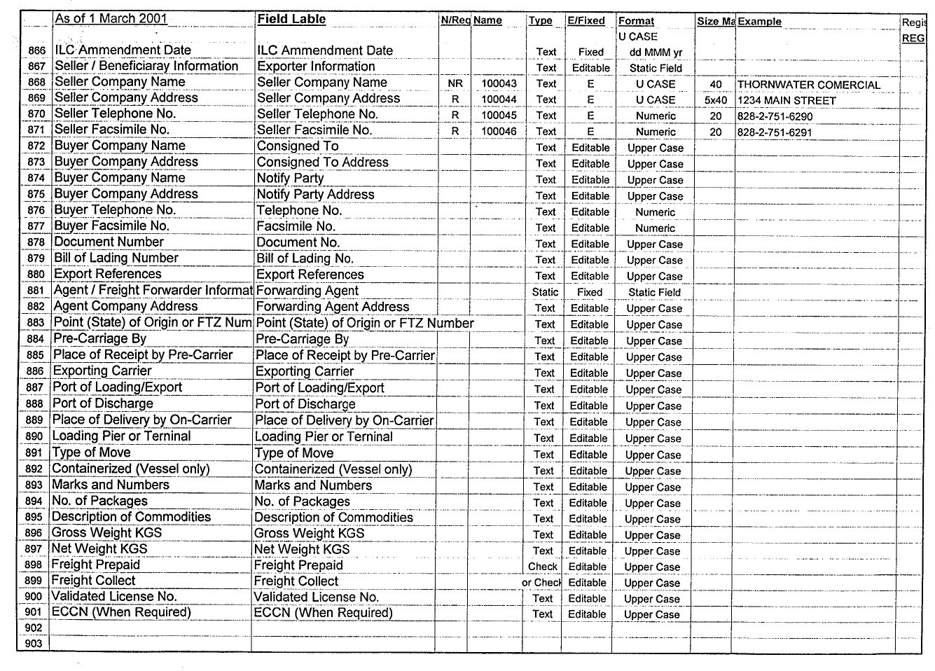

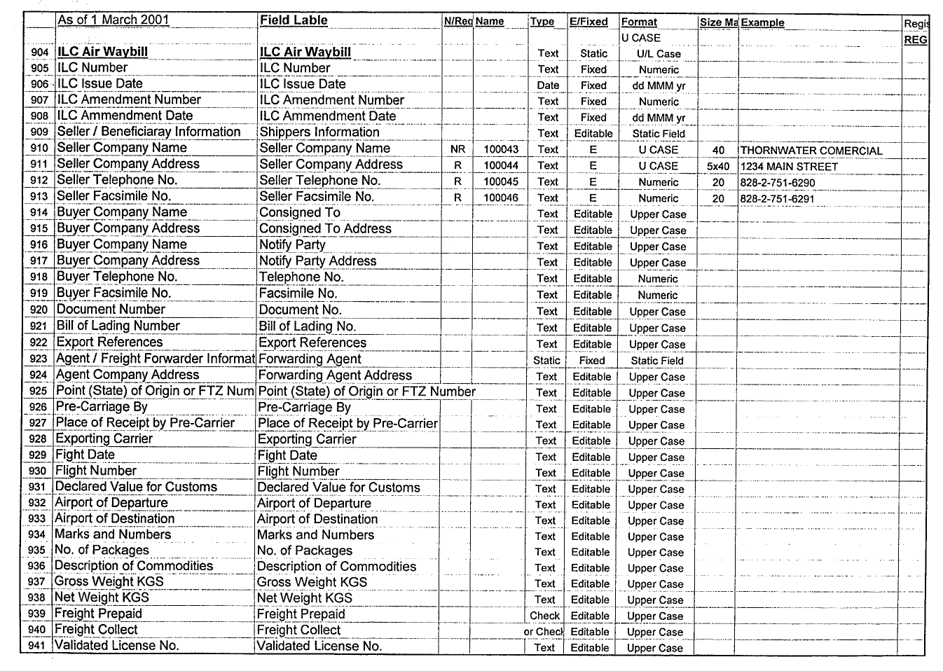

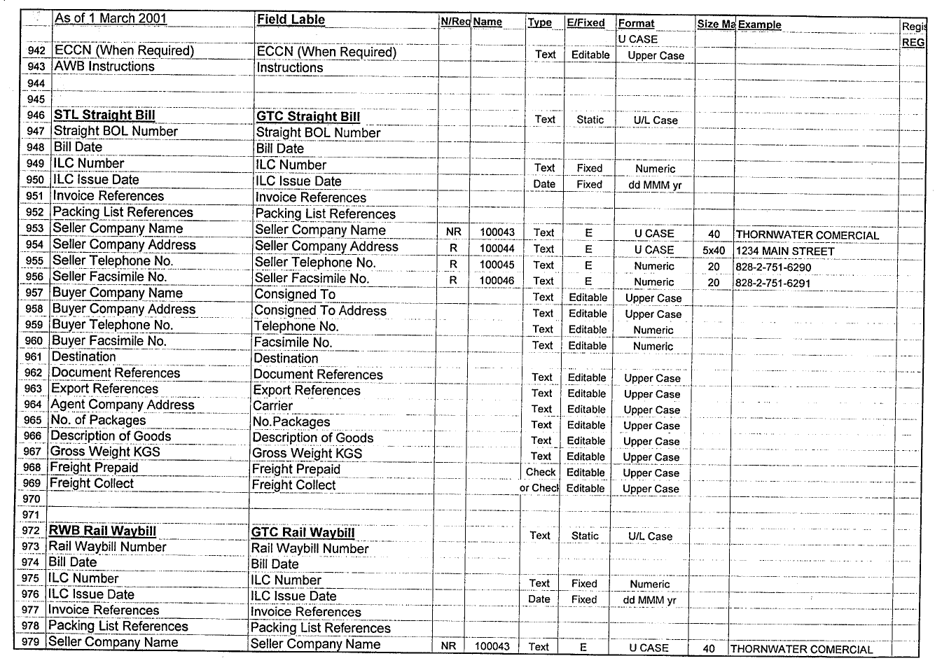

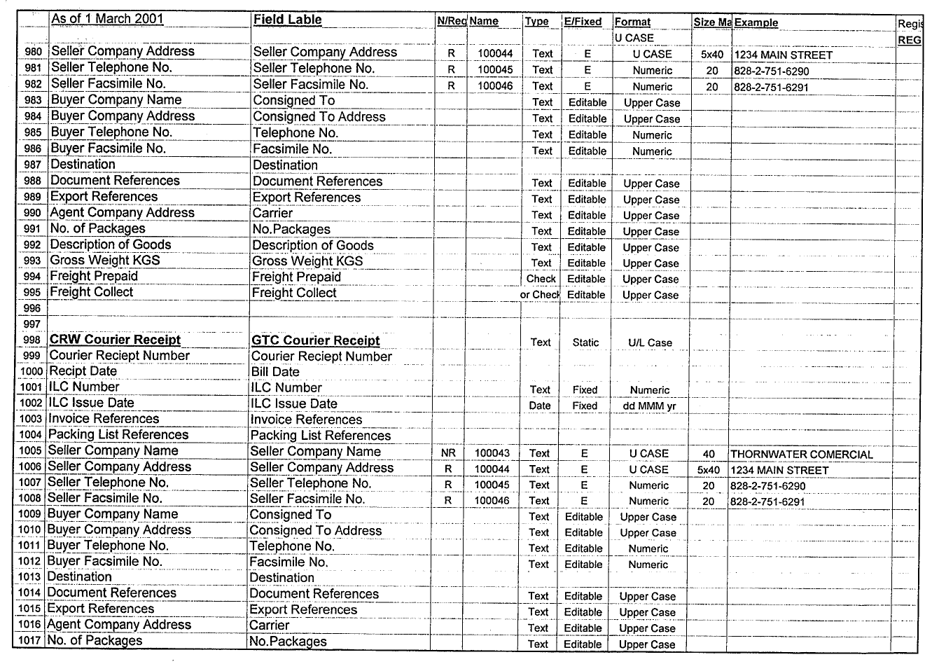

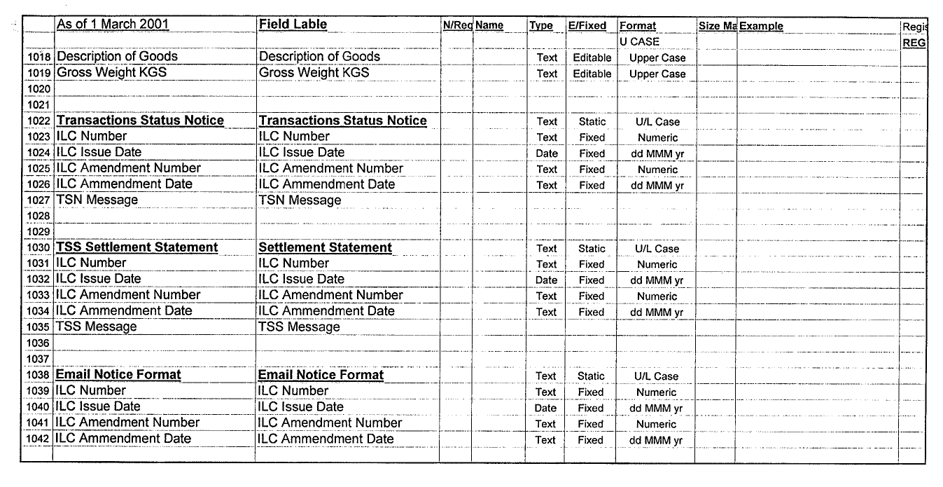

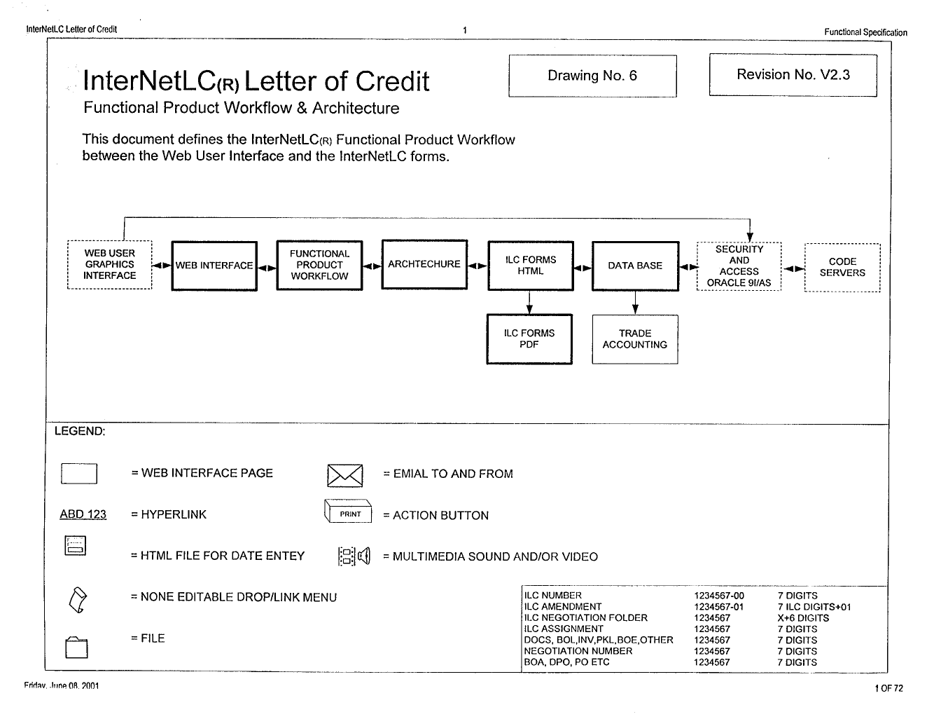

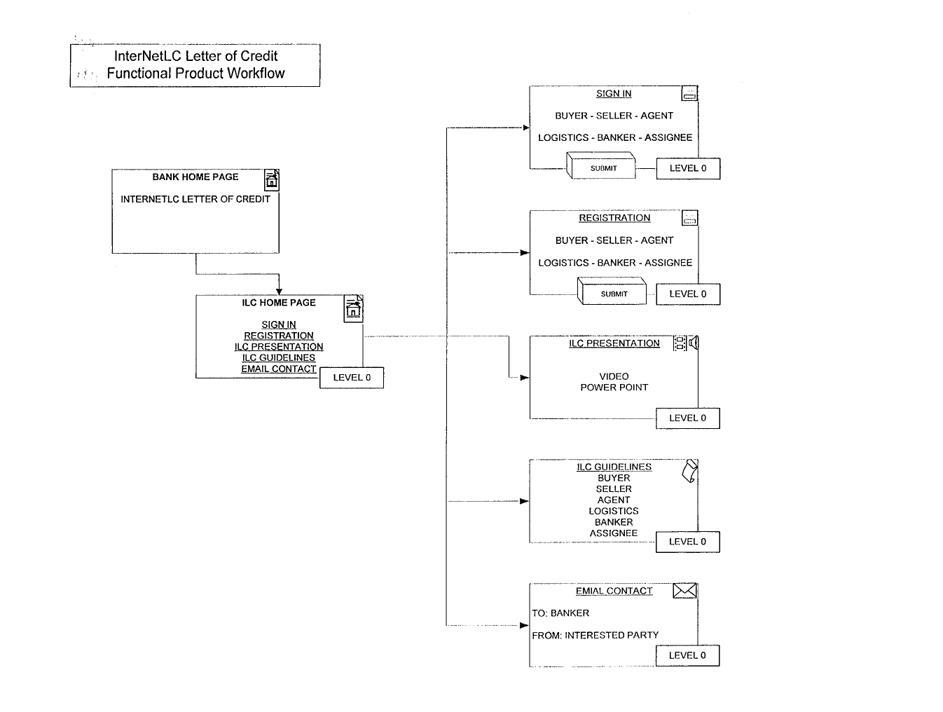

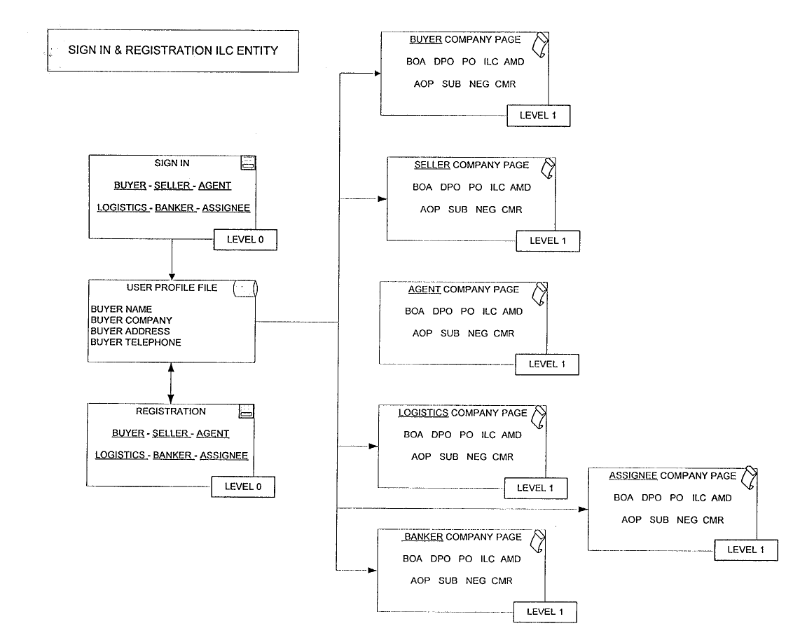

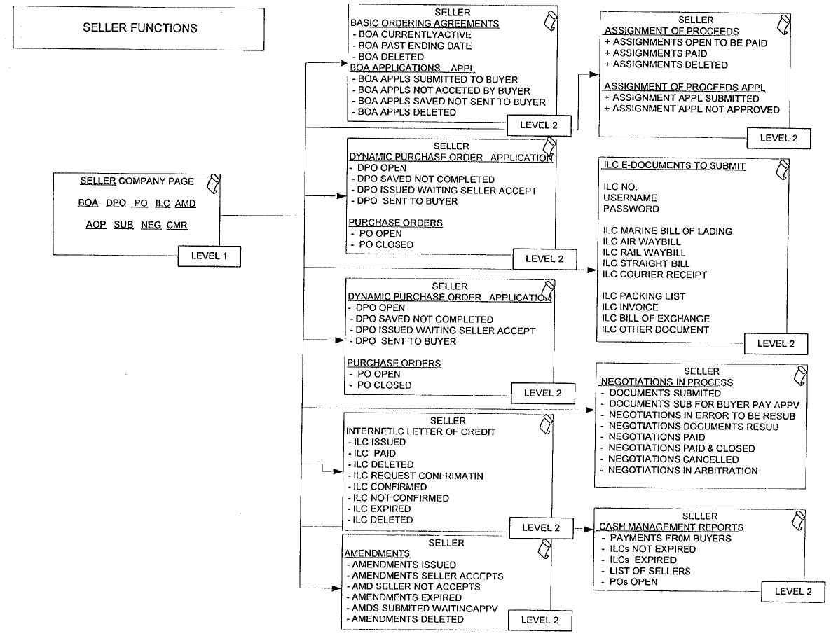

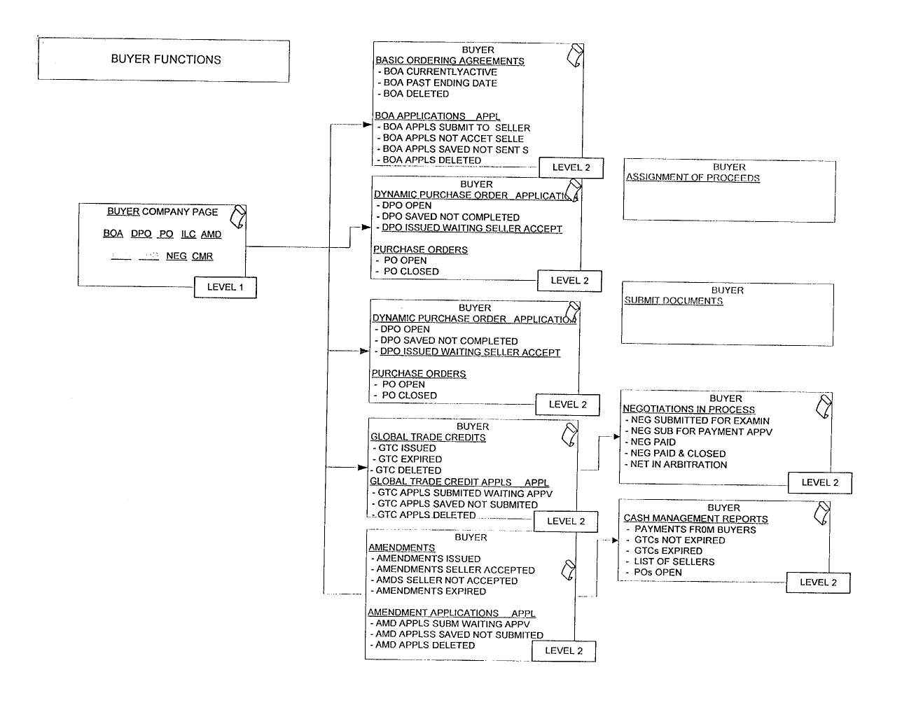

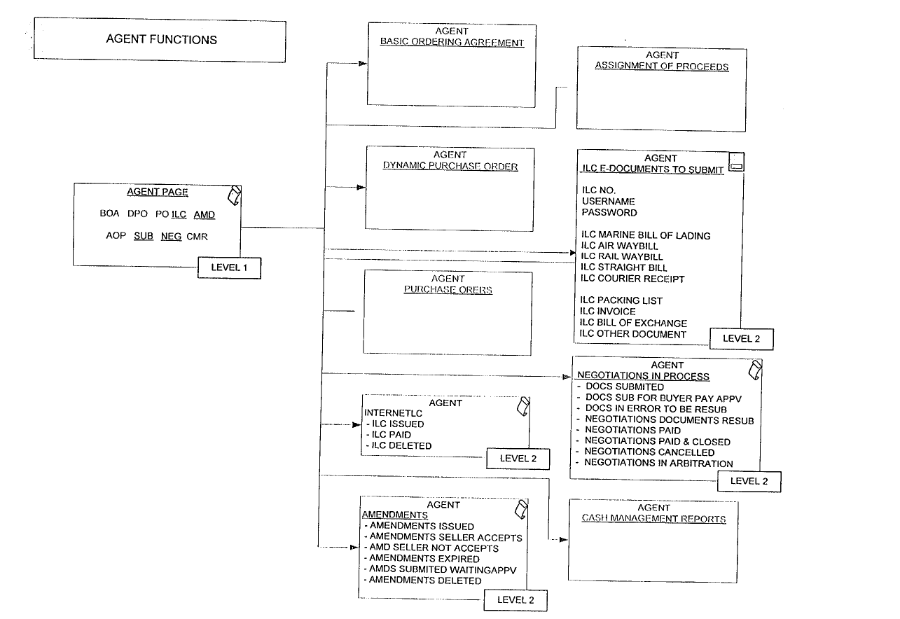

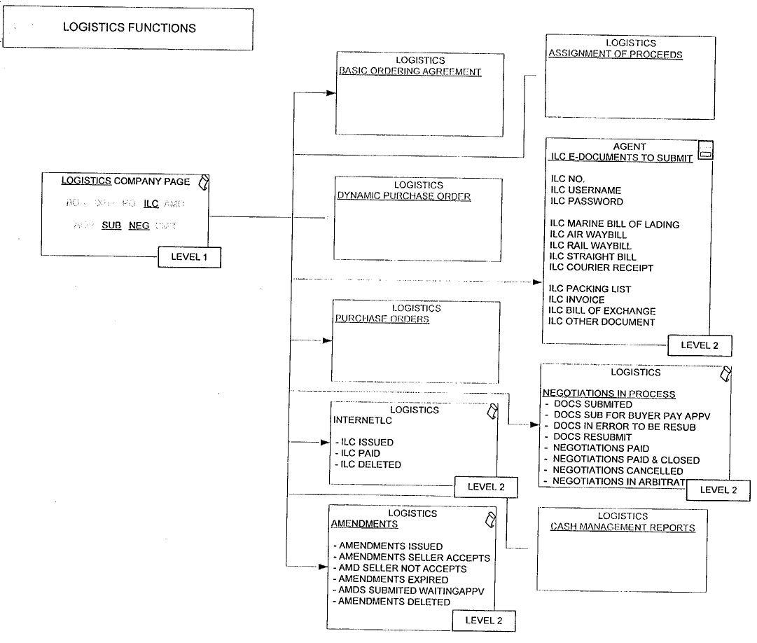

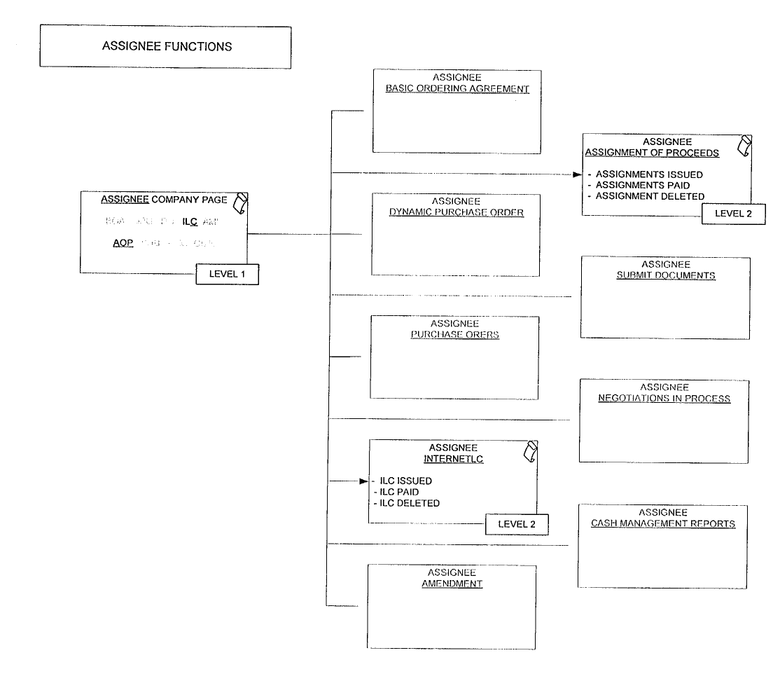

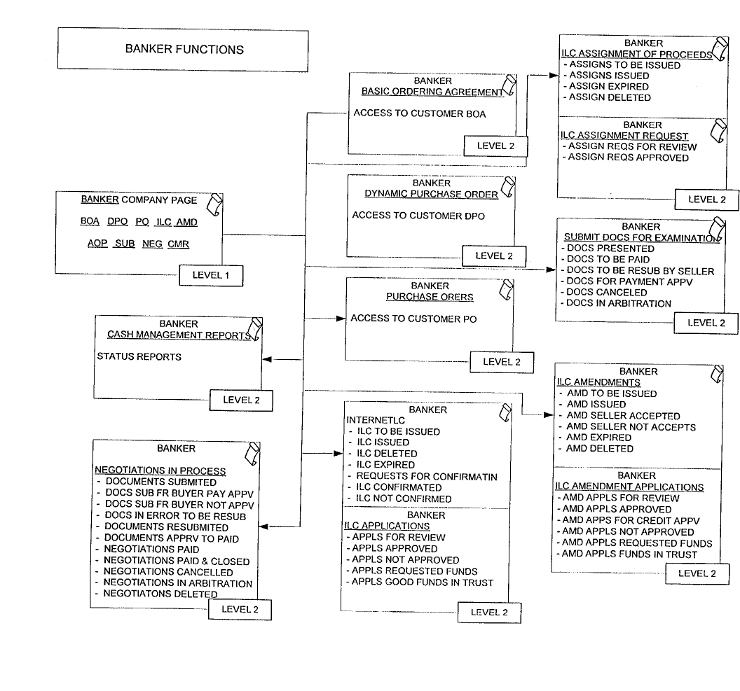

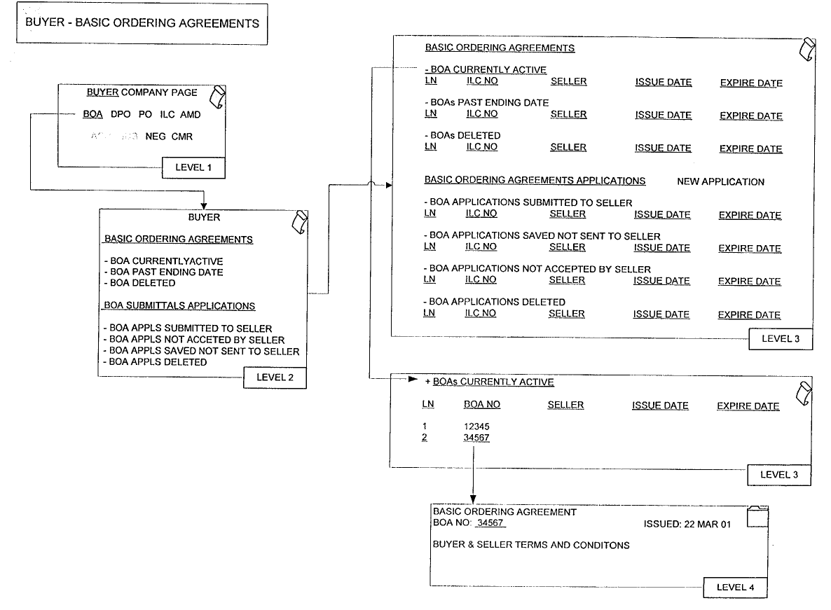

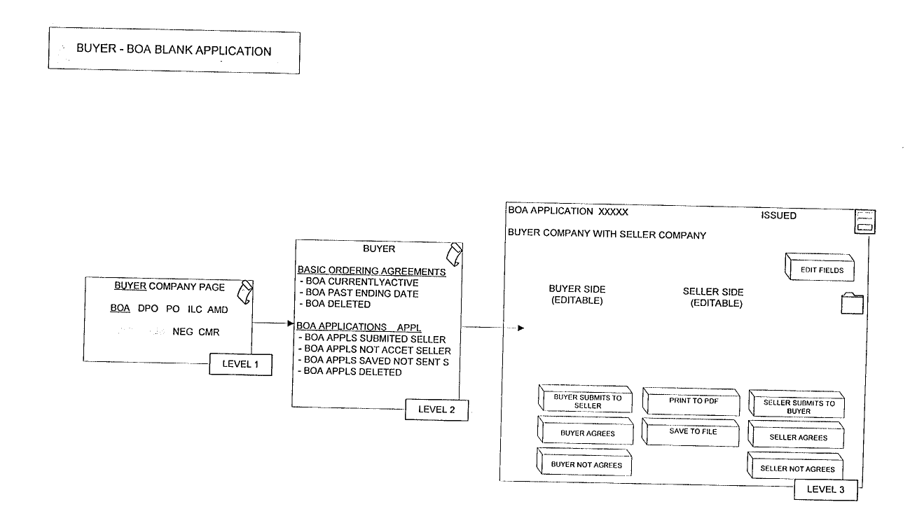

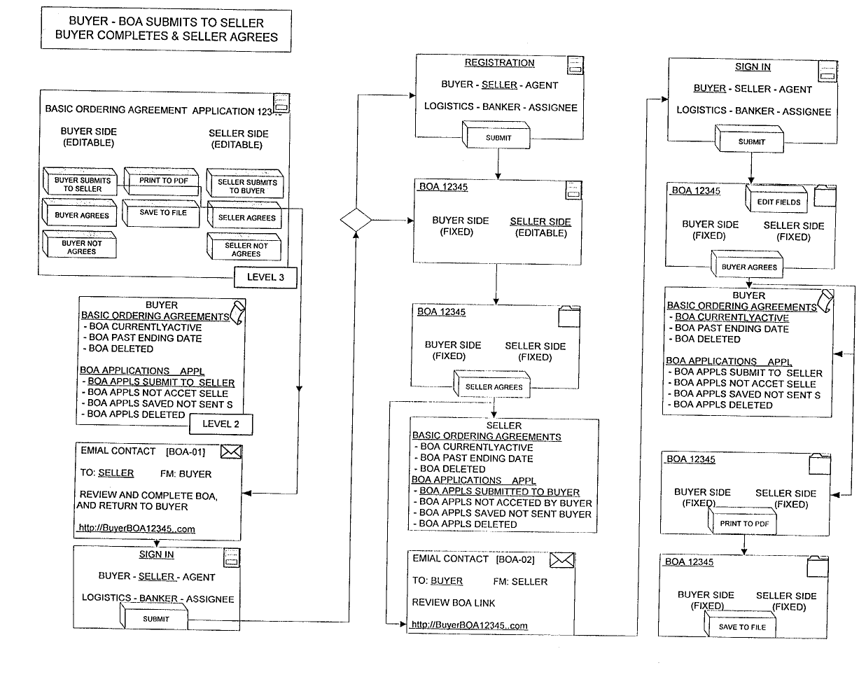

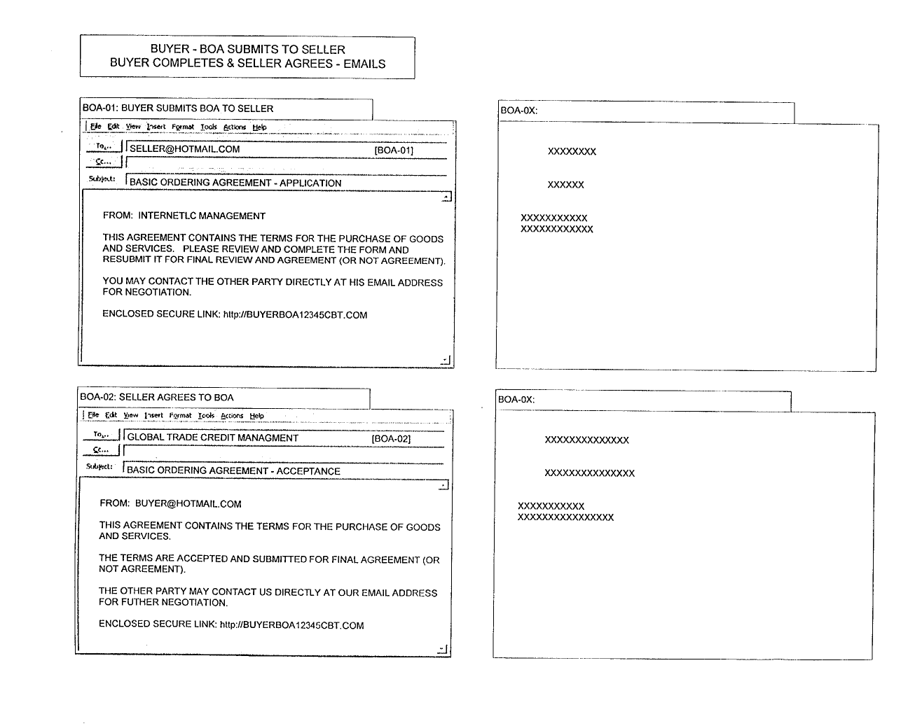

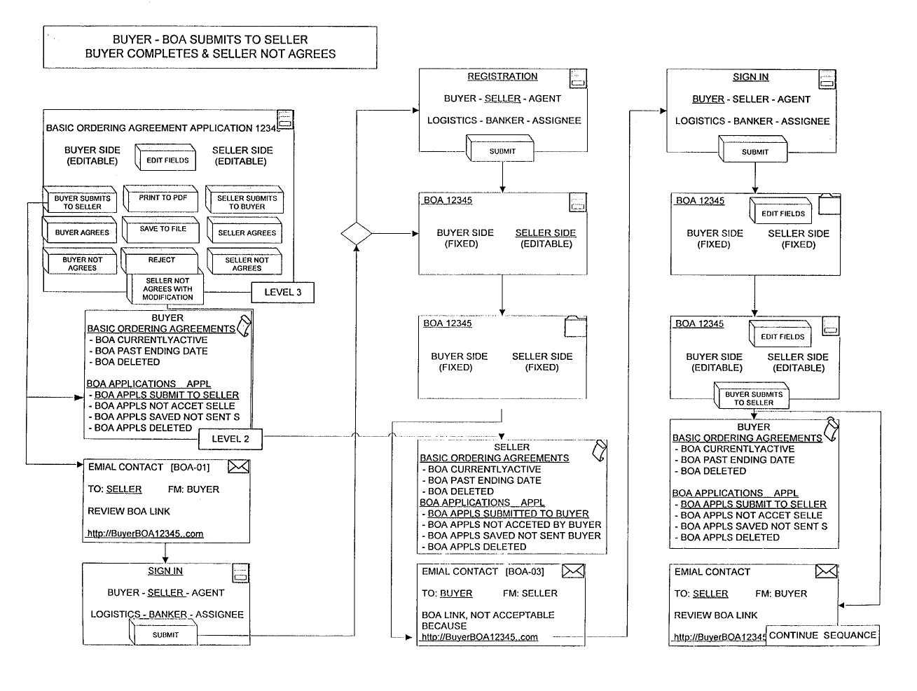

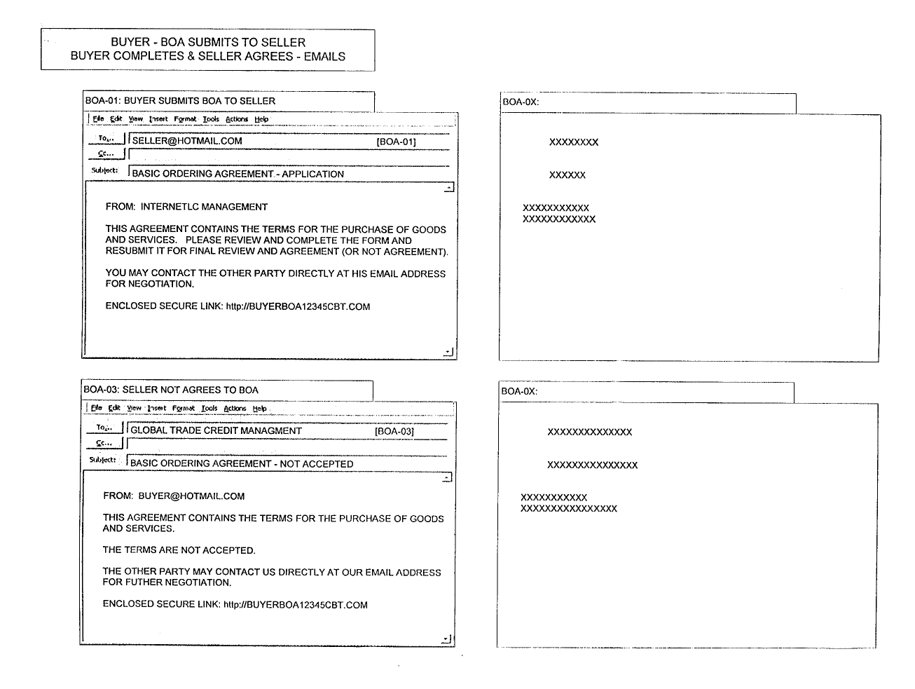

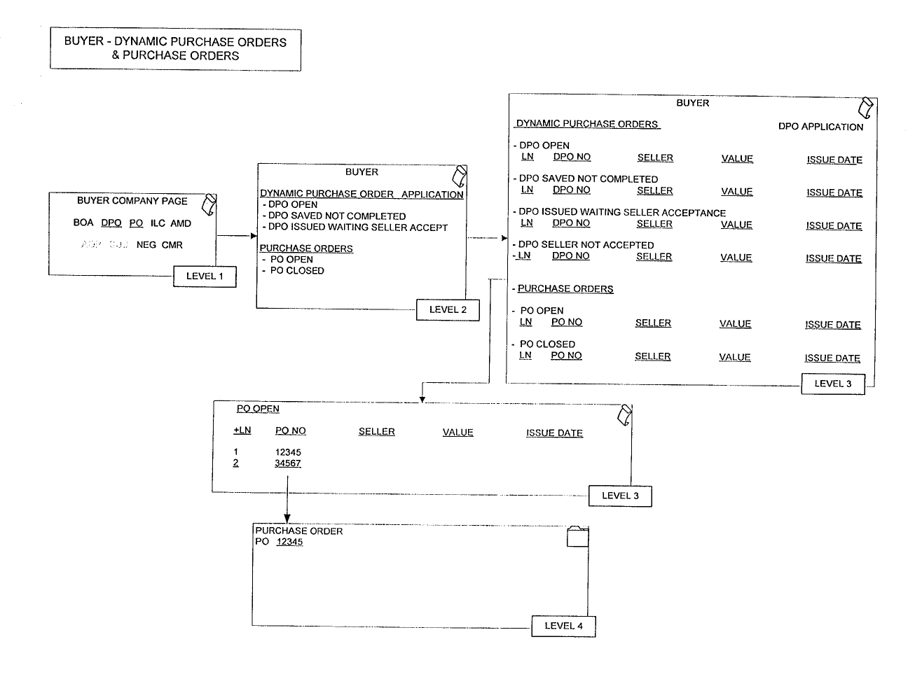

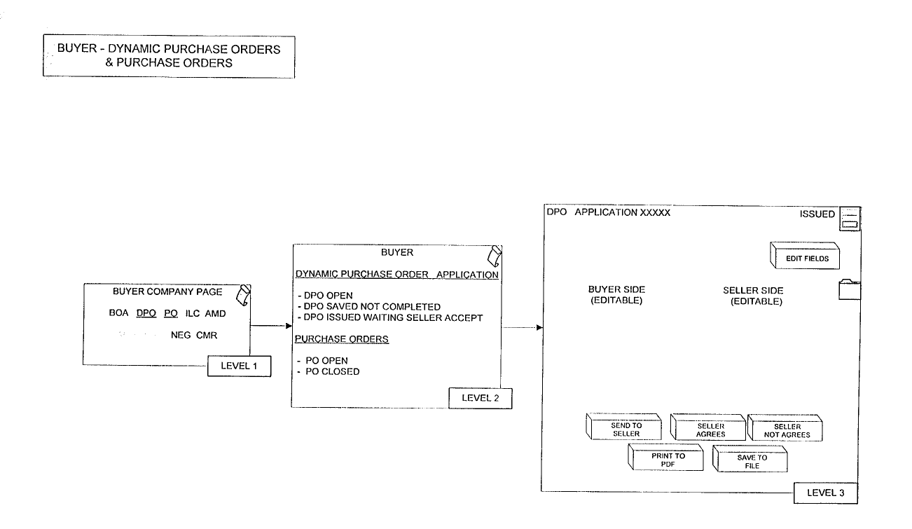

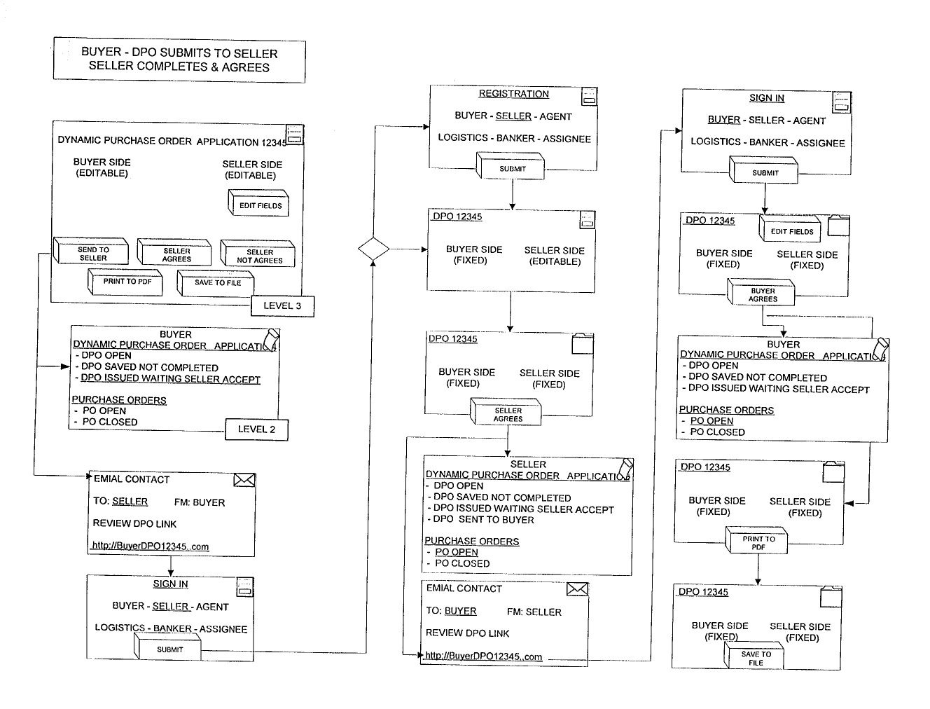

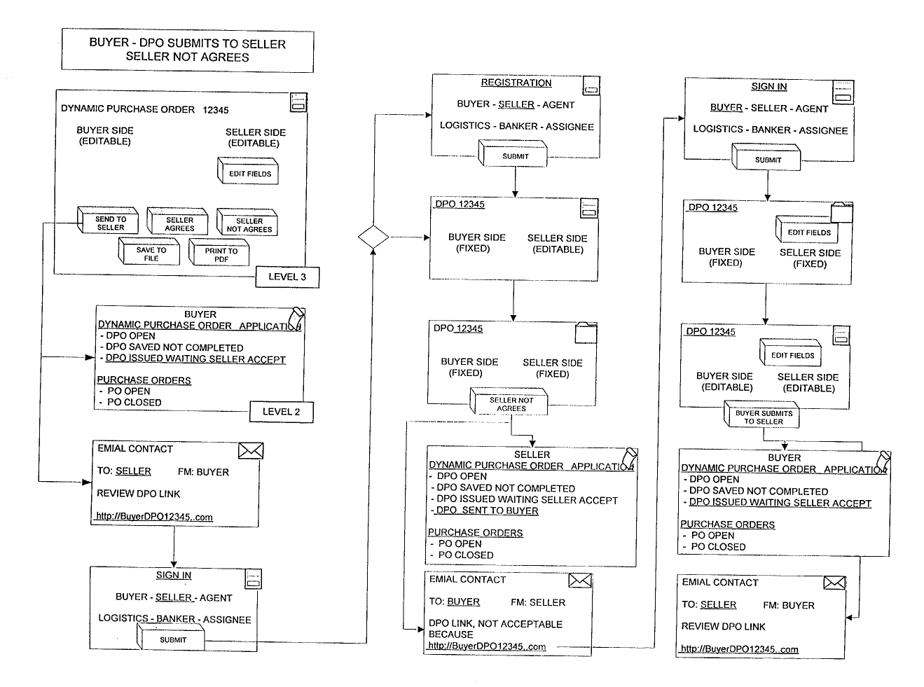

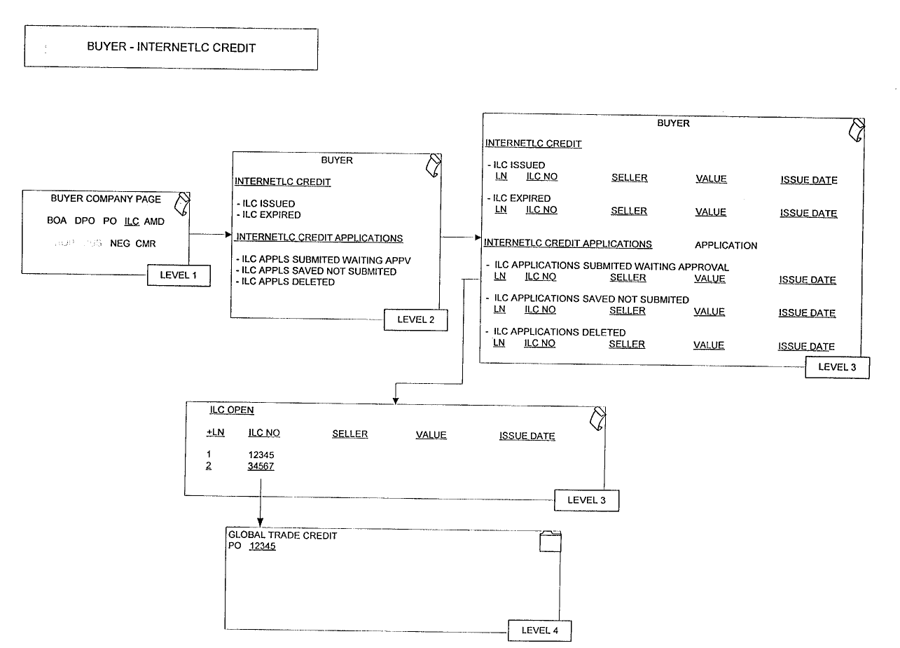

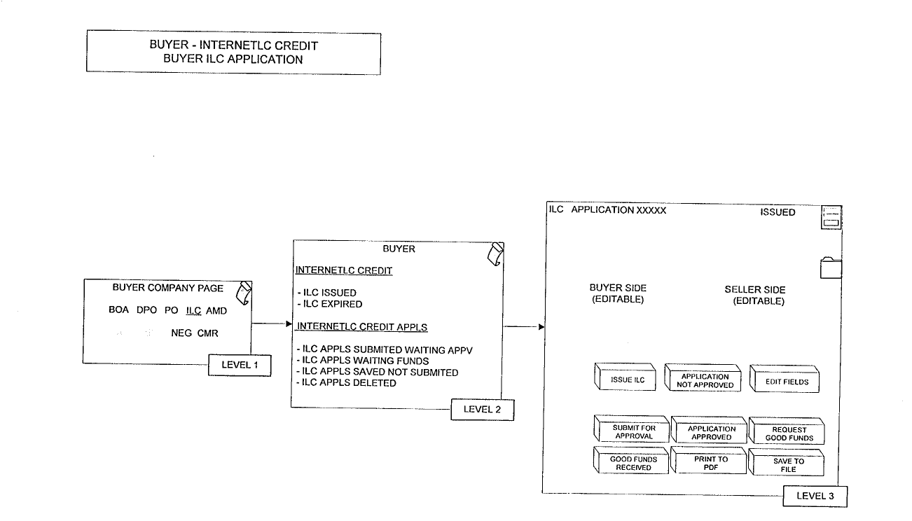

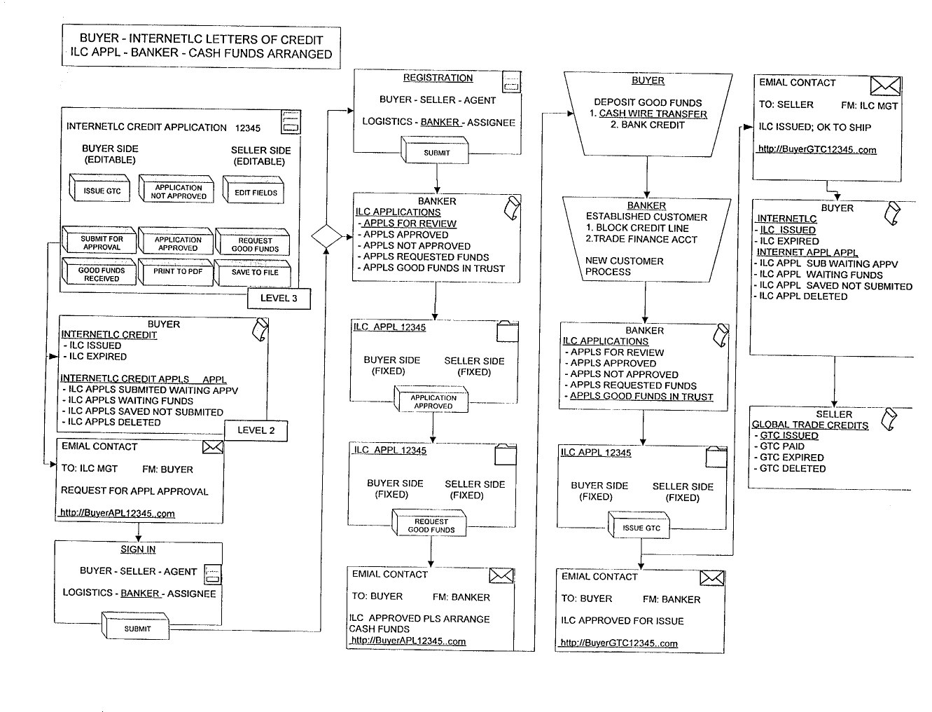

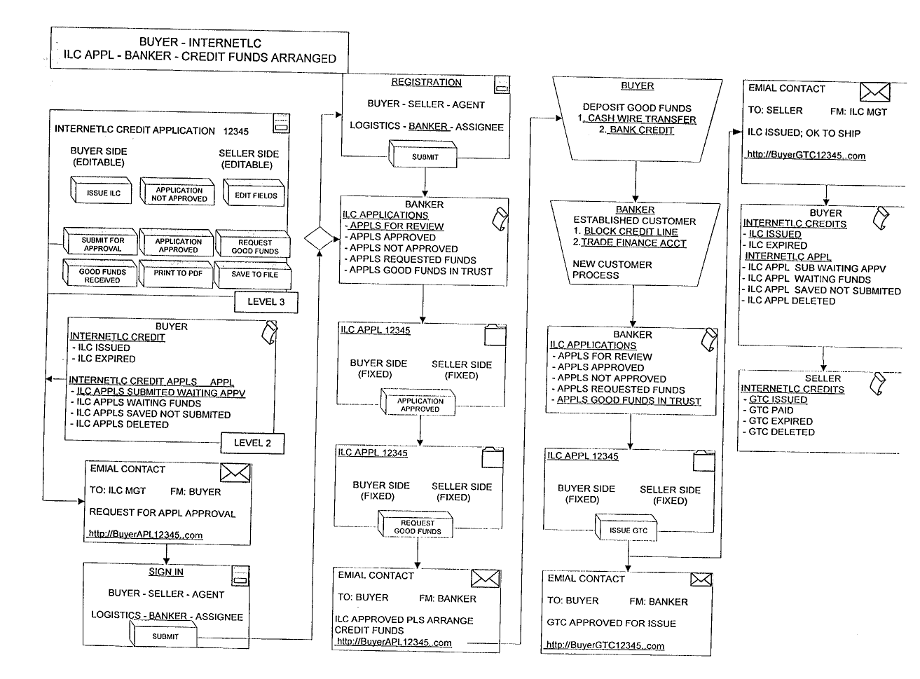

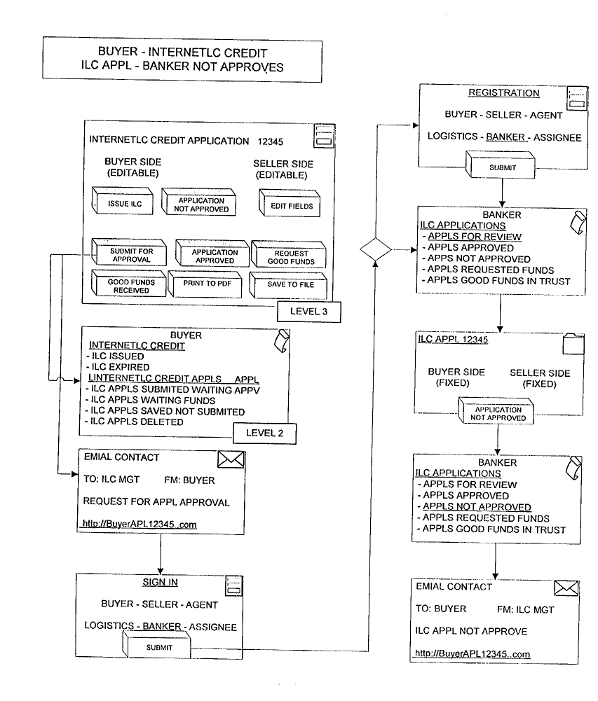

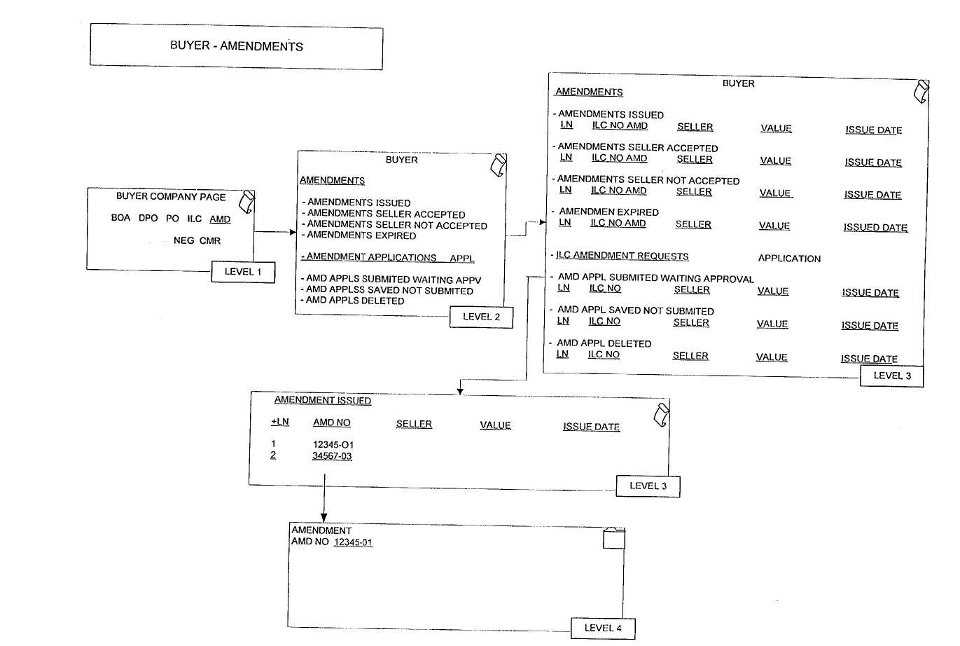

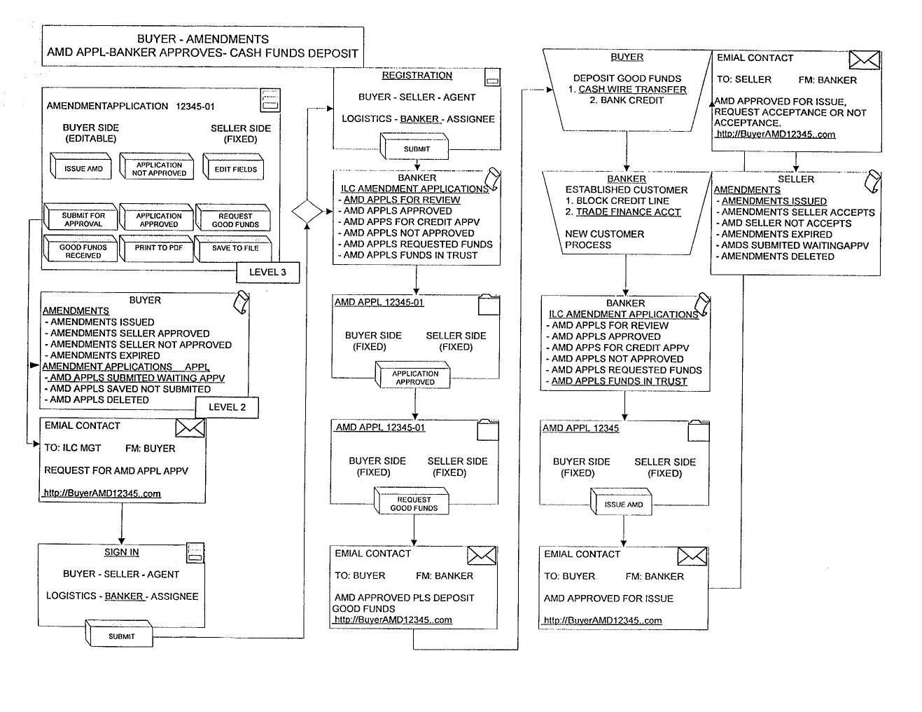

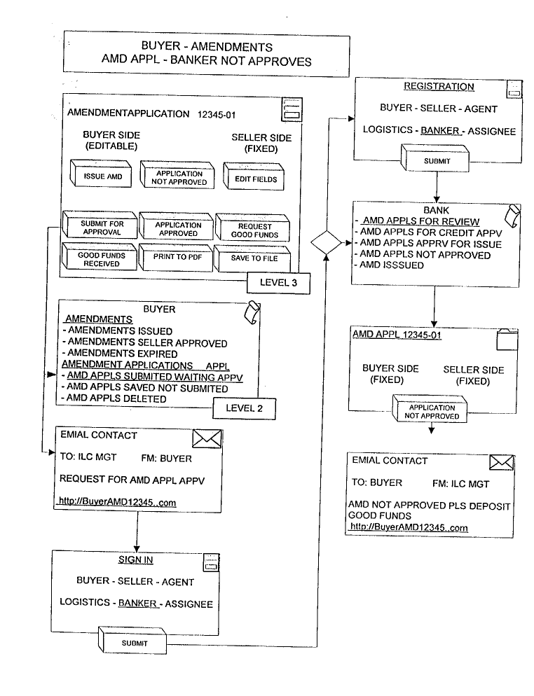

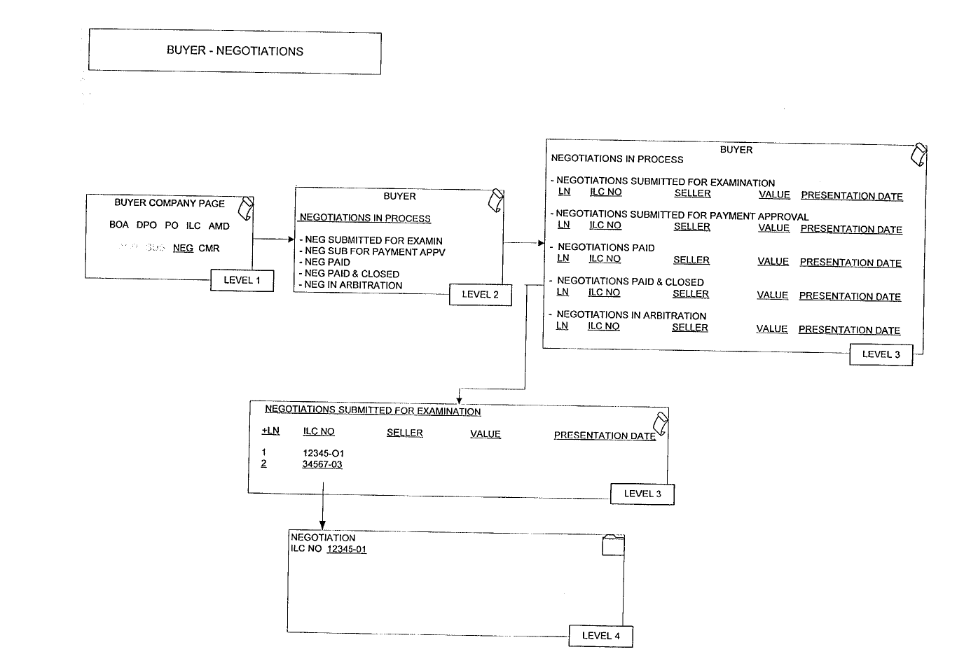

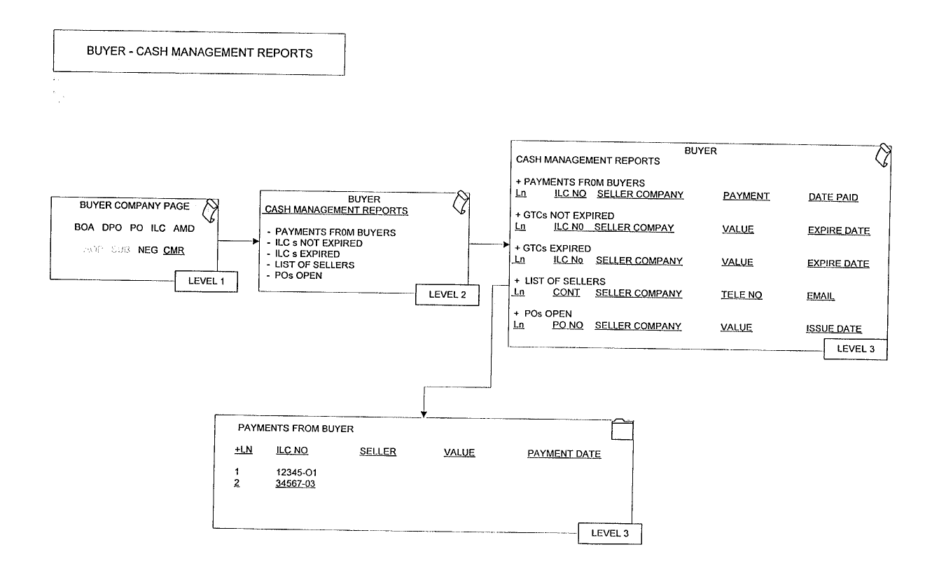

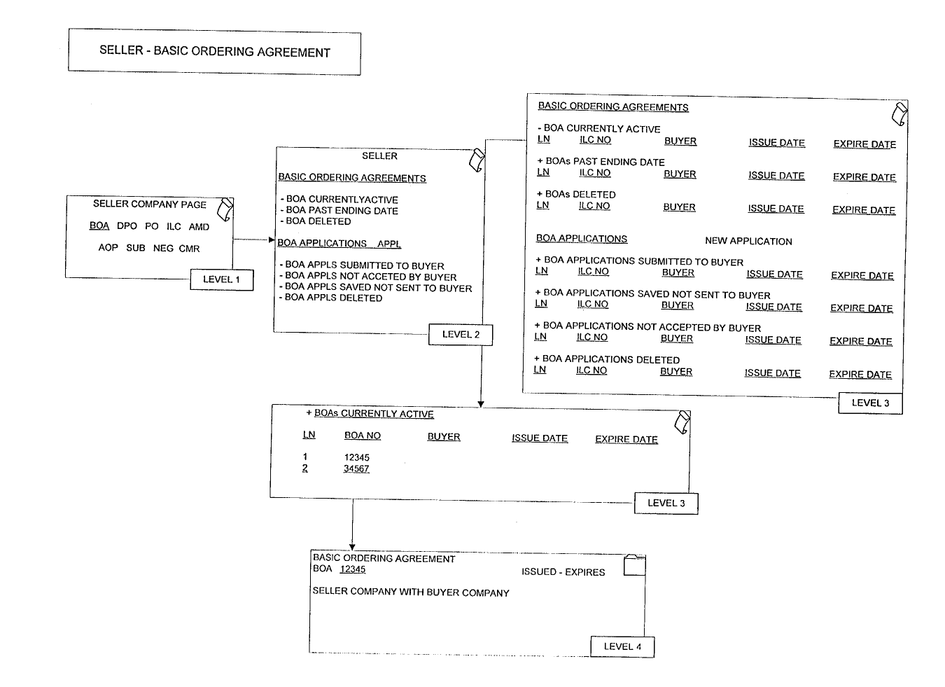

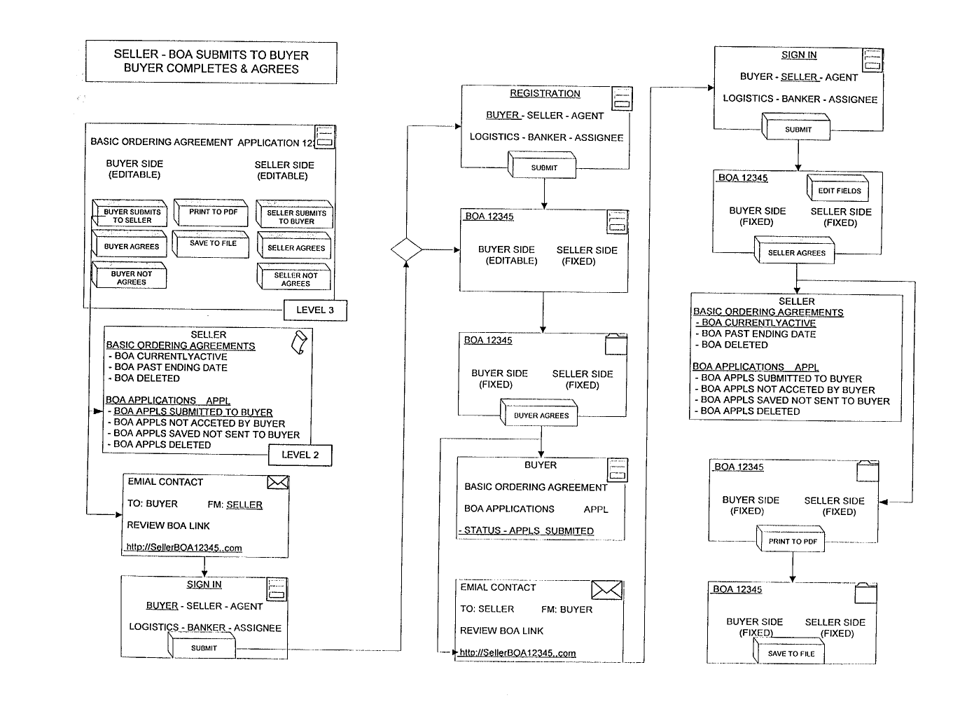

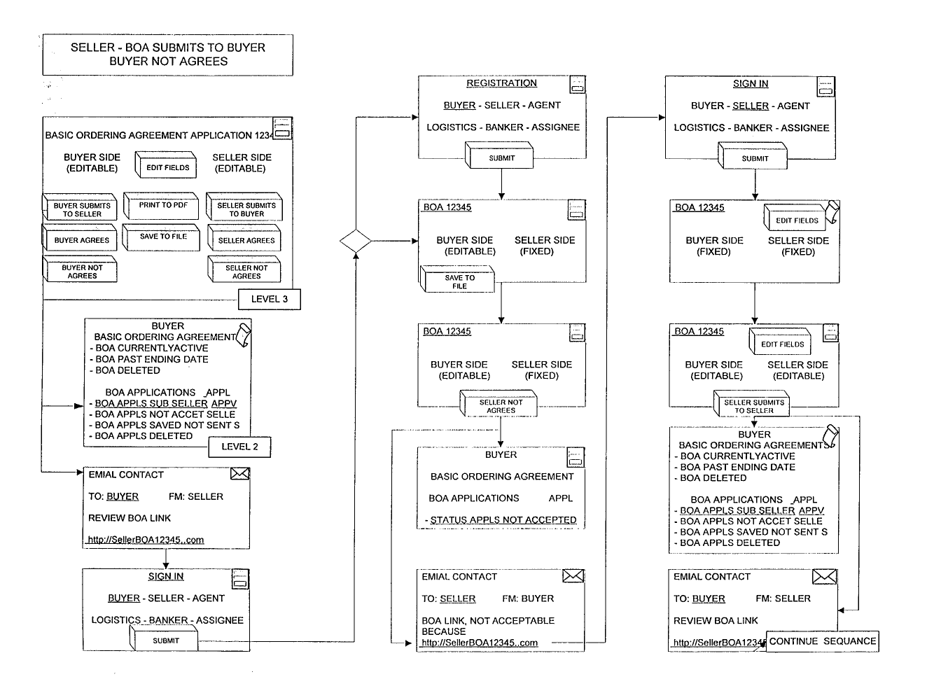

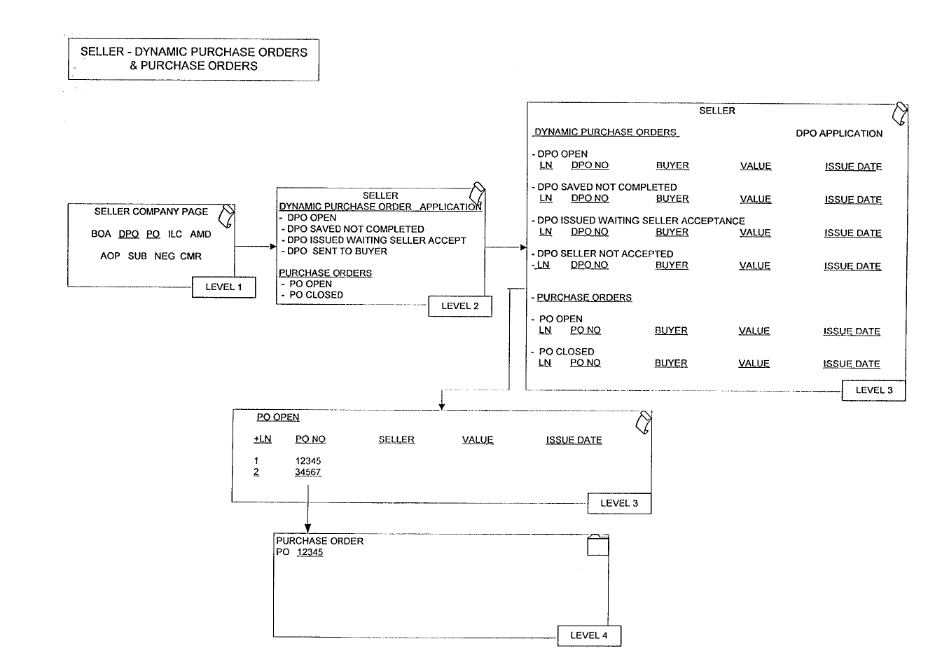

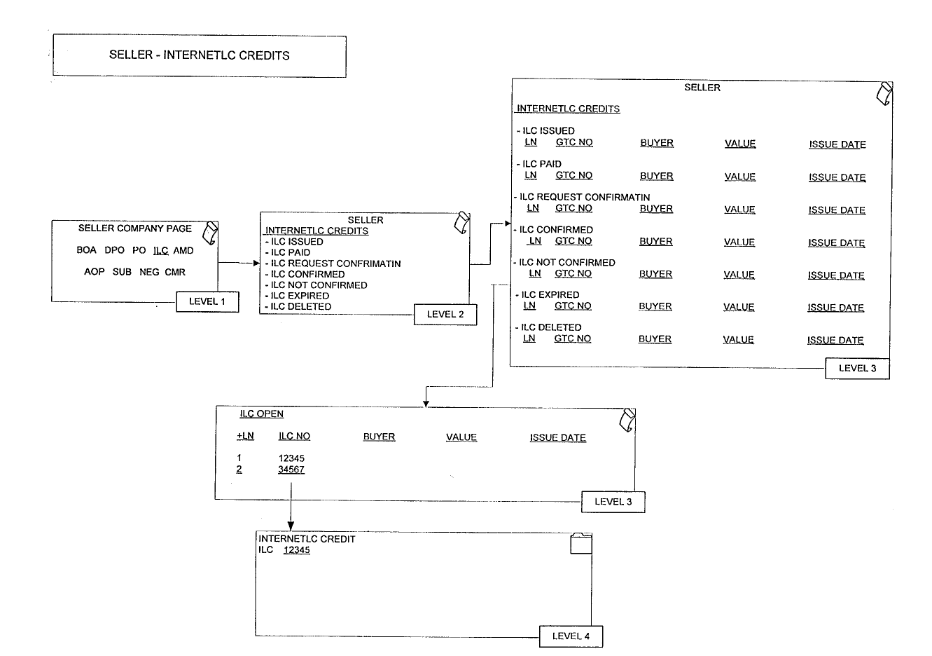

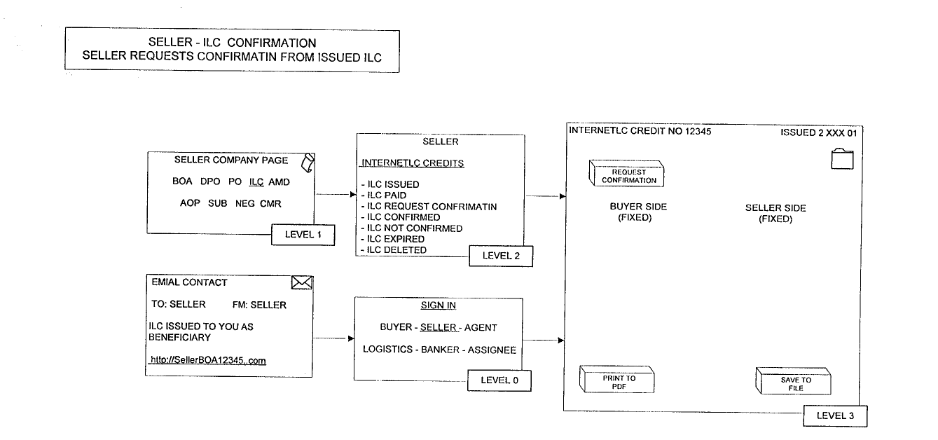

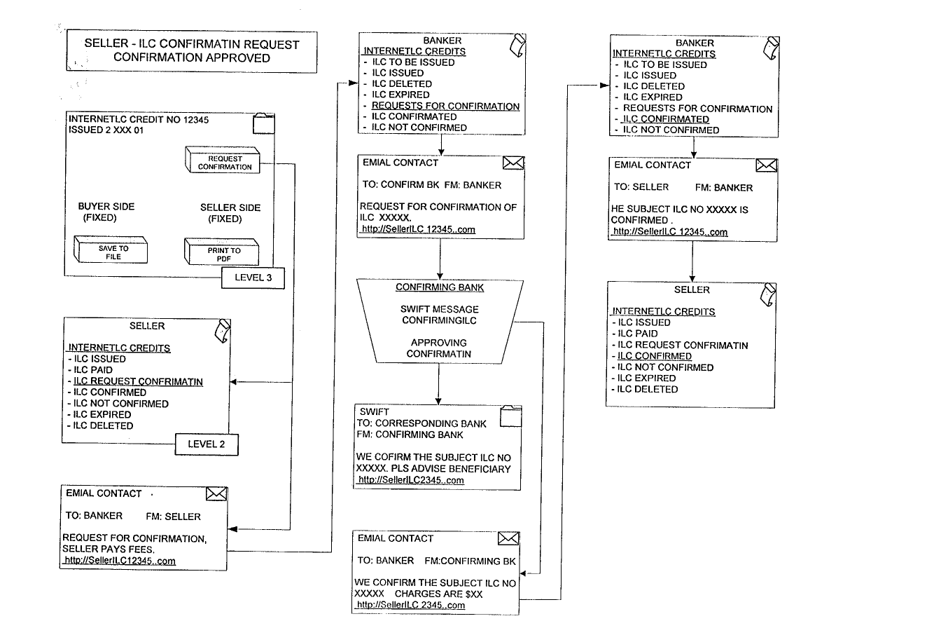

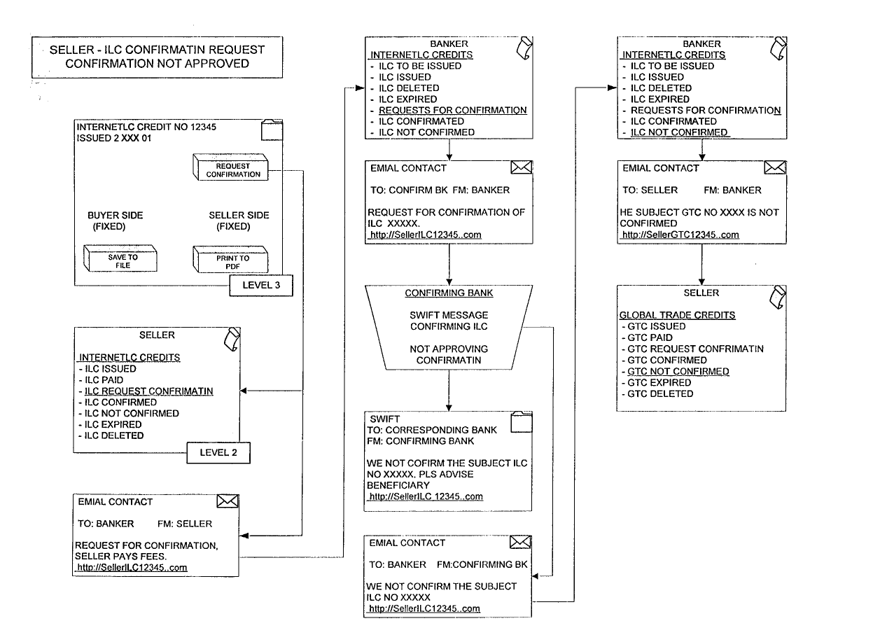

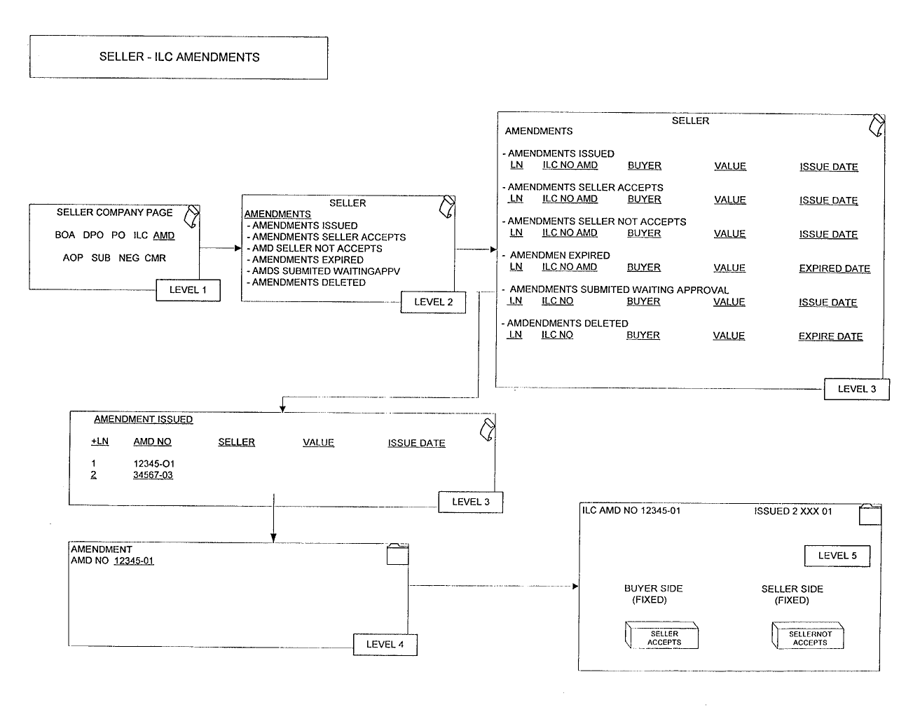

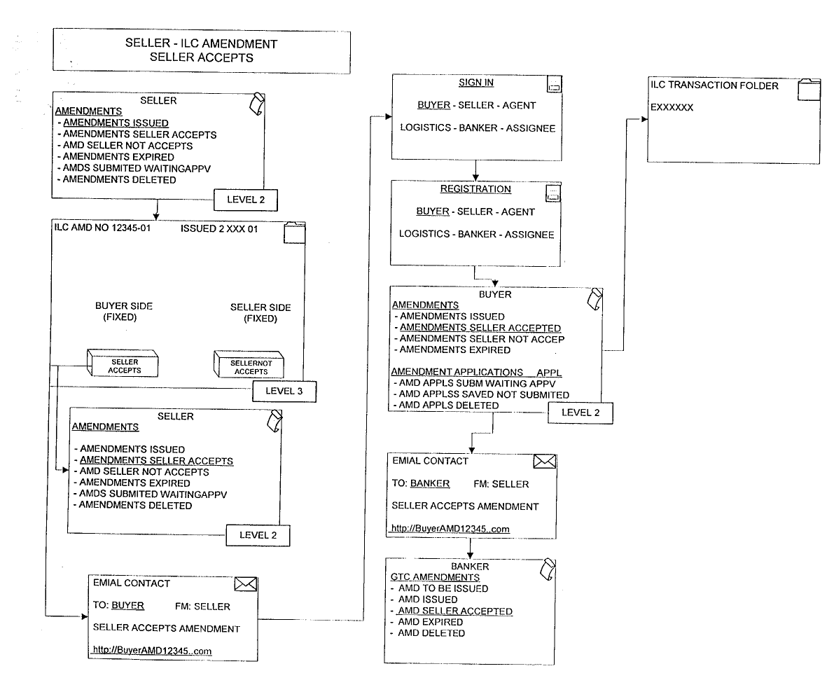

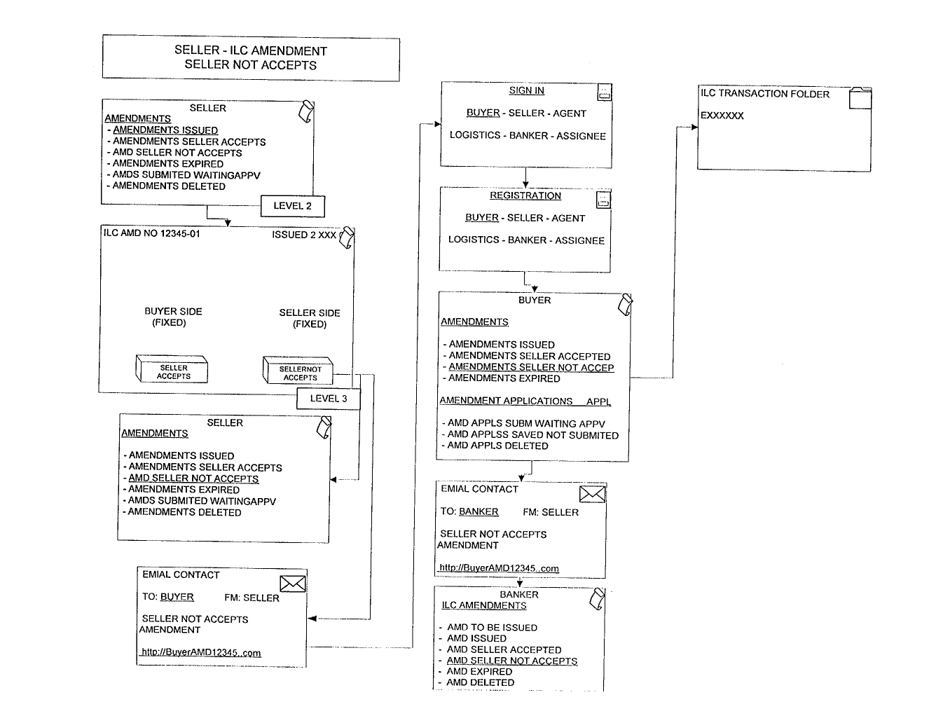

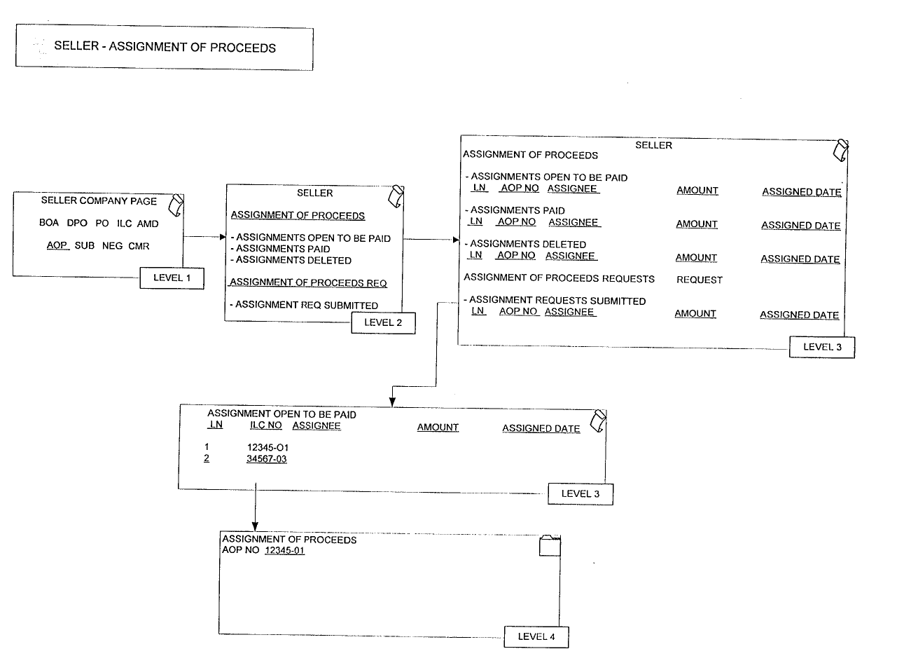

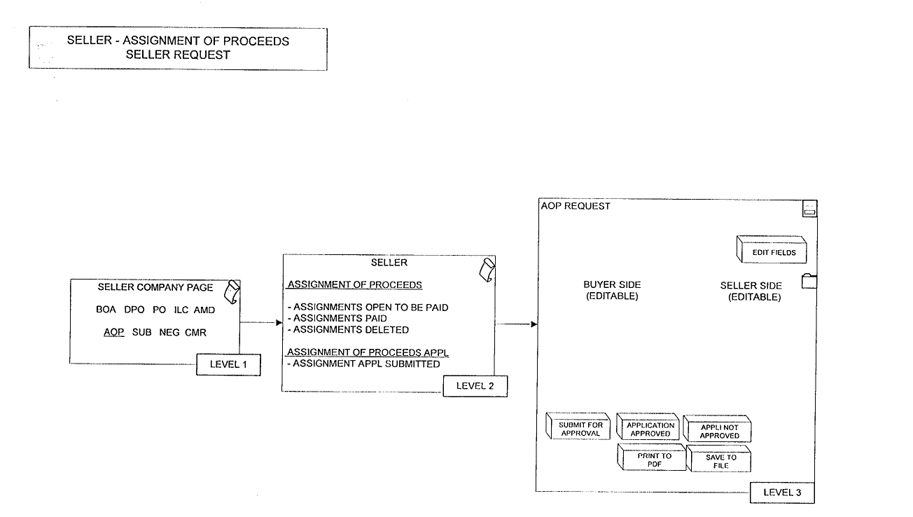

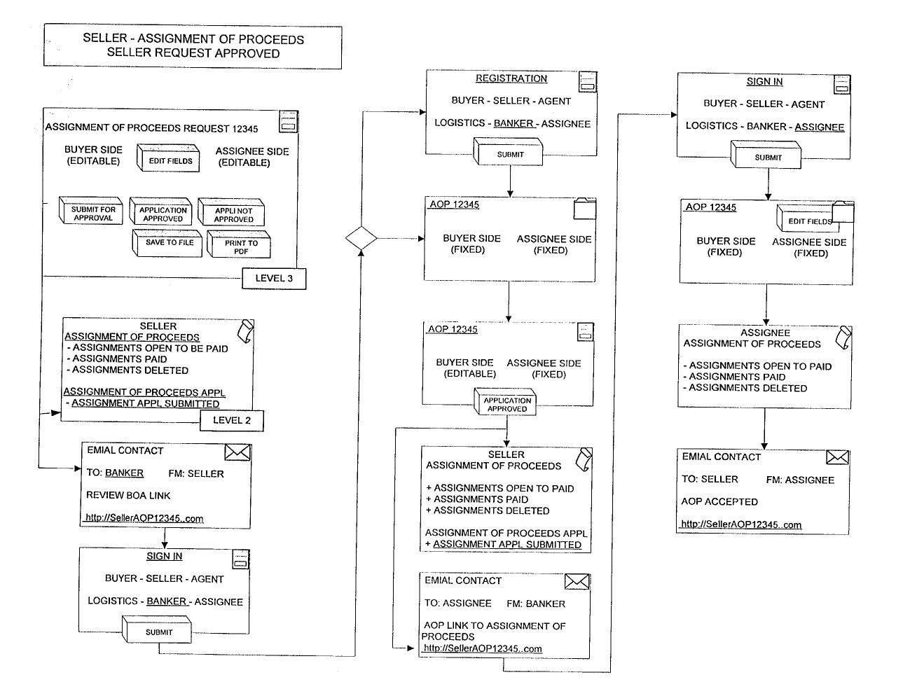

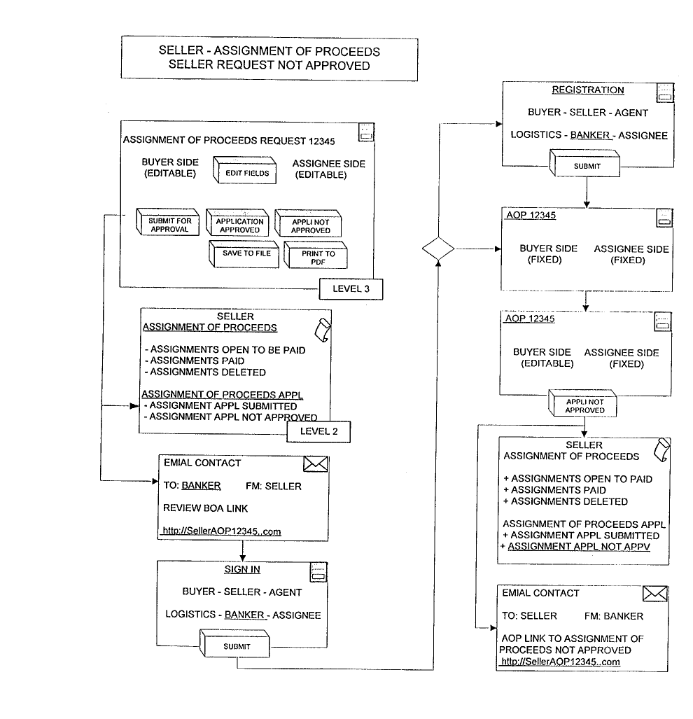

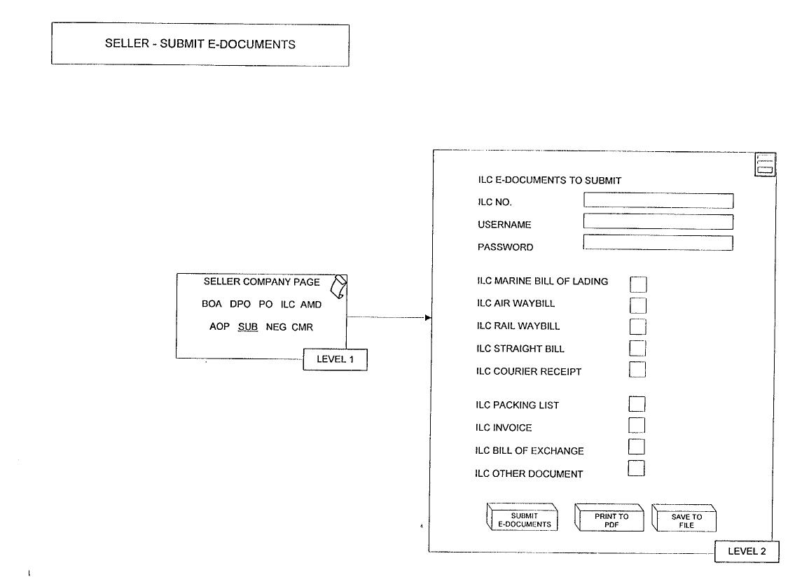

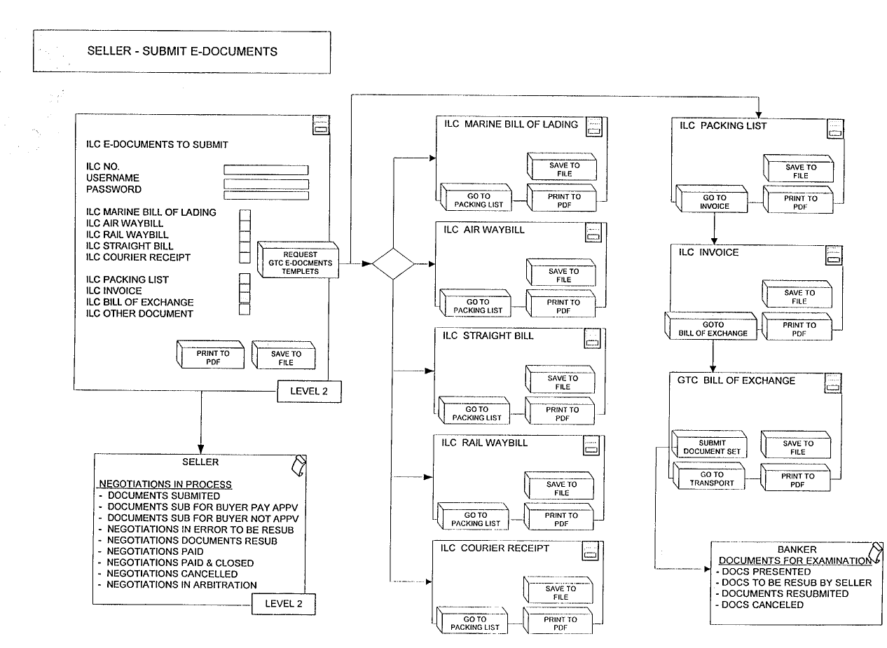

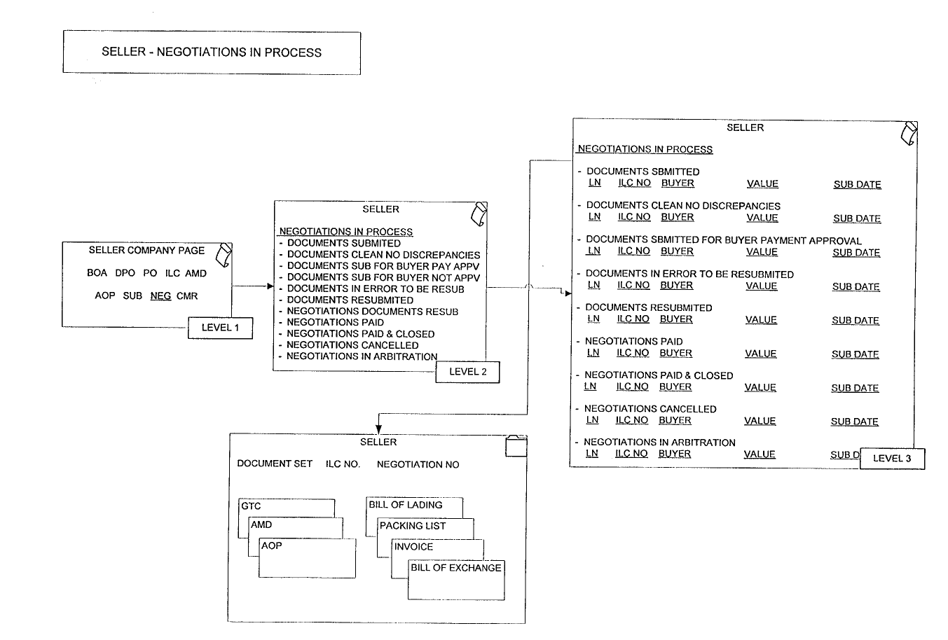

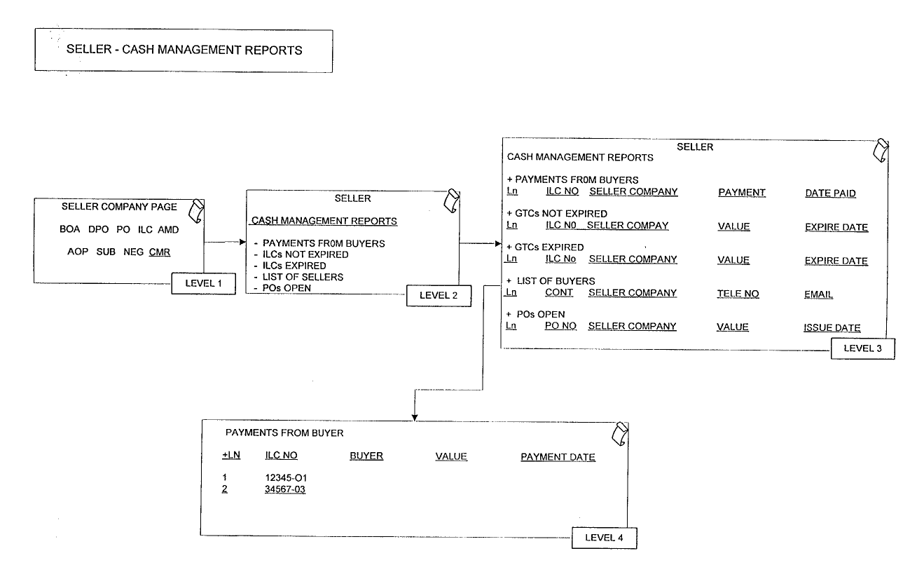

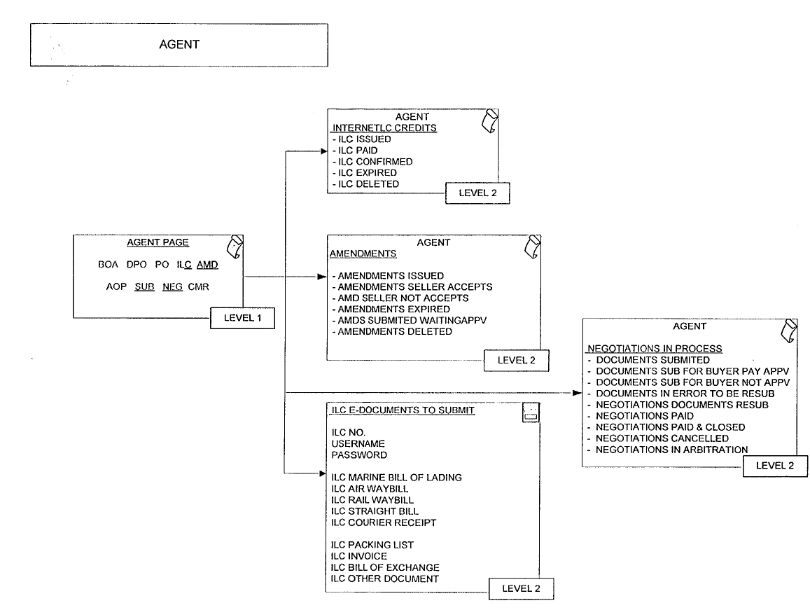

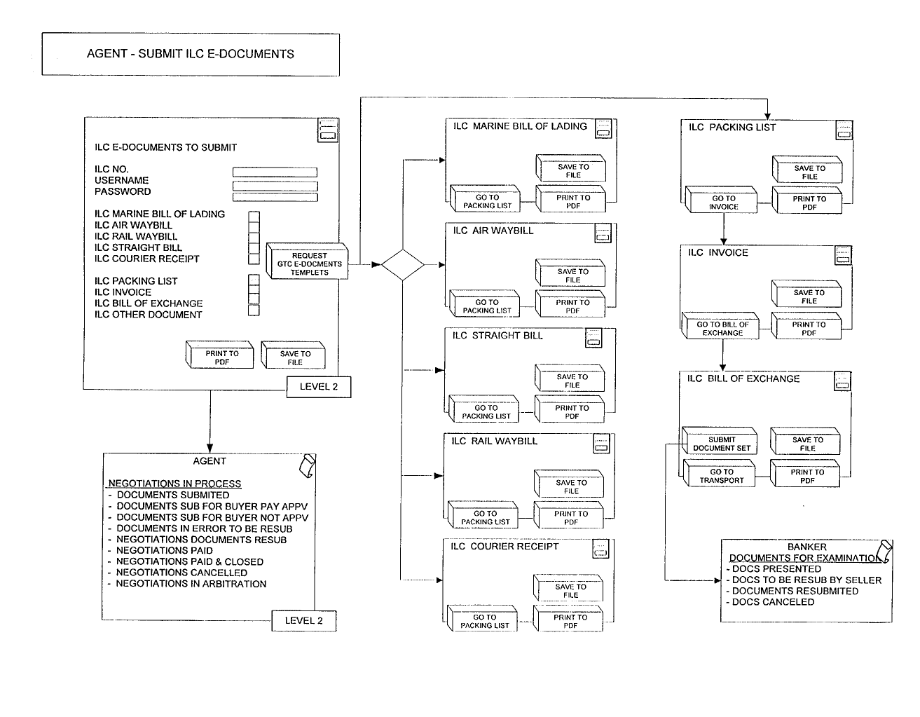

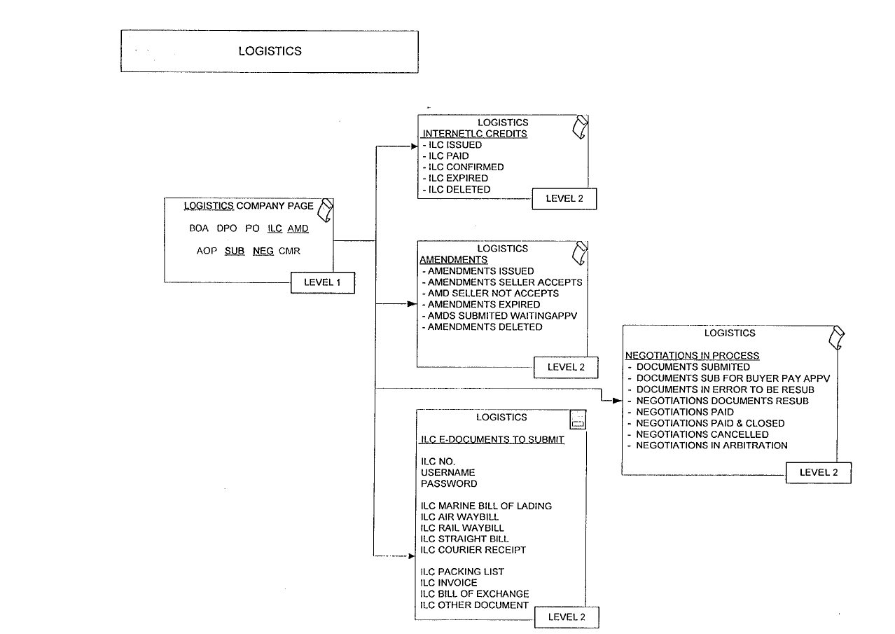

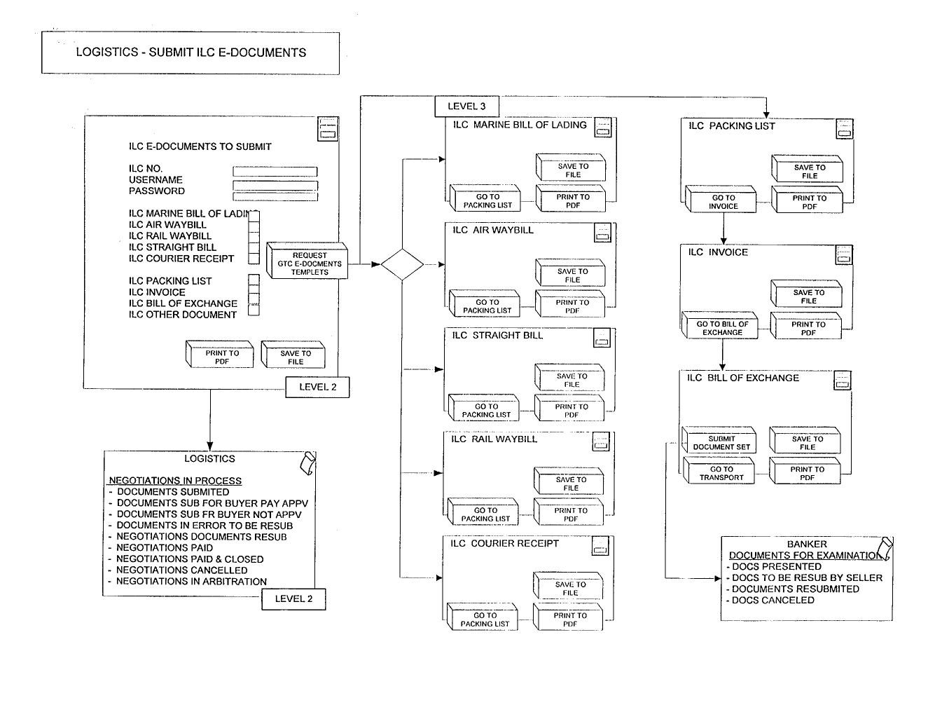

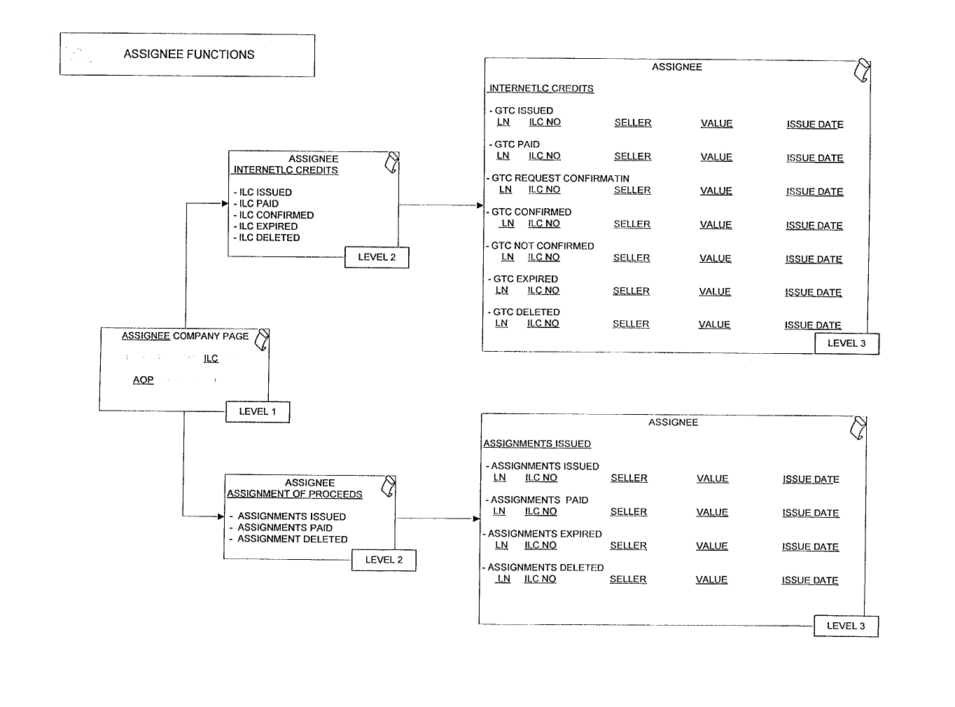

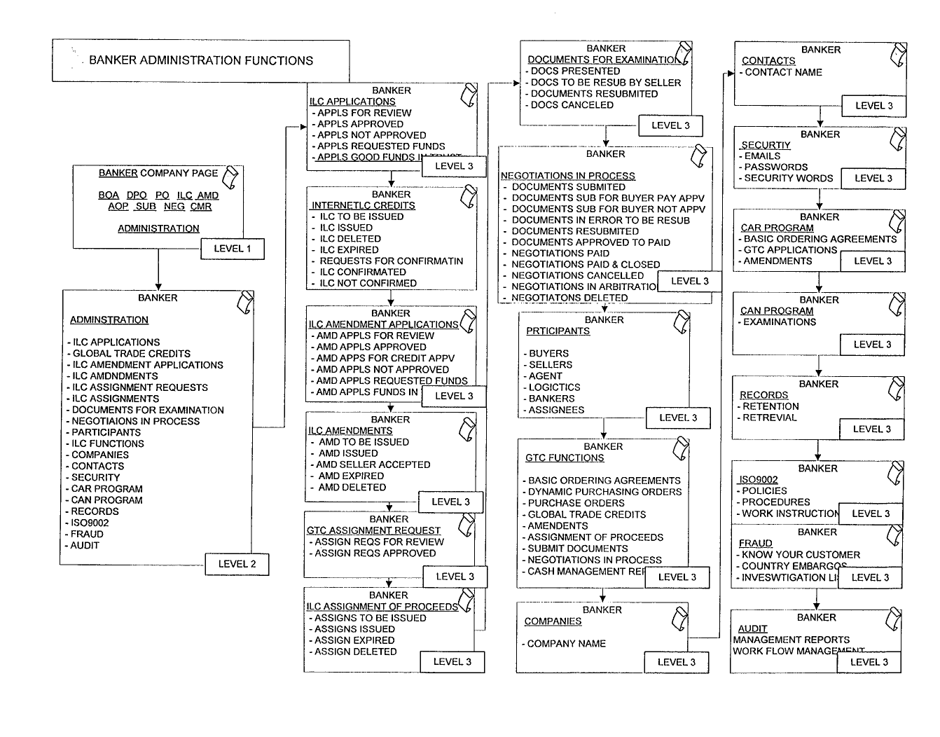

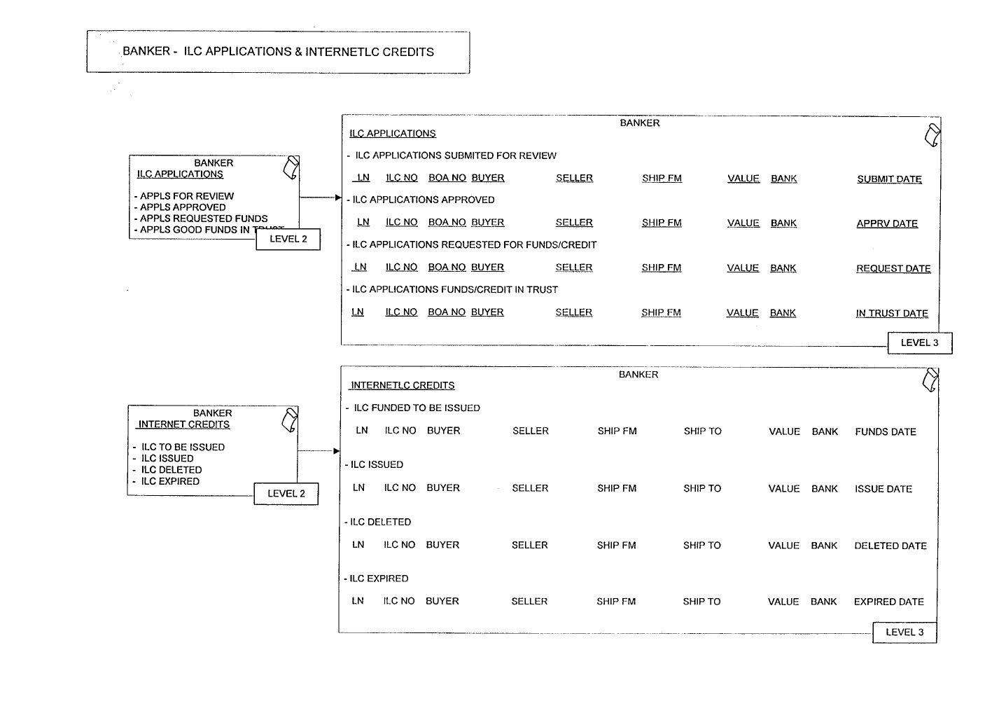

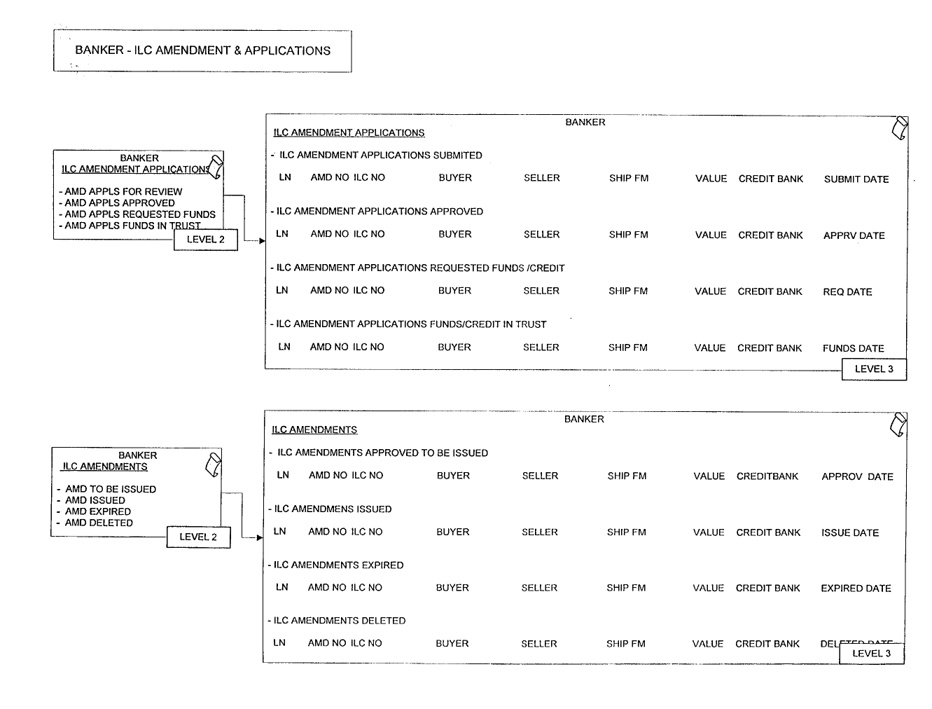

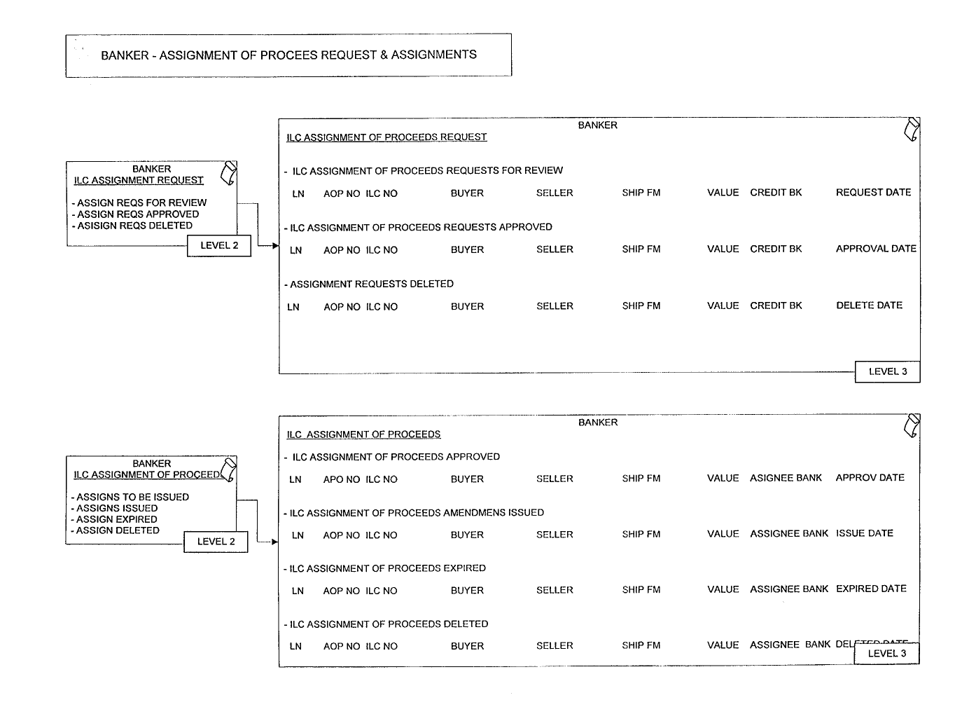

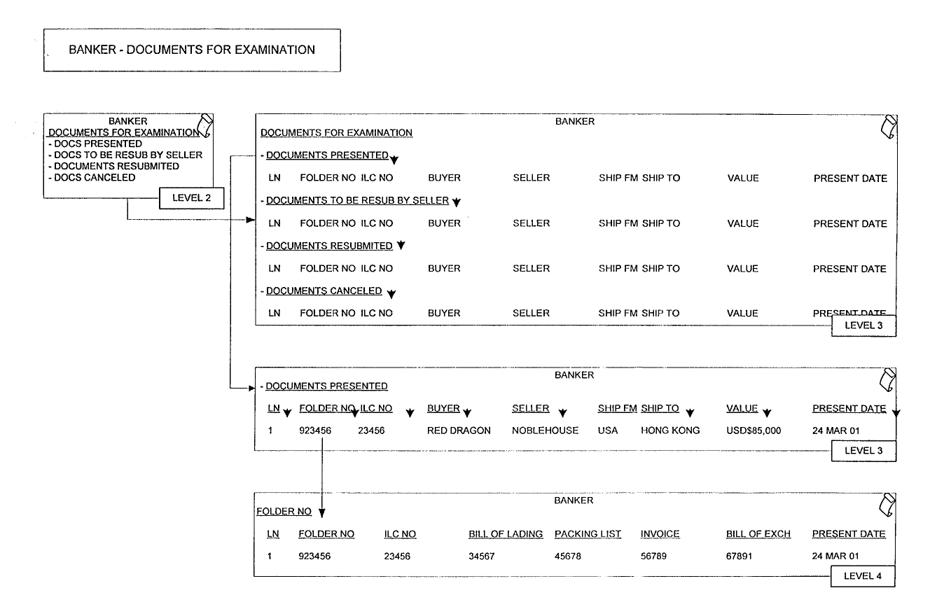

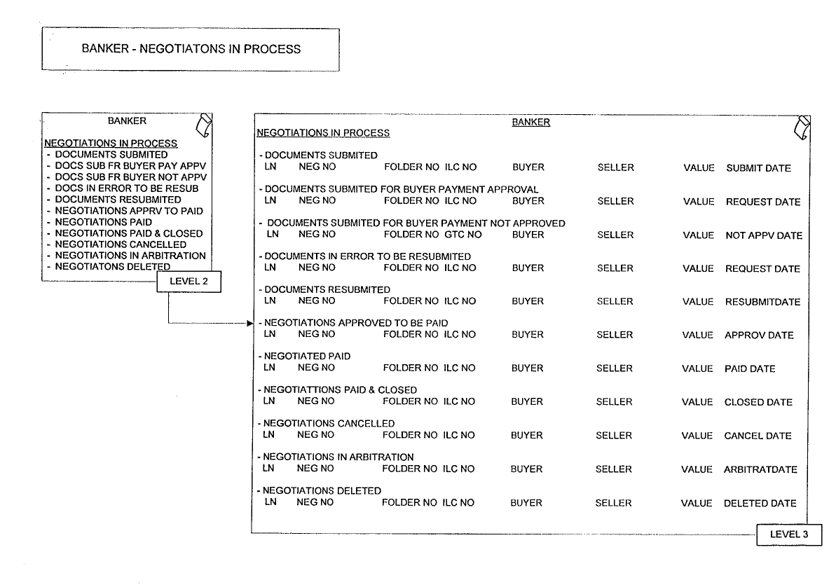

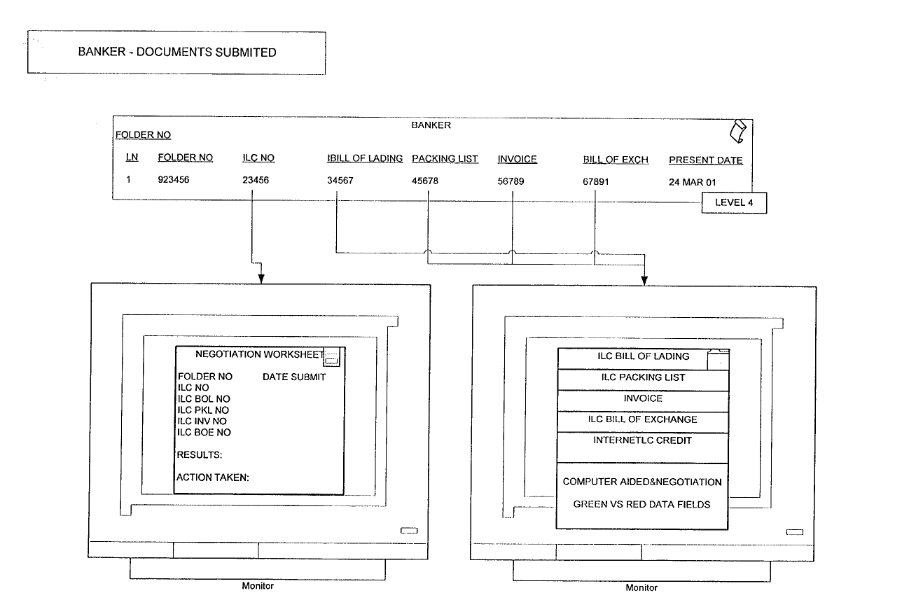

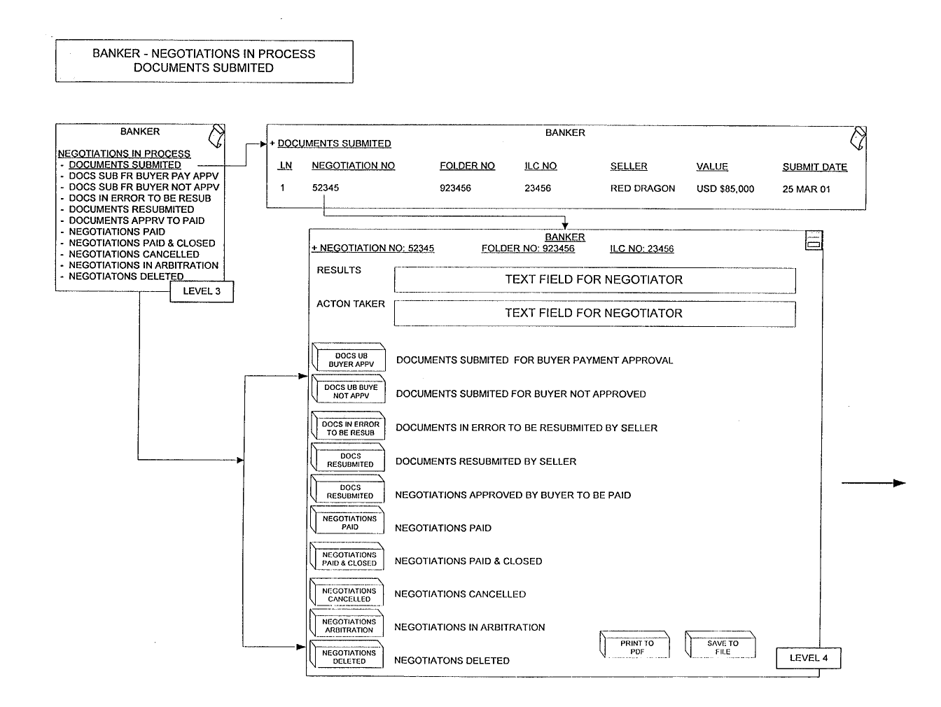

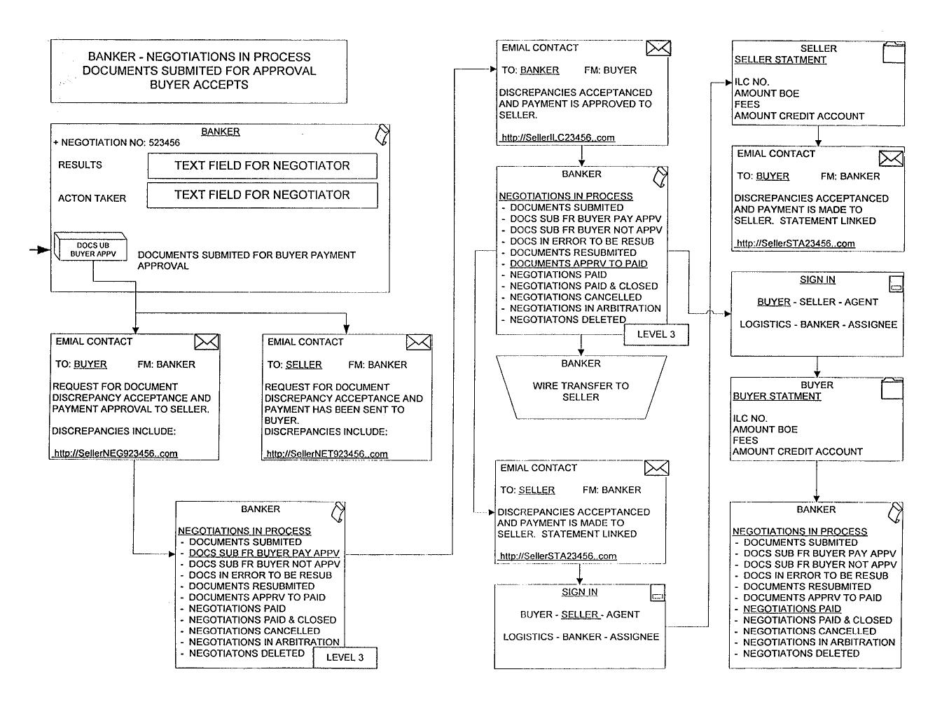

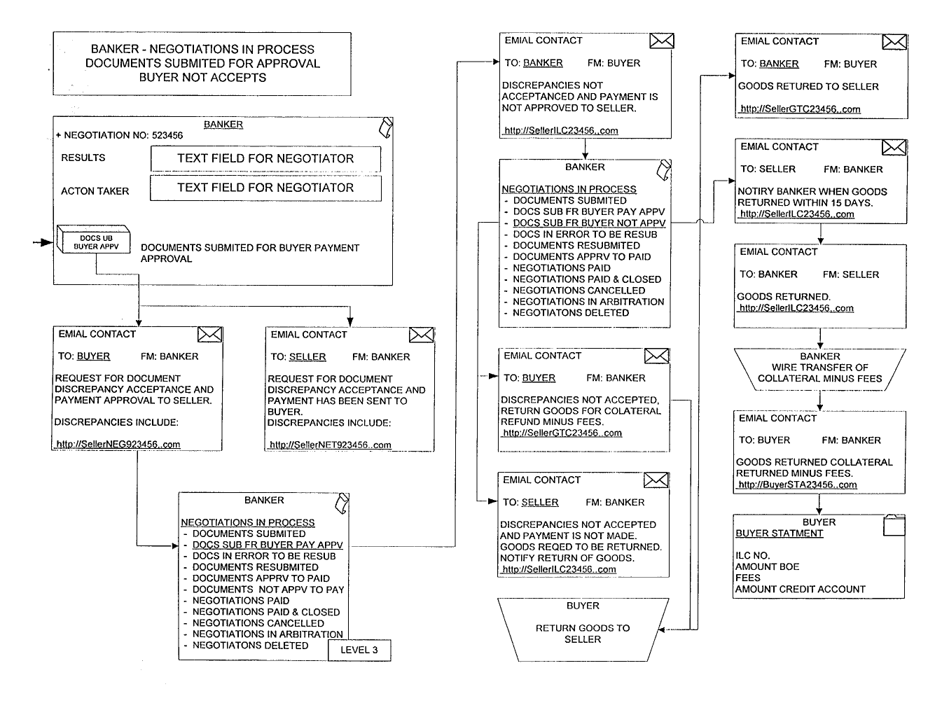

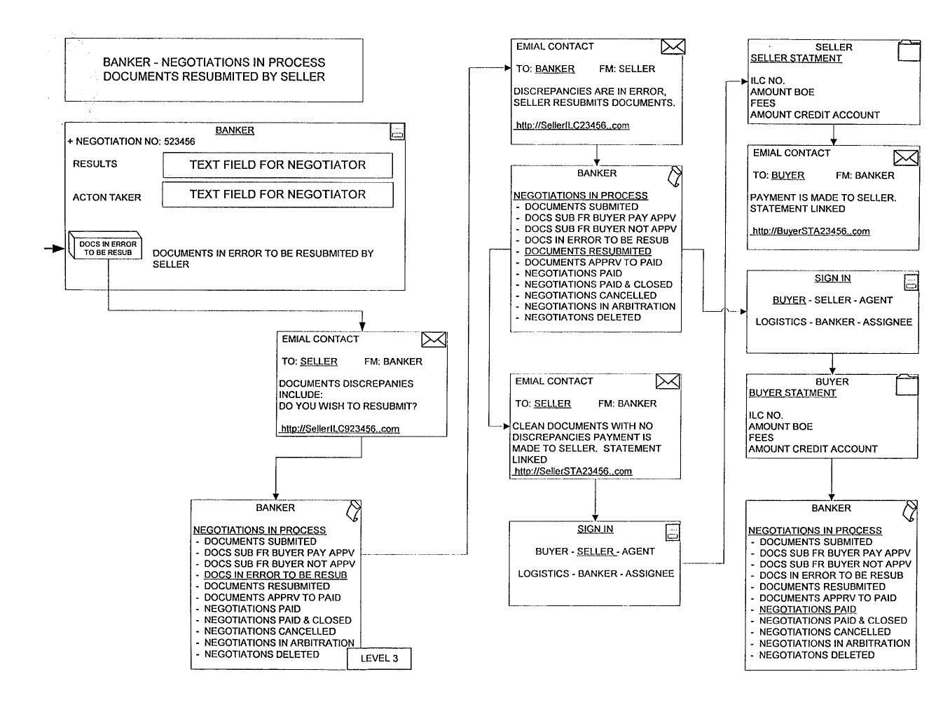

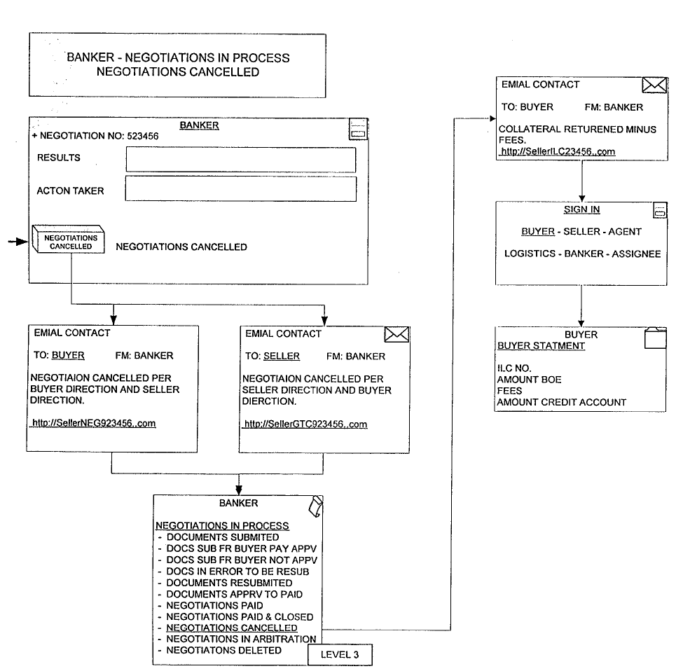

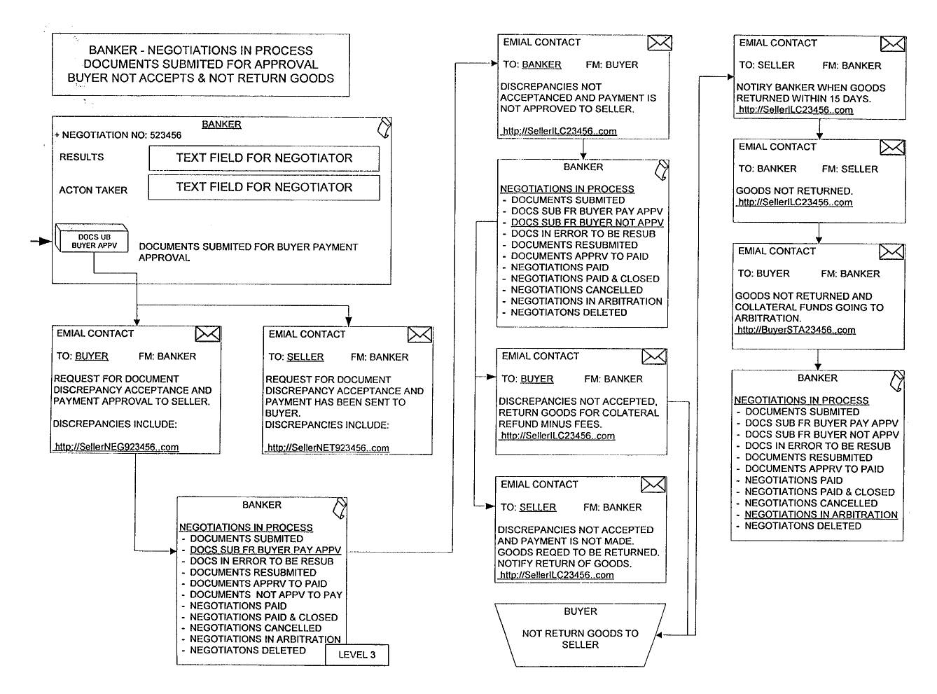

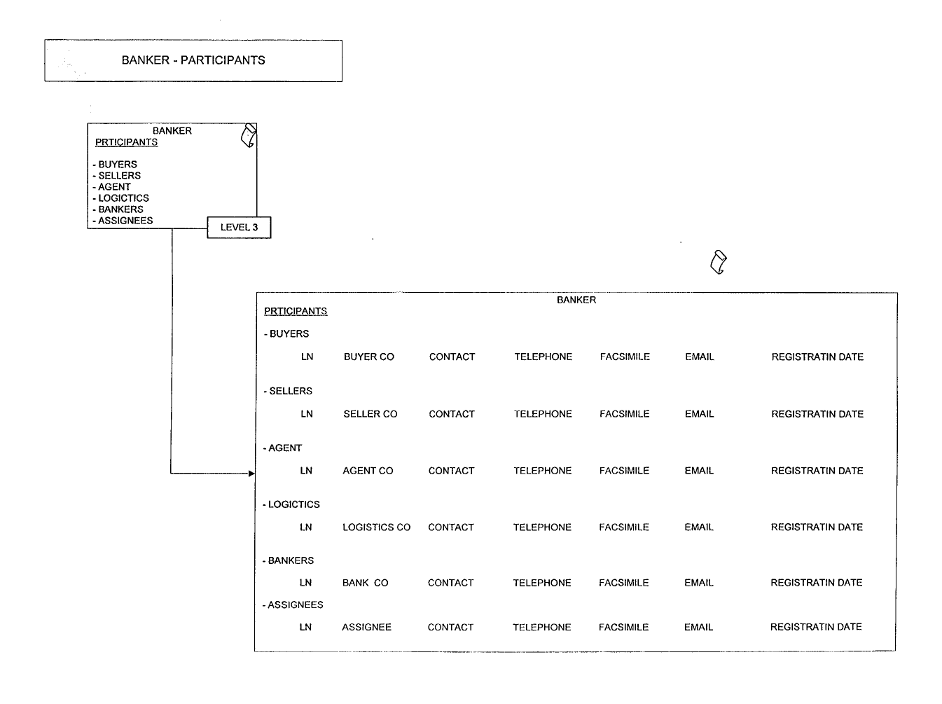

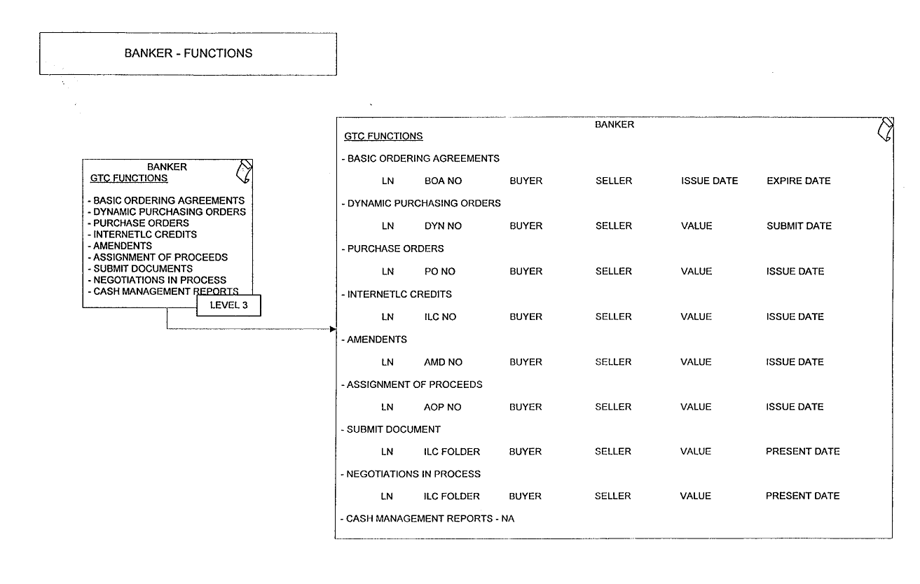

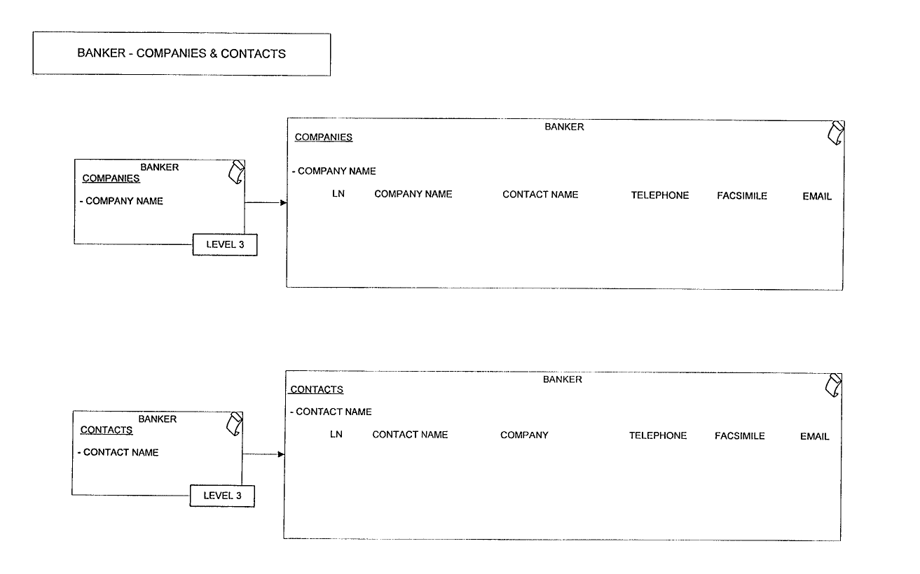

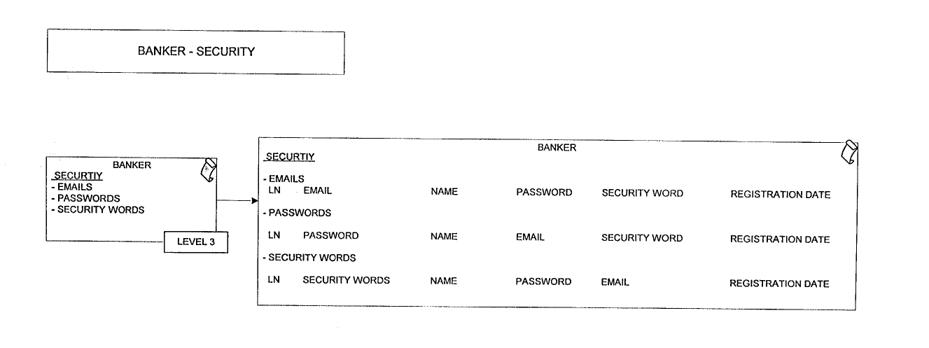

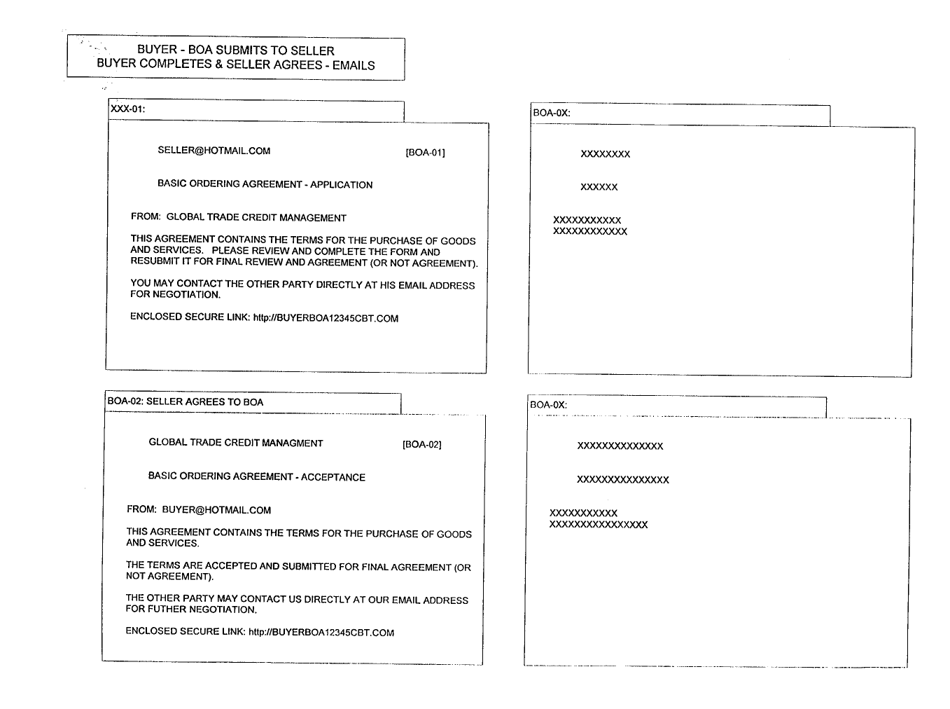

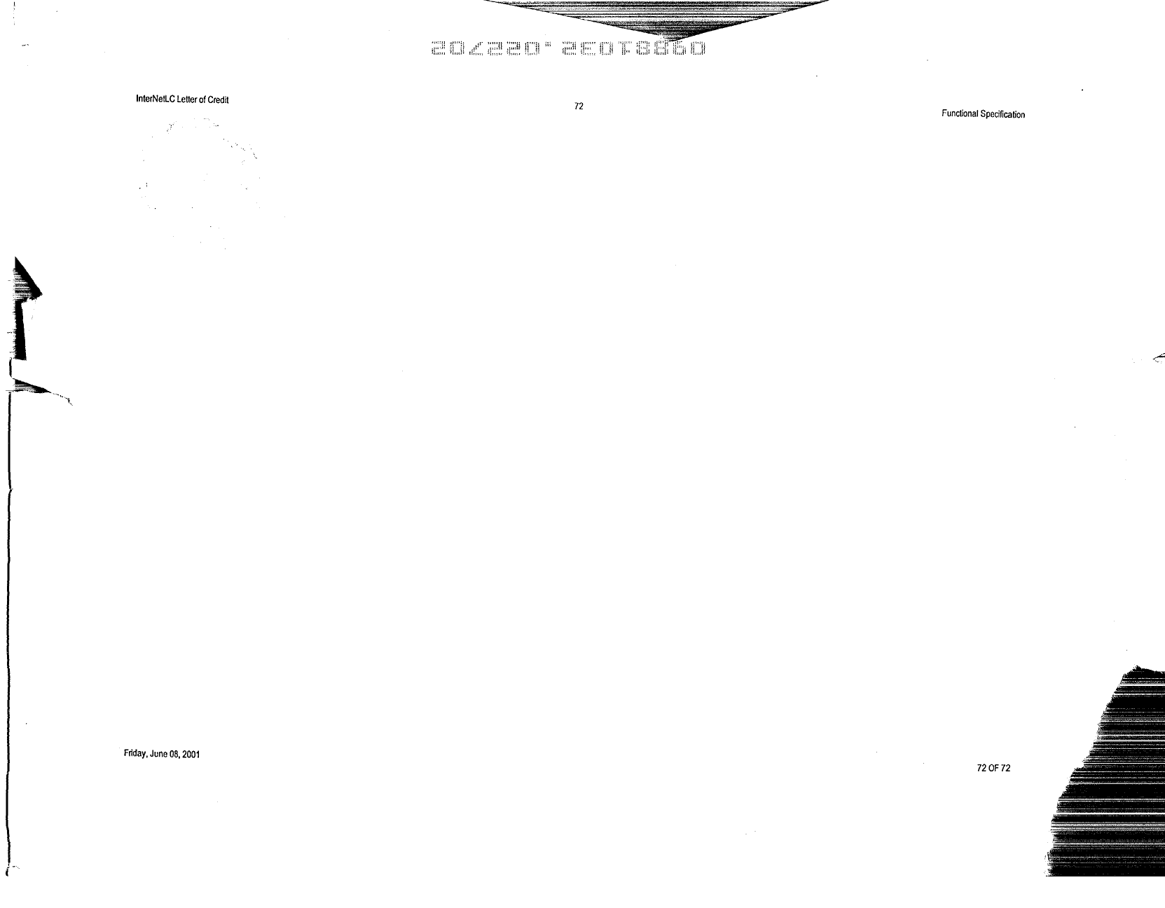

FIG. 5.1: Registration

FIG. 5.2: Sign In

FIG. 5.3: Basic Ordering Agreement

FIG. 5.4: Dynamic Purchase Order

FIG. 5.5: Purchase Order

FIG. 5.6: Letter of Credit Application

FIG. 5.7: Letter of Credit Amendment

FIG. 5.8: Assignment of Proceeds

FIG. 5.9: E-Documents to Submit

FIG. 5.10: E-Marine Bill of Lading

FIG. 5.11: E-Air Waybill

FIG. 5.12: E-Rail Waybill

FIG. 5.13: E-Courier Receipt

FIG. 5.14: E-Packing List

FIG. 5.15: E-Invoice

FIG. 5.16: E-Bill of Exchange

Drawing No. 6.0: Functional Product Workflow & Architecture

Appendix No. 1.0: ICC (UCP 500) Uniform Customs and Practice for Documentary Credits, Publication No. 500.

### DETAILED DESCRIPTION OF THE INVENTION

1 InterNetLC® Documentary Letter of Credit Internet Trade Transaction Settlement System.

InterNetLC(r)™ (ILC) is an Internet substitute for Documentary Letter of Credit transactions. It is cash or bank credit backed instrument issued by a bank via Internet for the purchase and shipment of goods to a buyer. The InterNetLC is negotiable by the ICC Uniform Customs and Practices for Documentary Credits.

InterNetLC™ is a secure payment method for sellers that demand payment upon shipment and for buyers that want to pay against transport documents. InterNetLC™ is payable by a bank with digital identification authenticated e-documents representing the transport Bill of Lading or Air Waybill, Rail Waybill, Straight Bill, Courier Receipt, Invoice, Packing List and Bill of Exchange that are equivalent with the document requirements specified in the InterNetLC™.

InterNetLC™ can be used as an alternative to a Letter of Credit for international or domestic purchases. A InterNetLC™ is available to and from most countries and between any buyer and seller with Internet access.

InterNetLC™ transaction process: (1) the buyer and seller register with and agree to settle their transactions following the ICC Uniform Customs and Practices, (2) the buyer places a InterNetLC™ to a seller issued a banking institution, (3) the seller ships the goods and submits digital identification authenticable e-documents of the transport bill of lading, invoice and packing list to for negotiation, and (4) the InterNetLC™ is negotiated and payment is made to the seller and any assigned proceeds to third parties if the document contents are equivalent to the issued InterNetLC™ requirements. The original transport documents are sent immediately upon shipment to the buyer by the seller or the freight forwarder to eliminate delays clearing customs.

InterNetLC™ negotiation includes: (1) verifying the authentication of the submitted documents with digital identification; (2) comparing the documents equivalency with the issued InterNetLC™; (3) making payment minus fees if equivalent; (4) requesting buyer approval for making payment if not equivalent; (5) returning funds minus fees to the buyer if not approved and after the goods are returned; and (6) referring the transaction to arbitration in the event of a dispute between the buyer and seller. As with a Letter of Credit the InterNetLC™ transaction does not concern itself in any way with the goods, shipment thereof, or contract performance, only with the required documents evidencing movement, value and content.

2 The InterNetLC® Process

2.1 General

The ILC provides an online trade transaction settlement method that provides an alternative to the traditional commercial Letters of Credit. It separates the settlement function from logistics, customs, payment, currency control and the myriad of other things that Letters of Credit are used for besides settlement. The system is precise and requires the parties involved in a trade transaction to follow its process and procedures. Its reward is fast payment to the seller, immediate available of transport documents to the buyer, and very low transaction costs with similar protections afforded by Letters of Credit.

2.2 Registration

The parties to the transaction must Register (REG) with the system and sign in (SIG) each time they need access. The Registration includes name, address, telephone numbers, and banking references. All parties to the transaction must provide banking references to be used in the “know you customer” procedures, and “anti-fraud” procedures. The system functions allowed to a registrant depend on the party's function in each transaction. Buyers cannot assign proceeds or submit documents, and sellers cannot issue purchase orders or apply for InterNetLCs.

2.3 Basic Ordering Agreement

The buyer and seller must agree to a Basic Ordering Agreement (BOA) as the baseline for all transaction functions. This agreement contains all of the terms and conditions that are required to issue Purchase Orders, InterNetLCs, Amendments, Assignment Proceeds and Submit Documents. The terms and conditions cannot be altered during the transaction. Alterations. and/or changes during the transaction result in discrepant document submittal if the chancre is a data element used in settlement.

2.4 Dynamic Purchase Order

The Dynamic Purchase Order (DPO) is used to confirm or negotiate the Purchase Order prior to its issue b the buyer. The DPO is a draft of the planned Purchase Order to the seller. When the seller accepts its terms, conditions, pricing, ship date and details, it becomes a Purchase Order and is then issued by the buyer to the seller.

2.5 Purchase Order

The Purchase Order (PO) is issued by the buyer and is either Accepted or Not Accepted by the seller. The PO is not used in the settlement process, but is used to define the sale and the amount of InterNetLC needed to support the settlement.

2.6 InterNetLC® Letter of Credit

The InterNetLC (ILC) is the buyer's alternative to a documentary Letter of Credit. The TLC is support with either cash or a bank credit line, and is issued by a bank. It conforms to the International Chamber of Commerce Uniform Customs and Practices for Documentary Credits, Publication 500. The seller/beneficiary of the Credit receives the ILC online via the Internet, and presents documents online via the Internet. The hardcopy originals are sent to the buyer at shipment the same as open account, while E-documents with the same information are sent to the issuing bank in html format. The ILC issuing bank will also participate as the advising bank, negotiation bank, and reimbursing bank.

2.7 Good Funds Request

The ILC requires cash or credit support with the issuing bank. Credit arrangements must be made with the issuing bank after application content approval and before issue to a beneficiary.

2.8 Amendment

An Amendment may be applied for by the buyer to the ILC issuing bank. A seller can only request an Amendment from the buyer, and if the buyer agrees, the buyer may then apply for the Amendment. The seller still has the option to “Accept” or “Not Accept” the Amendment after it is issued. The original ILC is irrevocable after issue unless agreed to by the buyer and seller, as such, the seller is not obligated to accept any changes via Amendment.

2.9 Assignment of Proceeds

The seller is the beneficiary of any proceeds of an InterNetLC. The seller may assign a part or all of the proceeds potentially due him to a 3^{rd} party.

2.10 Negotiable Document Submittal

The required documents for InterNetLC negotiation are html E-documents that contain the actual information as the hard copy documents evidencing movement, value, content and usance (time to payment). The ILC E-document templates are retrieved form the ILC transaction database partially filled out with previously entered data from the buyer and seller. The remaining information relating to actual shipment date, value, content and time is entered along with the requirement to edit differences between the previously entered data and actual data. The E-documents are then submitted online to the issuing and negotiation bank.

2.11 ILC Negotiation

InterNetLC negotiation of E-documents follows the UCP 500, and the same standards as a Documentary Letter of Credit.

2.12 Cash Management

Cash Management reports are available to keep track of payments made and pending negotiations.

3 Registration

3.1 Buyer Registration and Functions

The buyer registration sets up a name and company database that allows ILC buyer functions to include: Basic Ordering Agreements; Dynamic Purchase Orders; Purchase Orders; InterNetLCs; Amendments; Negotiations; and Cash Management Reports.

3.2 Seller Registration and Functions

The seller registration sets up a name and company database that allows ILC seller functions to include: Basic Ordering Agreements; Purchase Orders; InterNetLCs; Amendments; Assignment of Proceeds; Submittals; Negotiations; and Cash Management Reports.

3.3 Agent Registration and Functions

The agent registration sets up a name and company database that allows ILC agent functions to include: InterNetLCs; Amendments; Submittals; and Negotiations.

3.4 Logistics Registration and Functions

The logistics registration sets up a name and company database that allows ILC logistics functions to include: InterNetLCs; Submittals; and Negotiations.

3.5 Assignee Registration and Functions

The assignee registration sets up a name and company database that allows ILC assignee functions to include: InterNetLCs and Assignment of Proceeds.

3.6 Banker Registration and Functions

The banker registration sets up a name and company database that allows ILC bank functions to include: access to both buyer and seller side Basic Ordering Agreements; Dynamic Purchase Orders; Purchase Orders; InterNetLCs; Amendments; Assignment of Proceeds; Submittals; Negotiations; and Cash Management Reports.

3.7 Registration Application

3.7.1 Your Name, Email Address and Password (Label)

3.7.2 Name (Text) (Required Data)

3.7.3 E-Mail Address

3.7.4 Password

3.7.5 Re-type Password

3.7.6 Account Verification (Label)

3.7.7 Security Question (Menu) (Required Data)

3.7.8 Your Answer

3.7.9 Company Information (Label)

3.7.10 Company Name

3.7.11 Address

3.7.12 Telephone No

3.7.13 Facsimile No

3.7.14 Bank Information (Label)

3.7.15 Bank Name (Text) Required Data)

3.7.16 Bank Address

3.7.17 Bank Account Name

3.7.18 Bank Account No

3.7.19 ABA/Transit No

3.7.20 Contract Name

3.7.21 Contact E-Mail Address

3.7.22 Telephone No

3.7.23 Facsimile No

3.7.24 AB—Terms of Use & Privacy Policy

3.7.25 AB—Submit

4 Basic Ordering Agreement

4.1 General

The Basic Ordering Agreement is made between the buyer and the seller. The BOA contains all of the terms and conditions to begin and complete settlement of a transaction. The BOA terms and conditions define a specific relationship between the buyer and seller as to the description of goods, INCOTERM, logistics and mode of transportation. The BOA does not specific sales terms such as unit price or quantities. The BOA is in effect for a specified period of time, and may be renewed. The BOA is unique to the specified INCOTERM, mode of transport, insurance agreement, freight charges and tenor of payment, and instrument of payment. The BOA data is carried through all of the settlement documents and cannot be changed after agreement by the buyer and seller to its terms and conditions. The buyer and seller can have as many Basic Ordering Agreements in place as they choice.

4.1.1 Initiating a Basic Ordering Agreement.

Both must agree to its terms and conditions before it becomes active. If the buyer and seller choose to change the terms of their agreement, they must initiate another Basic Ordering Agreement.

A seller initiates a Basic Ordering Agreement by completing the buyer information in the BOA, and the payment and shipping terms and conditions to include: Ship to Destination, Ship to Address, Ship From Address, Method of Payment, ILC Terms, Incoterm, Ship Via, Insurance Covered By, Description of Goods and/or Services, and Type of Transport Lading Document.

A buyer initiates a Basic Ordering Agreement by completing the buyer information in the BOA, and the payment and shipping terms and conditions to include: Ship to Destination, Ship to Address, Ship From Address, Method of Payment, ILC Terms, Incoterm, Ship Via, Insurance Covered By, Description of Goods and/or Services, and Type of Transport Lading Document.

Freight Forwarder/Carrier Information. If the buyer or seller selects the Freight Forwarder or Carrier, this information must be entered by that party.

4.1.2 Number of BOA's Required.

There may be one to many Basic Ordering Agreements in place and currently active at the same time, each one defining different terms and conditions for a transaction. In general there should be different BOA for each buyer and seller combination, each Incoterm, each mode of transport, each shipping condition and each settlement term. The specific terms and conditions that require a different BOA include (but not limited to):

a. The BOA is specific as to the seller, buyer, agent and bank references.

b. The BOA is specific as to names, company names, addresses, email addresses and telephone or facsimile numbers spelling.

c. The BOA is specific as to transportation mode; ocean, air, rail, truck or courier.

d. The BOA is specific as to Incoterm; FOB, CIF, EXW, etc.

e. The BOA is specific as to Freight Forwarder or Agent if specified.

f. The BOA is specific as to shipping terms and conditions.

g. The BOA is specific as to settlement terms.

4.2 Basic Ordering Agreement Application

The buyer or seller selects either a blank application for a Basic Ordering Agreement, or a previous Agreement to be edited. They complete the buyer or seller side of the application, and at least the contact email of the other party. After completing the required data fields and the optional fields, the application is submitted to the other party for review and re-submittal to the originating party. If the entered information is not acceptable, the cycle continues until both side agree. After mutual agreement, the Basic Ordering Agreement becomes currently active, and can be used to initiate Dynamic Purchase Orders, InterNetLCs, Amendments, Assignments of Proceeds and Submittal of Documents.

4.2.1 BOA Begin Date (dd MMM yy) (Required Data)

The effective date the buyer and seller chose to have the Basic Ordering Agreement terms and conditions begin. This date can be immediately or sometime in the future.

4.2.2 BOA End Date (dd MMM yy) (Required Data)

The effective date the buyer and seller chose to have the Basic Ordering Agreement terms and conditions end. Normally terms are effective for at least one year from the BOA Begin Date.

4.2.3 Reference (Text) (Not Required Data)

Remarks by the buyer or seller to be included as a reference to the Basic Ordering Agreement. This field is not required, and is not part of the terms and conditions agreed to between the parties.

4.2.4 Buyer/Applicant Information (Label)

4.2.5 Buyer Name (Text) (Required Data)

Full name of the person authorized to issue Purchase Orders and apply for InterNetLCs for the company. Company or social titles should not be included, only the persons recognized or legal name.

4.2.6 Buyer Company Name (Text) (Required Data)

Full company name of business to issue Purchase Orders and apply for InterNetLCs. The name should include the company's entity such as “Corp.”, “Inc.”, SA de CV”, etc. The companies name should be related to the Buyer Bank Account Name either directly as a legal dba (doing business as), division, department, or subsidiary.

4.2.7 Buyer Company Address (Text) (Required Data)

Buyer's company address. The address should include all pertinent details such as room number, city, state, country, and postal or zip code if any.

4.2.8 Buyer Phone No (Country-Area/City-Local Number) (Required Data)

Buyer's telephone number

4.2.9 Buyer Fax No (Country-Area/City-Local Number) (Required Data)

Buyer's facsimile number.

4.2.10 Buyer Web URL (http://www.xxxxxx.com.xx) (Not Required Data)

Buyer's World Wide Web IP address.

4.2.11 Buyer Email Address (xxxxxx@xxxxx.com.xx) (Required Data)

Buyer's email address.

4.2.12 Buyer Bank Account Name (Text) (Required Data)

Buyer's bank account name.

4.2.13 Buyer Bank Account No (Numeric) (Required Data)

Buyer's bank account number.

4.2.14 Buyer Bank ABA/Transit No (Numeric) (Required Data)

Buyer's bank American Banking Association (ABA) or wire transit number.

4.2.15 Buyer Bank Name (Text) (Required Data)

Buyer's bank name.

4.2.16 Buyer Bank Address (Text) (Required Data)

Buyer's bank address. The address should include all pertinent details such as room number, city, state, country, and postal or zip code if any.

4.2.17 Buyer Bank Phone No (Country-Area/City-Local Number) (Required Data) Buyer's bank telephone number to include country, area and/or city code.

4.2.18 Buyer Bank Fax No (Country-Area/City-Local Number) (Required Data) Buyer's bank facsimile number to include country, area and/or city code.

4.2.19 Buyer Bank Contact Email (xxxxxx@xxxx.com.xx)

Buyer's bank contact email address.

4.2.20 Seller/Beneficiary Information (Label)

4.2.21 Seller Name (Text) (Required Data)

Full name of the person authorized to accept Purchase Orders and submit InterNetLC E-documents for the Seller Company that is the beneficiary of the Credit.

4.2.22 Seller Company Name (Text) (Required Data)

Full company name of business to receive Purchase Orders and submit InterNetLC E-documents. The Seller Company Name is the beneficiary or party in whose favor the Credit is to be issued, and the party that must comply with the terms and conditions of the Credit in order to be entitled to receive its proceeds. The name should include the company's entity such as “Corp.”, Inc. SA de CV”, etc. The companies name should be related to the Buyer Bank Account Name either directly as a legal dba (doing business as), division, department, or subsidiary.

4.2.23 Seller Company Address (Text) (Required Data)

Full company address of business to receive Purchase Orders and submit InterNetLC E-documents. The address should include all pertinent details such as room number, city, state, country, and postal or zip code if any.

4.2.24 Seller Phone No (Country-Area/City-Local Number) (Required Data)

Seller's telephone number.

4.2.25 Seller Fax No (Country-Area/City-Local Number) (Required Data)

Seller's facsimile number.

4.2.26 Seller Web URL (http://www.xxxxxx.com.xx) (Not Required Data)

Seller's World Wide Web IP address.

4.2.27 Seller Email Address (xxxxxx@xxxxx.com.xx) (Required Data)

Seller's email address.

4.2.28 Seller Bank Account Name (Text) (Required Data)

Seller's bank account name.

4.2.29 Seller Bank Account Number (Numeric) (Required Data)

Seller's bank account number.

4.2.30 Seller Bank ABA/Transit No (Numeric) (Required Data)

Seller's bank American Banking Association (ABA) or wire transit number.

4.2.31 Seller Bank Name (Text) (Required Data)

Seller's bank name.

4.2.32 Seller Bank Address (Text) (Required Data)

Seller's bank address.

4.2.33 Seller Bank Contact Name (Text) (Required Data)

Seller's bank telephone number to include country, area and/or city code.

4.2.34 Seller Bank Phone No (Country-Area/City-Local Number) (Required Data)

Seller's batik facsimile number to include country, area and/or city code,

4.2.35 Seller Bank Fax No (Country-Area/City-Local Number) (Required Data)

Seller's bank facsimile number to include country, area and/or city code.

4.2.36 Seller Bank Contact Email (xxxxxx@xxxxx.com.xx) (Required Data)

Seller's bank, contact email address.

4.2.37 Freight Forwarder/Carrier Information (label)

4.2.38 Freight Forwarder/Carrier Address (Text) (Not Required Data)

Freight Forwarder or Carrier's company address. The address should include all pertinent details such as room number, city, state, country, and postal or zip code if any.

4.2.39 Agent Name (Text) (Not Required Data)

Full name of the person or company authorized to submit InterNetLC E-documents for the Seller as the Seller's Agent.

4.2.40 Agent Telephone No (Country-Area/City-Local Number) (Not Required Data)

Agent's telephone number to include country, area and/or city code.

4.2.41 Agent Fax No (Country-Area/City-Local Number) (Not Required Data)

Agent's telephone number to include country, area and/or city code.

4.2.42 Agent Web URL (http://www.xxxxxx.com.xx) (Not Required Data)

Agent's World Wide Web IP address.

4.2.43 Agent Email Address (xxxxxx@xxxxx.com.xx) (Not Required Data)

Agent's email address.

4.2.44 Agent Bank Account Name (Text) (Not Required Data)

Agent's bank account name.

4.2.45 Agent Bank Account Number (Numeric) (Not Required Data)

Agent's bank American Banking Association (ABA) or wire transit number.

4.2.46 Agent Bank ABA/Transit No (Numeric) (Not Required Data)

Agent's bank American Banking Association (ABA) or wire transit number.

4.2.47 Agent Bank Name (Text) (Not Required Data)

Agent's bank name.

4.2.48 Agent Bank Address (Text) (Not Required Data)

Agent's bank address.

4.2.49 Shipment/Settlement Information (Label)

4.2.50 Ship To Destination (Text) (Required Data)

4.2.51 Ship To Address (Text) (Not Required Data)

4.2.52 Ship From (Text) (Required Data)

4.2.53 Ship From Address (Text) (Not Required Data)

4.2.54 METHOD OF SETTLEMENT (Menu) (Required Data) (label)

4.2.55 InterNetLC

Online alternative to a Documentary Letter of Credit.

4.2.56 InterNetLC® Draft Discount

Online alternative to a Bill of Exchange Discount

4.2.57 InterNetLC® Documents Against Payment

Online alternative to Documents Against Payment Collection

4.2.58 InterNetLC® Against Acceptance

Online alternative to Documents Against Acceptance Collection

4.2.59 InterNetLC® Clean Collection

Online alternative to Draft Against Payment or Clean Collection

4.2.60 InterNetLC Terms (label)

4.2.61 Sight Plus Days After Shipping

Number of days after shipment the InterNetLC is to be paid. The shipment date is the same date as the Bill of Lading date, actual air shipment, actual rail shipment, actual straight shipment, or courier receipt date.

4.2.62 Incoterm (Menu) (Required Data) (label)

International Commercial Term agreed to between the Buyer and Seller.

4.2.63 EXW—Ex Works ( . . . Named Place) (Ship, Air, Rail, Truck or Courier OK)

Goods are to be shipped from the “named place” by either ship, air, rail, truck or courier is acceptable.

4.2.64 FCA—Free Carrier ( . . . Named Place)

4.2.65 FAS—Free Alongside Ship ( . . . Named Port of Shipment)

4.2.66 FOB—Free On Board ( . . . Named Port of Shipment)

4.2.67 CFR—Cost And Freight ( . . . Named Port of Destination)

4.2.68 CIF—Cost, Insurance And Freight ( . . . Named Port of Destination)

4.2.69 CPT—Carriage Paid To ( . . . Named Place of Destination)

4.2.70 CIP—Carriage And Insurance Paid To ( . . . Named Place of Destination)

4.2.71 DAF—Delivered At Frontier ( . . . Named Place)

4.2.72 DES—Delivered Ex Ship ( . . . Named Port of Destination)

4.2.73 DEQ—Delivered Ex Quay (Duty Paid) ( . . . Named Port of Destination)

4.2.74 DDU—Delivered Duty Unpaid ( . . . Named Place of Destination)

4.2.75 DDP—Delivered Duty Paid ( . . . Named Place of Destination)

4.2.76 Ship Via (Menu) (Required Data)

4.2.77 Ocean—Goods are to be Moved by Sea

4.2.78 Air—Goods are to be Moved by Air

4.2.79 Truck—Goods are to be Moved by Struck

Rail—Goods are to be Moved by Railroad

4.2.80 Courier—Goods are to be Moved by Expedited Delivery Service

4.2.81 Insurance Covered By (Menu) (Required Data) (Label)

4.2.82 Buyer—Buyer is Responsible for Insurance

4.2.83 Seller—Seller is Responsible for Insurance

4.2.84 Shipments (Menu) (Required Data) (Label)

4.2.85 Partial Shipment Allowed—Shipments Less than Complete are Allowed with Multiple Negotiations

4.2.86 Transshipment Allowed—Goods may be Transported by more than One Vessel.

Transhipment means unloading and reloading from one vessel to another vessel during the course of ocean carriage from the port of loading to the port of discharge stipulated in the Credit.

4.2.87 Description of Goods and/or Services

General description of goods and/or services to be traded without unit prices or quantities or detailed description.

4.2.88 Authenticated Documents Required for Negotiation (Label)

4.2.89 Type of Transport Document (Menu) (Required Data) (Label)

4.2.90 ILC Marine Bill of Lading

4.2.91 ILC Air Waybill

4.2.92 ILC Rail Waybill

4.2.93 ILC Straight Bill

4.2.94 ILC Courier Receipt

4.2.95 ILC Invoice

4.2.96 ILC Packing List

4.2.97 ILC Bill of Exchange

4.2.98 ILC Other Document

4.2.99 AB—Buyer Submits to Seller

4.2.100 AB—Buyer Agrees

4.2.101 AB—Buyer Not Agrees

4.2.102 AB—Seller Submits to Buyer

4.2.103 AB—Seller Agrees

4.2.104 AB—Seller Not Agrees

4.2.105 AB—Print to PDF

4.2.106 AB—Save to File

5 Dynamic Purchase Order

5.1 General

5.2 Dynamic Purchase Order Application

5.2.1 Dynamic PO No (System Assigned) (Required Data)

5.2.2 Dynamic PO Date (dd MMM yy) (Required Data)

5.2.3 BOA Number (Required Data)

5.2.4 Dynamic PO Amendment (As Required Data)

5.2.5 DPO Amendment Date (As Required Data)

5.2.6 Buyer/Applicant Information (Label)

5.2.7 Buyer Name (Text) (Not Required)

5.2.8 Buyer Company Name (Text) (Required Data)

5.2.9 Buyer Company Address (Text) Required Data)

5.2.10 Buyer Telephone No (Country-Area/City-Local Number) (Required Data)

5.2.11 Buyer Fax No (Country-Area/City-Local Number) (Required Data)

5.2.12 Buyer Web Site Address (Not Required)

5.2.13 Buyer Email Notification (Required Data)

5.2.14 Buyer Reference Information (Text) (Not Required)

5.2.15 Seller/Beneficiary Information (Label)

5.2.16 Seller Name (Text) (Not Required)

5.2.17 Seller Company Name (Text) (Required Data)

5.2.18 Seller Company Address (Text) Required Data)

5.2.19 Seller Telephone No (Country-Area/City-Local Number) (Required Data)

5.2.20 Seller Fax No (Country-Area/City-Local Number) (Required Data)

5.2.21 Seller Web Site Address (Not Required)

5.2.22 Seller Email Notification (Required Data)

5.2.23 Seller Reference Information (Text) (Not Required)

5.2.24 Shipment/Settlement Information (Label)

5.2.25 Buyer Ship to Destination (Text) (Required Data)

5.2.26 Buyer Ship to Address (Text) (Not Required)

5.2.27 Method of Payment—InterNetLC (Label)

5.2.28 DPO Currency (Menu) (Required)

5.2.29 DPO Value (Numeric) (Required)

5.2.30 DPO Amount in Words (System Assigned) (Required)

5.2.31 InterNetLC Terms (Menu) (Required)

5.2.32 Place of Issued (System Assigned) (Required)

5.2.33 Place of Presentation (System Assigned) (Required)

5.2.34 Ship Via (From BOA) (Required)

5.2.35 Insurance Covered By (From BOA) (Required)

5.2.36 Shipment Delivery Date (Not Required)

5.2.37 Incoterm (From BOA) (Required)

5.2.38 Description of Goods and/or Services (Text) (From BOA)

5.2.39 Purchase Order Details (Text) (Not Required)

5.2.40 Authenticated Documents Required for Negotiation (Label)

5.2.41 Type of ILC Transport Lading Document (From BOA) (Required)

5.2.42 ILC Invoice (Required)

5.2.43 ILC Packing List (Required)

5.2.44 ILC Bill of Exchange (Required)

5.2.45 ILC Other (Not Required) (Not Active)

5.2.46 AB—Send to Seller

5.2.47 AB—Seller Agrees

5.2.48 AB—Seller Not Agrees

5.2.49 AB—Print to PDF

5.2.50 AB—Save to File

6 Purchase Order

6.1 General

6.2 Purchase Order Fields

6.2.1 PO Number (System Assigned) (Required Data)

6.2.2 PO Date (dd MMM yy) (Required Data)

6.2.3 BOA Number (System Assigned) (Required Data)

6.2.4 PO Amendment (System Assigned) (Not Required)

6.2.5 PO Amendment Date (dd MMM yy) (Not Required Data)

6.2.6 Buyer/Applicant Information (Label)

6.2.7 Buyer Name (Text) (Not Required)

6.2.8 Buyer Company Name (Text) (Required Data)

6.2.9 Buyer Company Address (Text) Required Data)

6.2.10 Buyer Telephone No (Country-Area/City-Local Number) (Required Data)

6.2.11 Buyer Fax No (Country-Area/City-Local Number) (Required Data)

6.2.12 Buyer Web Site Address (Not Required)

6.2.13 Buyer Email Notification (Required Data)

6.2.14 Buyer Reference Information (Text) (Not Required)

6.2.15 Seller/Beneficiary Information (Label)

6.2.16 Seller Name (Text) (Not Required)

6.2.17 Seller Company Name (Text) (Required Data)

6.2.18 Seller Company Address (Text) Required Data)

6.2.19 Seller Telephone No (Country-Area/City-Local Number) (Required Data)

6.2.20 Seller Fax No (Country-Area/City-Local Number) (Required Data)

6.2.21 Seller Web Site Address (Not Required)

6.2.22 Seller Email Notification (Required Data)

6.2.23 Seller Reference Information (Text) (Not Required)

6.2.24 Shipment/Settlement Information (Label)

6.2.25 Buyer Ship to Destination (Text) (Required Data)

6.2.26 Buyer Ship to Address (Text) (Not Required)

6.2.27 Method of Payment—InterNetLC (Label)

6.2.28 PO Currency (Menu) (Required)

6.2.29 PO Value (Numeric) (Required)

6.2.30 PO Amount in Words (System Assigned) (Required)

6.2.31 InterNetLC Terms (Menu) (Required)

6.2.32 Place of Issued (System Assigned) (Required)

6.2.33 Place of Presentation (System Assigned) (Required)

6.2.34 Ship Via (From BOA) (Required)

6.2.35 Insurance Covered By (From BOA) (Required)

6.2.36 Shipment Delivery Date (Not Required)

6.2.37 Incoterm (From BOA) (Required)

6.2.38 Description of Goods and/or Services (Text) (From BOA)

6.2.39 Purchase Order Details (Text) (Not Required)

6.2.40 Authenticated Documents Required for Negotiation (Label)

6.2.41 Type of ILC Transport Lading Document (From BOA) (Required)

6.2.42 ILC Invoice (Required)

6.2.43 ILC Packing List (Required)

6.2.44 ILC Bill of Exchange (Required)

6.2.45 ILC Other (Not Required) (Not Active)

6.2.46 AB—Send to Seller

6.2.47 AB—Seller Accepts

6.2.48 AB—Seller Rejects

6.2.49 AB—Print to PDF

6.2.50 AB—Save to File

7 InterNetLC® Letter of Credit

7.1 General

7.2 InterNetLC Application

7.2.1 BOA No (System Assigned) (Required Data)

7.2.2 Date of Latest Presentation (Label)

7.2.3 Date ILC Expires (dd MMM yy) (Required Data)

7.2.4 Date Latest Shipment (dd MMM yy) (Required Data)

7.2.5 Reference Information (Not Required)

7.2.6 ILC Currency (Menu) (Required Date)

7.2.7 ILC Value (Numeric) (Required Data)

7.2.8 Processing Fee (Required Data)

7.2.9 Collateral Amount Required (Required Data)

7.2.10 Buyer/Applicant Information (Label)

7.2.11 Buyer Name (Text) (Not Required)

7.2.12 Buyer Company Name (Text) (Required Data)

7.2.13 Buyer Company Address (Text) Required Data)

7.2.14 Buyer Telephone No (Country-Area/City-Local Number) (Required Data)

7.2.15 Buyer Fax No (Country-Area/City-Local Number) (Required Data)

7.2.16 Buyer Web Site Address (Not Required)

7.2.17 Buyer Email Notification (Required Data)

7.2.18 Seller/Beneficiary Information (Label)

7.2.19 Seller Name (Text) (Not Required)

7.2.20 Seller Company Name (Text) (Required Data)

7.2.21 Seller Company Address (Text) Required Data)

7.2.22 Seller Telephone No (Country-Area/City-Local Number) (Required Data)

7.2.23 Seller Fax No (Country-Area/City-Local Number) (Required Data)

7.2.24 Seller Web Site Address (Not Required)

7.2.25 Seller Email Notification (Required Data)

7.2.26 Shipment/Settlement Information

7.2.27 Buyer Ship to Destination (Text) (Required Data)

7.2.28 Buyer Ship to Address (Text) (Not Required)

7.2.29 Method of Payment—InterNetLC (Label)

7.2.30 InterNetLC Terms (Menu) (Required)

7.2.31 Incoterm (From BOA) (Required)

7.2.32 Description of Goods and/or Services (Text) (From BOA)

7.2.33 Freight Forwarder/Carrier Information (Label)

7.2.34 Freight Forwarder/Carrier Address (Text) (Not Required Data)

7.2.35 Agent Telephone No (Country-Area/City-Local Number) (Not Required Data)

7.2.36 Agent Fax No (Country-Area/City-Local Number) (Not Required Data)

7.2.37 Place of Issue (Assigned) (Required Data)

7.2.38 Place of Presentation (Assigned) (Required Data)

7.2.39 Ship Via (Required Data)

7.2.40 Insurance Covered By (Required Data)

7.2.41 Shipments

7.2.42 Partial Shipments Allowed (Assigned Option)

7.2.43 Trans Shipments Allowed (Assigned Option)

7.2.44 Authenticated Documents Required for Negotiation

7.2.45 Type of ILC Transport Lading Document (From BOA) (Required)

7.2.46 ILC Invoice (Required)

7.2.47 ILC Packing List (Required)

7.2.48 ILC Bill of Exchange (Required)

7.2.49 ILC Other (Not Required) (Not Active)

7.2.50 AB—Submit for Approval

7.2.51 AB—Application Approved

7.2.52 AB—Application Not Approved

7.2.53 AB—Request Good Funds

7.2.54 AB—Good Funds Received

7.2.55 AB—Issue ILC

7.2.56 AB—Edit Fields

7.2.57 AB—Print to PDF

7.2.58 AB—Save to File

8 Good Funds Request

8.1 General

8.2 Cash Supported ILC

8.3 Credit Supported ILC

9 InterNetLC® Amendment

9.1 General

9.2 ILC Amendment Application

9.2.1 Original (Label)

9.2.2 ILC No (Numeric) (Required)

9.2.3 Date of Latest Presentation (dd MMM yy) (Required Data)

9.2.4 Date to be Issued (dd MMM yy) (Required Data)

9.2.5 BOA No. (System Assigned) (Required Data)

9.2.6 Reference Information (Text) (Not Required)

9.2.7 Amendments (Label)

9.2.8 ILC No (Assigned) (Required Data)

9.2.9 Date ILC Expires (dd MMM yy) (Required Data)

9.2.10 Date of Latest Shipment (dd MMM yy) (Required Data)

9.2.11 ILC Value (Numeric) (Required Data)

9.2.12 Processing Fee (Numeric) (Required Data)

9.2.13 ILC Total (Numeric) (Required Data)

9.2.14 Amend to (Label)

9.2.15 ILC Amendment No (Assigned)

9.2.16 Date ILC Expires

9.2.17 Date Latest Shipment

9.2.18 ILC Currency (Menu)

9.2.19 ILC Value (Numeric) (Required Data)

9.2.20 Processing Fee (Numeric) (Required Data)

9.2.21 ILC Total (Numeric) (Required Data)

9.2.22 Shipment Settlement Information (Label)

9.2.23 Ship to Destination (Text) (Required Data)

9.2.24 Ship to Address (Text) (Not Required Data)

9.2.25 Method of Payment (Menu) (Required)

9.2.26 InterNetLC Terms (Menu) (Required Data)

9.2.27 Incoterm (Menu) (Required Data)

9.2.28 Description of Goods and/or Services (Text) (Required Data)

9.2.29 Freight Forwarder/Carrier Information (Label)

9.2.30 Freight Forwarder/Carrier Address (Text) (Not Required)

9.2.31 Agent Phone No (Country-Area/City-Local Number) (Required Data)

9.2.32 Agent Fax No (Country-Area/City-Local Number) (Required Data)

9.2.33 Place of Issue (Fixed)

9.2.34 Place of Presentation (Fixed)

9.2.35 Ship Via (Menu) (Required Data)

9.2.36 Insurance Covered By (Required Data)

9.2.37 Shipments

9.2.38 Authenticated Documents Required for Negotiation (Label)

9.2.39 Type of ILC Transport Lading Document (From BOA) (Required)

9.2.40 ILC Invoice (Required)

9.2.41 ILC Packing List (Required)

9.2.42 ILC Bill of Exchange (Required)

9.2.43 ILC Other (Not Required) (Not Active)

9.2.44 AB—Submit for Approval

9.2.45 AB—Application Approved

9.2.46 AB—Application Not Approved

9.2.47 AB—Request Good Funds

9.2.48 AB—Good Funds Received

9.2.49 AB—Issue AMD

9.2.50 AB—Edit Fields

9.2.51 AB—Print to PDF

9.2.52 AB—Save to File

10 Assignment of Proceeds

10.1 General

10.2 Assignment of Proceeds Request

10.2.1 Assignment No (Assigned) (Required Data)

10.2.2 Assignment Date (dd MMM yy) (Assigned) (Required Data)

10.2.3 ILC No (Assigned) (Required Data)

10.2.4 Date ILC Expires (dd MMM yy) (Assigned) (Required Data)

10.2.5 Assigned Party Information (Label)

10.2.6 Assigned Name (Text) (Not Required)

10.2.7 Assigned Company Name (Text) (Not Required)

10.2.8 Assigned Company Address (Text) (Not Required)

10.2.9 Assigned Tel No (Country-Area/City-Local Number) (Not Required Data)

10.2.10 Assigned Fax No (Country-Area/City-Local Number) (Not Required Data)

10.2.11 Assigned Web URL (http://www.xxxxxx.com.xx) (Not Required Data)

10.2.12 Assigned Email Address (xxxxxx@xxxxx.com.xx) (Required Data)

10.2.13 Seller/Beneficiary Information (Label)

10.2.14 Seller Name (Text) (Required Data)

10.2.15 Seller Company Name (Text) (Required Data)

10.2.16 Seller Company Address (Text) (Required Data)

10.2.17 Seller Phone No (Country-Area/City-Local Number) (Required Data)

10.2.18 Seller Fax No (Country-Area/City-Local Number) (Required Data)

10.2.19 Seller Web URL (http://www.xxxxxx.com.xx) (Not Required Data)

10.2.20 Seller Email Address (xxxxxx@xxxxx.com.xx) (Required Data)

10.2.21 Assigned Party Bank Information (Label)

10.2.22 Assigned Currency

10.2.23 Amount to be Assigned

10.2.24 Amount in Words

10.2.25 Assigned Bank Account Name

10.2.26 Assigned Bank Account Number

10.2.27 Assigned Bank ABA/Transit Number

10.2.28 Assigned Bank Name

10.2.29 Assigned Bank Address

10.2.30 Assigned Bank Contact Name

10.2.31 Assigned Bank Tel No

10.2.32 Assigned Bank Fax No

10.2.33 Assigned Bank Contact Email

10.2.34 AB—Submit for Approval

10.2.35 AB—Application Approved

10.2.36 AB—Application Not Approved

10.2.37 AB—Edit Fields

10.2.38 AB—Print to PDF

10.2.39 AB—Save to File

11 ILC Marine Bill of Lading

11.1 General

11.2 ILC Marine Bill of Lading E-document

12 ILC Air Waybill

12.1 General

12.2 ILC air waybill E-Document

13 ILC RAIL WAYBILL

13.1 General

13.2 ILC Rail Waybill E-Document

14 ILC Straight Waybill

14.1 General

14.2 ILC Straight Waybill E-Document

15 ILC Courier Receipt

15.1 General

15.2 ILC Courier Receipt E-Document

16 ILC Packing List

16.1 General

16.2 ILC Packing List E-Document

17 ILC Invoice

17.1 General

17.2 ILC Invoice E-Document

18 ILC Bill of Exchange

18.1 General

18.2 ILC Bill of Exchange E-Document

19 Shippers Letter of Instruction

19.1 General

19.2 Shippers Letter of Instructions Fields

20 ILC Settlement

20.1 General

21 ILC Confirmation

21.1 General

22 Know Your Customer Procedures

23 Anti Fraud Procedures

24 Uniform Customs and Practices for Documentary Credits

[image]

[image]

[image]

[image]

[image]

[image]

[image]

[image]

[image]

[image]

[image]

[image]

[image]

[image]

[image]

[image]

[image]

[image]

What I claim is:

1. An online method and system for using the Internet for transaction and settlement of Commercial Documentary Sight Letters of Credit that conforms to the International Chamber of Commerce, Paris, France, Uniform Customs and Practice for Documentary Credits (UCP).

2. An online method and system for using the Internet for transaction and settlement of Commercial Documentary Usance Letters of Credit that conforms to the International Chamber of Commerce, Paris, France, Uniform Customs and Practice for Documentary Credits (UCP).

3. A online method and system for using the Internet for transaction and settlement of Trade Acceptances and Bankers Acceptances that conforms to the International Chamber of Commerce, Paris, France, Uniform Customs and Practice for Documentary Credits (UCP).

4. An online method and system for using the Internet for transaction and settlement of commercial Standby Letters of Credit that conforms to the International Chamber of Commerce, Paris, France, Uniform Customs and Practice for Documentary Credits (UCP), and the International Standby Practices (ISP).

5. An online method and system for using the Internet for transaction and settlement of International Collections to include Documents Against Payment, Documents Against Acceptance and Clean Collection.

6. An online method and system for using the Internet for transaction and settlement of open account with and/or without credit insurance.
